(19) United States
(12) Patent Application Publication
(10) Pub. No.: US 2014/0086714 A1
(43) Pub. Date: Mar. 27, 2014

(54) AUTOMATED WAREHOUSING SYSTEMS AND METHOD

(71) Applicant: Ohad MALIK, Givat Shmuel (IL)

(72) Inventor: Ohad MALIK, Givat Shmuel (IL)

(21) Appl. No.: 13/628,998

(22) Filed: Sep. 27, 2012

(51) Int. Cl. B65G 1/137

(52) U.S. Cl. 414/273

(57) ABSTRACT

A dynamically automated warehousing system including a three-dimensional storage volume having a plurality of horizontal storage levels which are vertically offset from each other, each level defining a grid of mutually adjacent palletized load storage/travel locations, at least some of the storage/travel locations being accessible from multiple directions, a three-dimensional palletized load storage/travel controller operative to dynamically control placement of palletized loads to and removal of palletized loads from palletized load storage locations and being operative to changeably designate a first plurality of the storage/travel locations as palletized load storage locations and a second plurality of the storage/travel locations as palletized load travel locations at a first time, and at a second time to designate a third plurality, different from the first plurality, of the storage/travel locations as palletized load storage locations and a fourth plurality, different from the second plurality, of the storage/travel locations as palletized load travel locations.

### FIELD OF THE INVENTION

The present invention relates generally to automated warehousing systems and methodologies.

### BACKGROUND OF THE INVENTION

Automated warehouse systems and methodologies are described in U.S. Published Patent Application US 2007/0276535 and U.S. Pat. No. 5,556,246.

A carriage and rail system for pallet storage systems are described in U.S. Published Patent Application US 2005/0191160 and U.S. Pat. No. 7,131,811.

### SUMMARY OF THE INVENTION

The present invention seeks to provide improved automated warehouse systems and methodologies.

There is thus provided in accordance with a preferred embodiment of the present invention a dynamically automated warehousing system including a three-dimensional storage volume having a plurality of horizontal storage levels which are vertically offset from each other, each of the plurality of horizontal storage levels defining a grid of mutually adjacent palletized load storage/travel locations, at least some of the mutually adjacent palletized load storage/travel locations being accessible from multiple directions, a three-dimensional palletized load storage/travel controller operative to dynamically control placement of palletized loads to and removal of palletized loads from palletized load storage locations and being operative to changeably designate a first plurality of the mutually adjacent palletized load storage/travel locations as palletized load storage locations and a second plurality of the mutually adjacent palletized load storage/travel locations as palletized load travel locations at a first time, and at a second time to designate a third plurality, different from the first plurality, of the mutually adjacent palletized load storage/travel locations as palletized load storage locations and a fourth plurality, different from the second plurality, of the mutually adjacent palletized load storage/travel locations as palletized load travel locations, whereby at least some of the mutually adjacent palletized load storage/travel locations may belong to the first plurality at the first time and may belong to the fourth plurality at the second time.

Preferably, the dynamically automated warehousing system also includes a plurality of three-axis palletized load transporters, each arranged to displace palletized loads along three mutually perpendicular axes. In accordance with a preferred embodiment of the present invention, the three-dimensional palletized load storage/travel controller is also operative to control operation of the plurality of three-axis palletized load transporters for transporting and storing palletized loads within the three-dimensional storage volume. Additionally or alternatively, the three-dimensional palletized load storage/travel controller is also operative to coordinate operation of at least two palletized load transporters for synchronized engagement with a single palletized load which is supported on at least two pallets, displacement thereof to a desired location and disengagement therefrom.

There is also provided in accordance with another preferred embodiment of the present invention an automated warehousing system including a multi-story structure for storage of palletized loads, each story including a first multiplicity of paired elongate static first palletized load travel path elements arranged in a first mutually parallel arrangement along first mutually parallel axes in a first three-dimensional arrangement within a three-dimensional volume, a second multiplicity of paired elongate static second palletized load travel path elements arranged in a second mutually parallel arrangement along second mutually parallel axes in a second three-dimensional arrangement within the three dimensional volume, the second mutually parallel axes being generally perpendicular to the first mutually parallel axes and a third multiplicity of static palletized load supports arranged within the three-dimensional volume and a plurality of three-axis palletized load transporters, each arranged to displace palletized loads along three mutually perpendicular axes: along at least one of the first mutually parallel axes, along at least one of the second mutually parallel axes and along a vertical axis perpendicular to both the first and second mutually parallel axes.

Preferably, the plurality of three-axis palletized load transporters are operative to move along the first and second mutually parallel axes into a position underlying a palletized load which is supported on ones the third multiplicity of static palletized load supports, to raise the palletized load out of supported engagement with the ones of the multiplicity of static palletized load supports, to displace the palletized load along the first and second mutually parallel axes and thereafter to lower the palletized load onto others of the third multiplicity of static palletized load supports in supported engagement therewith and to move along the first and second mutually parallel axes to a position not underlying the palletized load.

In accordance with a preferred embodiment of the present invention the automated warehousing system also includes at least one palletized load lifting/lowering assembly for raising or lowering the palletized loads between levels of the multi-story structure.

Preferably, the at least one palletized load lifting/lowering assembly includes an elevator having a load platform configured to define palletized load travel paths extending along the first and second mutually parallel axes. Additionally, the elevator has a load platform configured to accommodate palletized loads which extend over more than one pallet.

In accordance with a preferred embodiment of the present invention the automated warehousing system also includes a palletized load storage/travel controller operative to control operation of the plurality of three-axis palletized load transporters and to coordinate operation of at least two palletized load transporters for synchronized engagement with a single palletized load which is supported on at least two pallets, displacement thereof to a desired location and disengagement therefrom.

There is further provided in accordance with yet another preferred embodiment of the present invention a dynamically automated warehousing system including a three-dimensional storage volume having a plurality of horizontal storage levels which are vertically offset from each other, each of the plurality of horizontal storage levels defining a grid of mutually adjacent palletized load storage/travel locations, at least some of the mutually adjacent palletized load storage/travel locations being accessible from multiple directions and a three-dimensional palletized load storage/travel controller operative to dynamically control placement of palletized loads to and removal of palletized loads from the mutually adjacent palletized load storage locations and being operative to changeably designate a first plurality of the mutually adjacent palletized load storage/travel locations as one-deep palletized load storage locations, which do not require movement of another palletized load for access thereto, and generally independently thereof to changeably designate a second plurality of the mutually adjacent palletized load storage/travel locations as two-deep palletized load storage locations, which require movement of a single palletized load for access thereto and generally independently thereof to changeably designate a third plurality of the mutually adjacent palletized load storage/travel locations as three-deep palletized load storage locations, which require movement of two palletized loads for access thereto, whereby at least some of the mutually adjacent palletized load storage/travel locations may belong to the first plurality at a first time and may belong to the second plurality at a second time and may belong to the third plurality at a third time.

Preferably, the three-dimensional storage volume and the three-dimensional palletized load storage/travel controller are both capable of accommodating palletized loads which extend over more than one pallet.

In accordance with a preferred embodiment of the present invention the dynamically automated warehousing system also includes a plurality of three-axis palletized load transporters wherein the three-dimensional palletized load storage/travel controller is operative to control operation of the plurality of three-axis palletized load transporters and to coordinate operation of at least two palletized load transporters for synchronized engagement with a single palletized load which is supported on at least two pallets, displacement thereof to a desired location and disengagement therefrom.

There is yet further provided in accordance with still another preferred embodiment of the present invention a dynamically automated warehousing method including providing a three-dimensional storage volume having a plurality of horizontal storage levels which are vertically offset from each other, each of the plurality of horizontal storage levels defining a grid of mutually adjacent palletized load storage/travel locations, at least some of the mutually adjacent palletized load storage/travel locations being accessible from multiple directions and dynamically controlling placement of palletized loads to and removal of palletized loads from palletized load storage locations including changeably designating a first plurality of the mutually adjacent palletized load storage/travel locations as palletized load storage locations and a second plurality of the mutually adjacent palletized load storage/travel locations as palletized load travel locations at a first time, and at a second time changeably designating a third plurality, different from the first plurality, of the mutually adjacent palletized load storage/travel locations as palletized load storage locations and a fourth plurality, different from the second plurality of the mutually adjacent palletized load storage/travel locations as palletized load travel locations, whereby at least some of the mutually adjacent palletized load storage/travel locations may belong to the first plurality at the first time and may belong to the fourth plurality at the second time.

Preferably, the plurality of horizontal storage levels are vertically offset from each other by differing amounts and the dynamically controlling placement of palletized loads includes selecting palletized load storage/travel locations in accordance with height of a palletized load.

In accordance with a preferred embodiment of the present invention the dynamically controlling placement of palletized loads includes simultaneously moving multiple palletized loads to enable access to a given palletized load storage/travel location.

There is even further provided in accordance with yet another preferred embodiment of the present invention an automated warehousing system including a structure for storage of palletized loads including palletized loads which are supported on at least two pallets, a plurality of palletized load transporters, each arranged to displace palletized loads in a plane and along a vertical axis perpendicular to the plane and a palletized load storage/travel controller operative to control operation of the plurality of palletized load transporters and to coordinate operation of at least two palletized load transporters for synchronized engagement with a single palletized load which is supported on at least two pallets, displacement thereof to a desired location and disengagement therefrom.

### BRIEF DESCRIPTION OF THE DRAWINGS

The present invention will be understood and appreciated from the following detailed description, taken in conjunction with the drawings in which:

FIGS. 1A & 1B are simplified illustrations of a modular pillar element employed in a dynamically configurable automated warehousing system in accordance with a preferred embodiment of the present invention;

FIG. 1C is a simplified illustration of a mounting element for mounting the modular pillar element of FIGS. 1A and 1B;

FIGS. 2A & 2B are respective simplified exploded view and assembled view pictorial illustrations of a modular multi-track support element employed in a dynamically configurable automated warehousing system in accordance with a preferred embodiment of the present invention;

FIGS. 3A, 3B and 3C are respective simplified pictorial illustrations of a first type of track element forming part of the modular multi-track support element of FIGS. 2A & 2B;

FIGS. 4A, 4B and 4C are respective simplified pictorial illustrations of a second type of track element forming part of the modular multi-track support element of FIGS. 2A & 2B;

FIGS. 5A and 5B are respective simplified pictorial illustrations of a palletized load support and pillar mounting element forming part of the modular multi-track support element of FIGS. 2A & 2B;

FIGS. 6A & 6B are respective simplified partially exploded, partial view illustrations of a three-directional palletized load transporter;

FIGS. 6C & 6D are respective simplified partially assembled view illustrations of the three-directional palletized load transporter of FIGS. 6A & 6B;

FIGS. 6E & 6F are respective simplified exploded view and assembled view pictorial illustrations of a Z-axis wheel lifting assembly forming part of the three-directional palletized load transporter of FIGS. 6A-6D;

FIG. 7 is a simplified illustration of the three-directional palletized load transporter of FIGS. 6A-6D in a first operative orientation;

FIG. 8 is a simplified illustration of the three-directional palletized load transporter of FIGS. 6A-6D in a second operative orientation;

FIG. 9 is a simplified illustration of the three-directional palletized load transporter of FIGS. 6A-6D in a third operative orientation;

FIG. 10 is a simplified illustration of the three-directional palletized load transporter of FIGS. 6A-6D in a fourth operative orientation;

FIG. 11 is a simplified illustration of the three-directional palletized load transporter of FIGS. 6A-6D in a fifth operative orientation;

FIG. 12 is a simplified illustration of the three-directional palletized load transporter of FIGS. 6A-6D in a sixth operative orientation;

FIGS. 13A, 13B, 13C, 13D, 13E, 13F and 13G are simplified illustrations of various stages in the construction of a dynamically configurable automated warehousing system in accordance with a preferred embodiment of the present invention;

FIGS. 14A, 14B, 14C, 14D, 14E, 14F, 14G and 14H are simplified illustrations of various operational configurations of the dynamically configurable automated warehousing system of FIGS. 1A-12 in accordance with a preferred embodiment of the present invention;

FIGS. 15A, 15B, 15C, 15D, 15E and 15F are simplified illustrations of various stages in one aspect of the operation of the dynamically configurable automated warehousing system of FIGS. 1A-12;

FIGS. 16A, 16B, 16C, 16D, 16E, 16F, 16G, 16H, 16I, 16J, 16K, 16L and 16M are simplified illustrations of various stages in another aspect of the operation of the dynamically configurable automated warehousing system of FIGS. 1A-12;

FIGS. 17A, 17B, 17C, 17D and 17E are simplified illustrations of various stages in a further aspect of the operation of the dynamically configurable automated warehousing system of FIGS. 1A-12, which are combinable with one or both aspects of the operation of the dynamically configurable automated warehousing system of FIGS. 1A-12 shown in FIGS. 15A-16M;

FIGS. 18A, 18B, 18C, 18D, 18E, 18F, 18G, 18H, 18I, 18J and 18K are simplified illustrations of various stages in a yet further aspect of the operation of the dynamically configurable automated warehousing system of FIGS. 1A-12, which are combinable with one or both aspects of the operation of the dynamically configurable automated warehousing system of FIGS. 1A-12, shown in FIGS. 15A-16M;

FIGS. 19A, 19B, 19C, 19D, 19E, 19F, 19G, 19H and 19I are simplified illustrations of various stages in a still further aspect of the operation of the dynamically configurable automated warehousing system of FIGS. 1A-12, which are combinable with one or both aspects of the operation of the dynamically configurable automated warehousing system of FIGS. 1A-12, shown in FIGS. 15A-16M;

FIGS. 20A, 20B and 20C are simplified illustrations of various stages in another further aspect of the operation of the dynamically configurable automated warehousing system of FIGS. 1A-12, which are combinable with one or both aspects of the operation of the dynamically configurable automated warehousing system of FIGS. 1A-12, shown in FIGS. 15A-16M;

FIGS. 21A, 21B and 21C are simplified illustrations of various stages in yet another further aspect of the operation of the dynamically configurable automated warehousing system of FIGS. 1A-12, which are combinable with one or both aspects of the operation of the dynamically configurable automated warehousing system of FIGS. 1A-12, shown in FIGS. 15A-16M;

FIG. 22 is a simplified illustration of a control network interconnecting various controllable elements in the dynamically automated warehousing system of FIGS. 1A-21C;

FIGS. 23A and 23B are respective simplified exploded view and assembled view pictorial illustrations of a modular multi-track support element employed in the construction of a dynamically configurable automated warehousing system in accordance with another preferred embodiment of the present invention;

FIGS. 24A, 24B and 24C are respective simplified pictorial illustrations of a first type of track element forming part of the modular multi-track support element of FIGS. 23A & 23B;

FIGS. 25A and 25B are respective simplified pictorial illustrations of a palletized load support element forming part of the modular multi-track support element of FIGS. 23A & 23B;

FIGS. 26A and 26B are simplified illustrations of a dynamically configurable automated warehousing system in accordance with another preferred embodiment of the present invention;

FIGS. 27A, 27B, 27C, 27D, 27E, 27F, 27G, 27H, 27I, 27J, 27K and 27L are simplified illustrations of various stages in the operation of the dynamically configurable automated warehousing system of FIGS. 26A and 26B;

FIGS. 28A, 28B, 28C and 28D are simplified illustrations of various stages in the operation of the dynamically configurable automated warehousing system of FIGS. 26A and 26B; and

FIGS. 29A, 29B, 29C and 29D are simplified illustrations of various stages in still another aspect of the operation of the dynamically configurable automated warehousing system of FIGS. 1A-13G, at a top level thereof, which may also be utilized in the dynamically configurable automated warehousing system of FIGS. 26A and 26B at any level thereof.

### DETAILED DESCRIPTION OF PREFERRED EMBODIMENTS

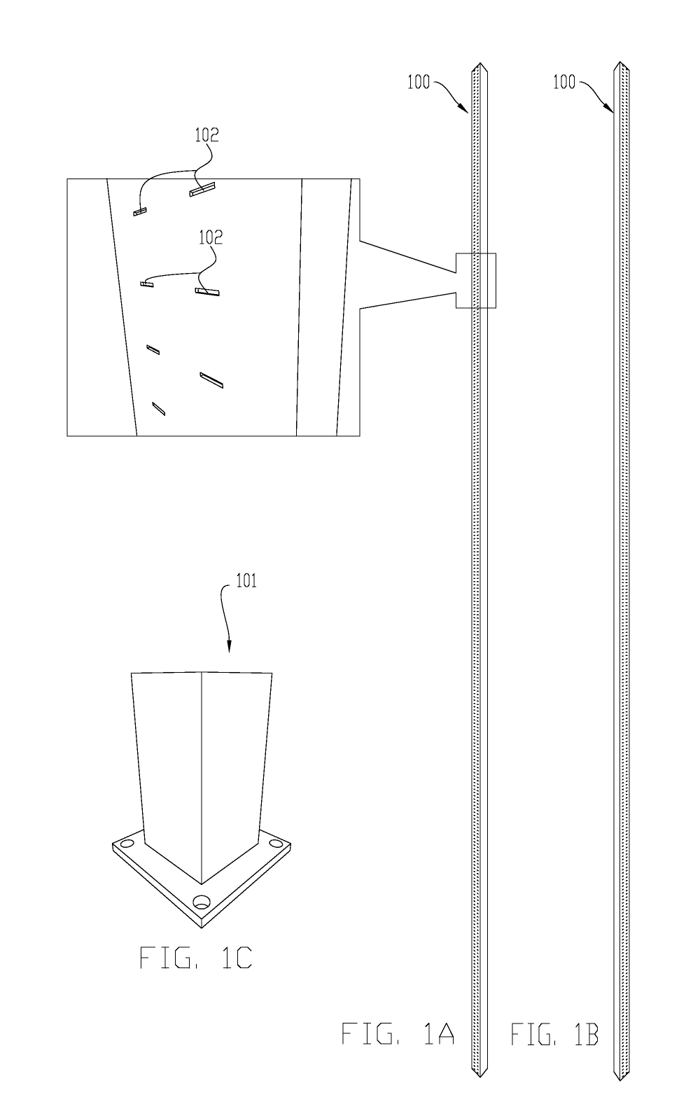

Reference is now made to FIGS. 1A & 1B, which are simplified illustrations of a modular pillar element 100 employed in the construction of a dynamically configurable automated warehousing system in accordance with a preferred embodiment of the present invention, and to FIG. 1C, which is a simplified illustration of a mounting plate element 101 for mounting the modular pillar element 100. As seen in FIGS. 1A & 1B, the pillar elements are preferably elongate steel pillars having a uniform, generally rectangular cross section. The length and cross-sectional dimensions of the pillar elements 100 are governed by the number of storage levels in the automated warehousing system and the weight capacities thereof. It is appreciated that the vertical separation between various storage levels may vary from level to level, so as to accommodate palletized loads of differing heights in a volume efficient manner.

Preferably pillar elements 100 are formed along at least two opposite side surfaces thereof with a series of mounting slots 102, for receiving mounting protrusions of elements which are supported thereon. In the present example, pillar elements 100 have a typical length of 18 meters and outer cross-sectional dimensions of 20 cm×20 cm. Mounting slots 102 preferably have a length of 22 mm, a width of 5 mm and a vertical spacing therebetween of 6 cm. Preferably, pillar elements 100 are bolted onto mounting plate elements 101, which, in turn, are preferably arranged to be bolted onto a support surface, such as a concrete slab.

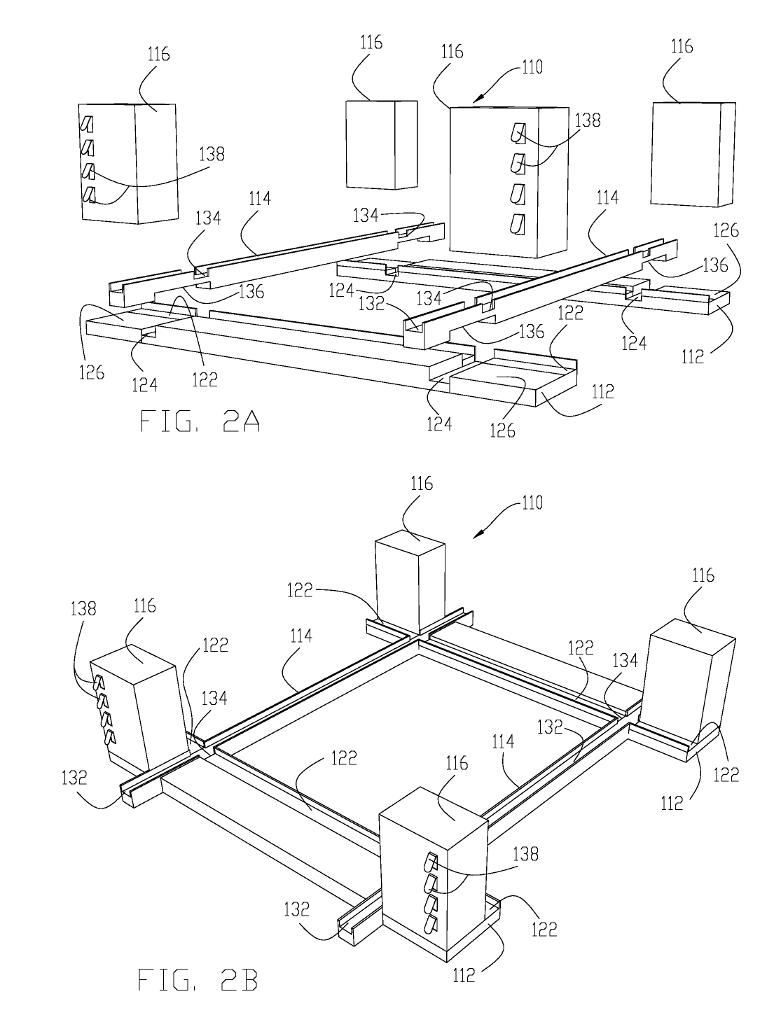

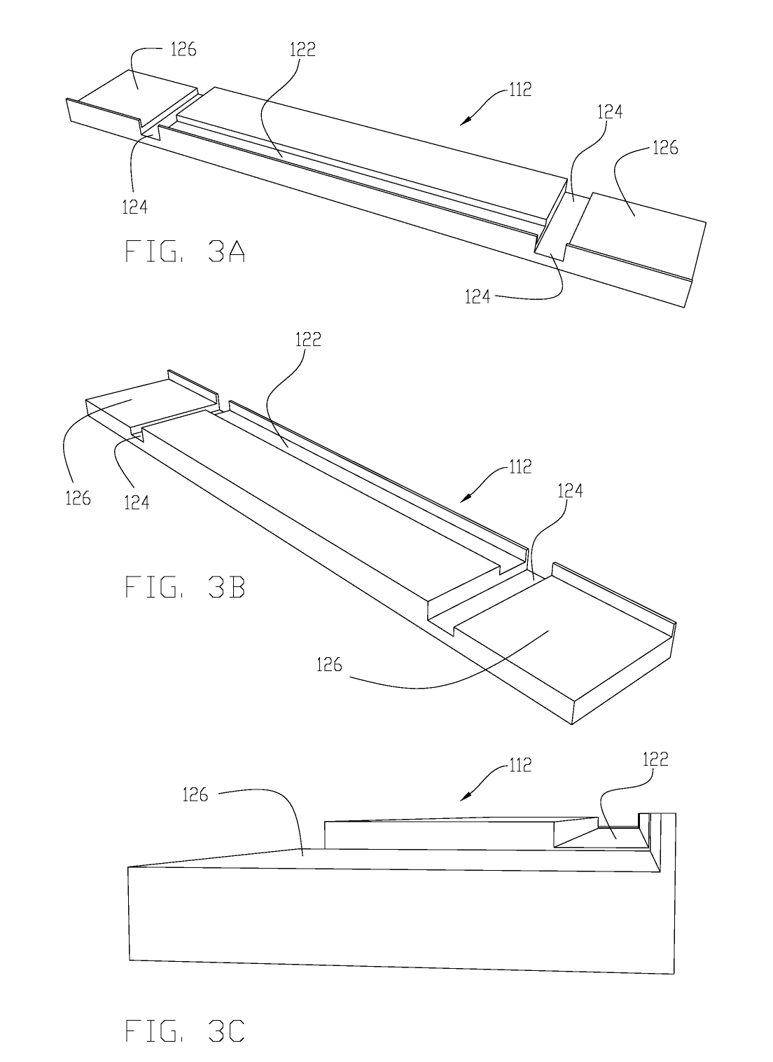

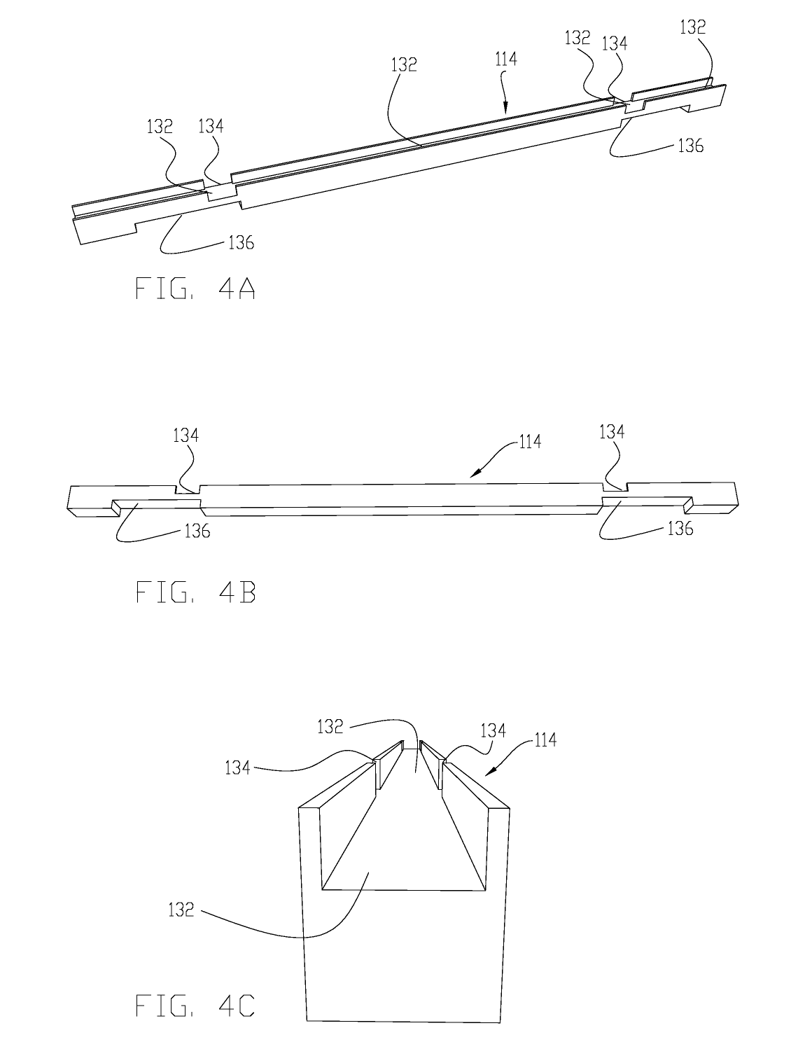

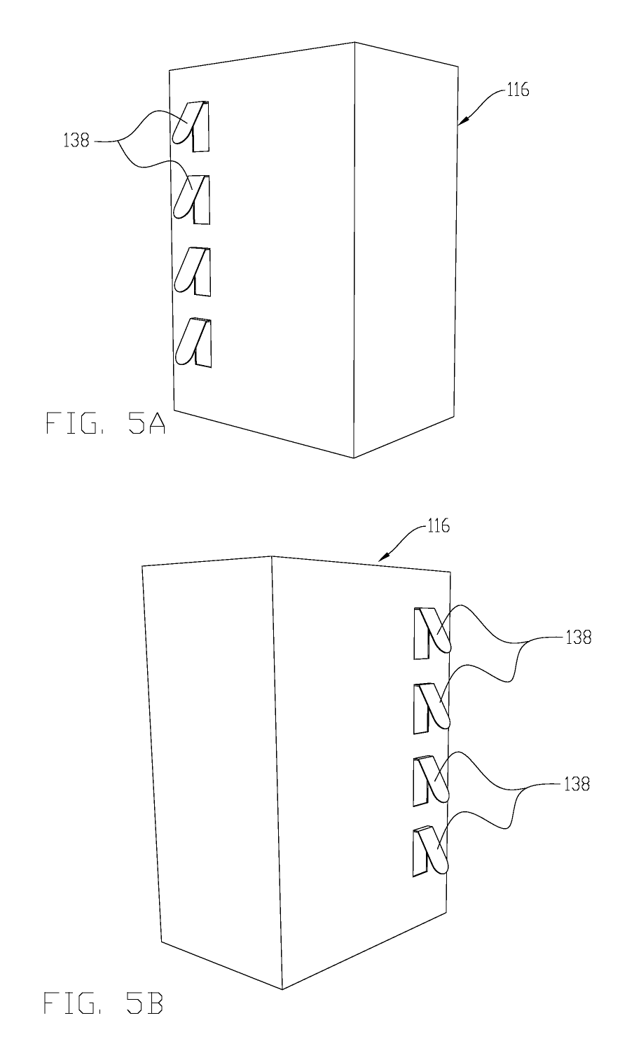

Reference is now made to FIGS. 2A & 2B, which are respective simplified exploded view and assembled view pictorial illustrations of a modular multi-track support element 110 employed in the construction of a dynamically configurable automated warehousing system in accordance with a preferred embodiment of the present invention. Reference is also made to FIGS. 3A, 3B and 3C, which are respective simplified pictorial illustrations of a first type of track element forming part of the modular multi-track support element of FIGS. 2A & 2B, to FIGS. 4A and 4B, which are respective simplified pictorial illustrations of a second type of track element forming part of the modular multi-track support element of FIGS. 2A & 2B, and to FIGS. 5A and 5B, which are respective simplified pictorial illustrations of a palletized load support and pillar mounting element forming part of the modular multi-track support element of FIGS. 2A & 2B.

As seen in FIGS. 2A-5B, the modular multi-track support element 110 is preferably a welded or bolted unit, formed of a pair of generally parallel first track elements 112, a pair of generally parallel second track elements 114, preferably mounted on said pair of first track elements 112, and four palletized load support and pillar mounting elements 116, which are fixed to the four corners of the first track elements 112.

Turning now additionally and specifically to FIGS. 3A, 3B & 3C, it is seen that first track elements 112 preferably are each generally elongate elements having an overall generally rectangular cross section. Each track element 112 is preferably formed with a longitudinal recess 122 extending along the entire length thereof and defining a first track. Each track element 112 is also preferably formed with a pair of mutually spaced transverse recesses 124, which intersect recess 122. It is seen that transverse recesses 124 are deeper than longitudinal recess 122. Each track element 112 is also formed with generally rectangular reduced thickness regions 126.

Turning now additionally and specifically to FIGS. 4A-4C, it is seen that second track elements 114 preferably are each generally elongate elements having an overall generally rectangular cross section. Each track element 114 is preferably formed with a longitudinal recess 132 extending along the entire length thereof and defining a second track. Each track element 114 is also preferably formed with a pair of mutually spaced transverse cuts 134, which intersect recess 132. Each track element 114 is also preferably formed with a pair of mutually spaced transverse cuts 136, part of which underlie transverse cuts 134.

Turning now additionally and specifically to FIGS. 5A & 5B, it is seen that palletized load support and pillar mounting elements 116 are preferably generally rectangular closed hollow elements having formed on at least one side surface thereof a vertical array of mounting protrusions 138 which are preferably configured for secure mounting of palletized load support and pillar mounting elements 116 and thus of modular multi-track support element 110 on multiple pillar elements 100 via engagement with a corresponding vertical array of series of mounting slots 102 formed on each of pillar elements 100.

In the example shown in FIGS. 2A-5B, it is seen that second track elements 114 are preferably mounted perpendicularly to first track elements 112 and lie in transverse recesses 124. The various thicknesses of the elements and the recesses and cut outs formed therein are preferably such that the first and second tracks are of generally uniform dimensions all along the first and second track elements 112 and 114, including the regions at which they overlap and at which the first and second tracks intersect.

Palletized load support and pillar mounting elements 116 are preferably welded onto reduced thickness regions 126 at four corners of the modular multi-track support element 110.

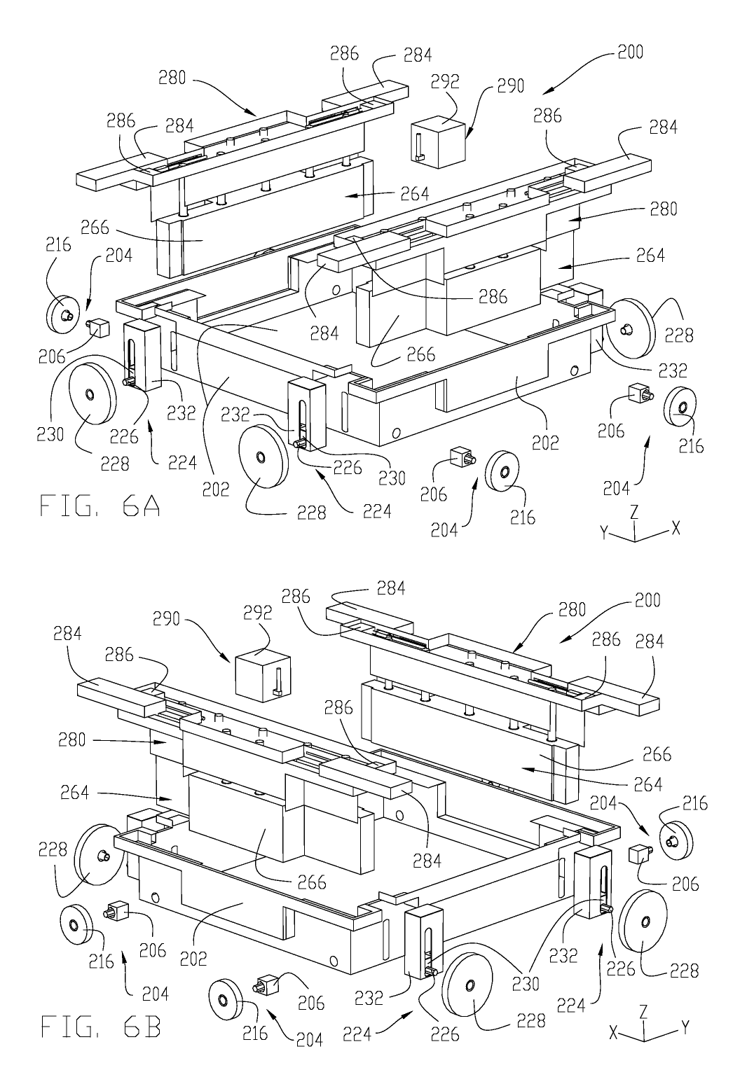

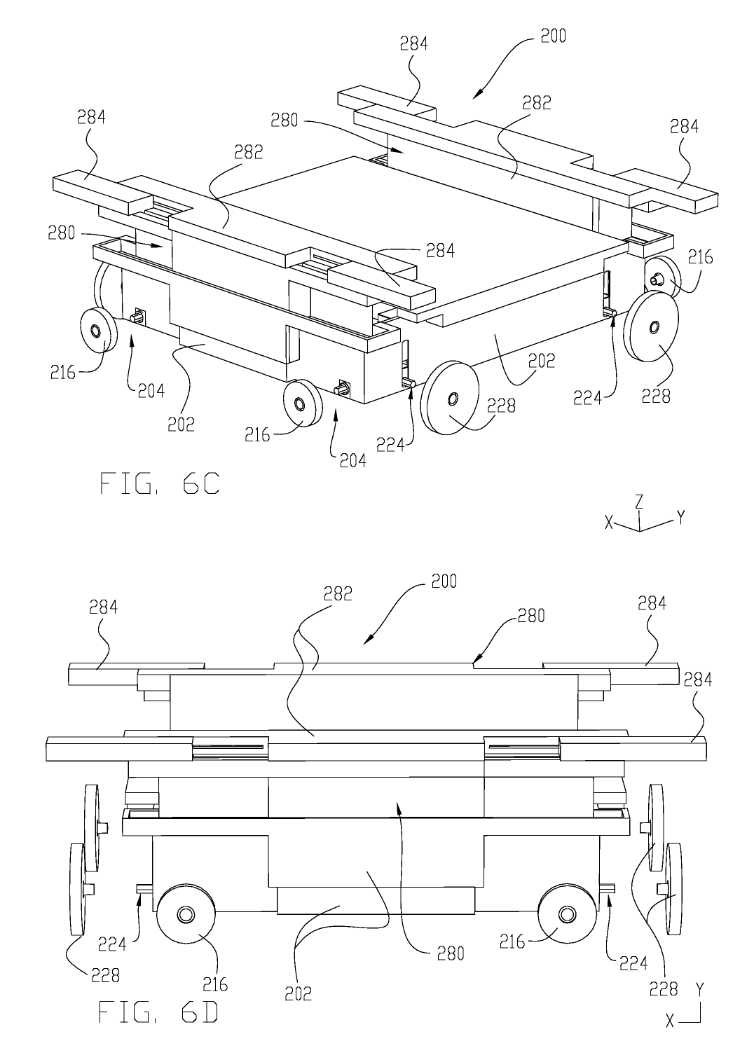

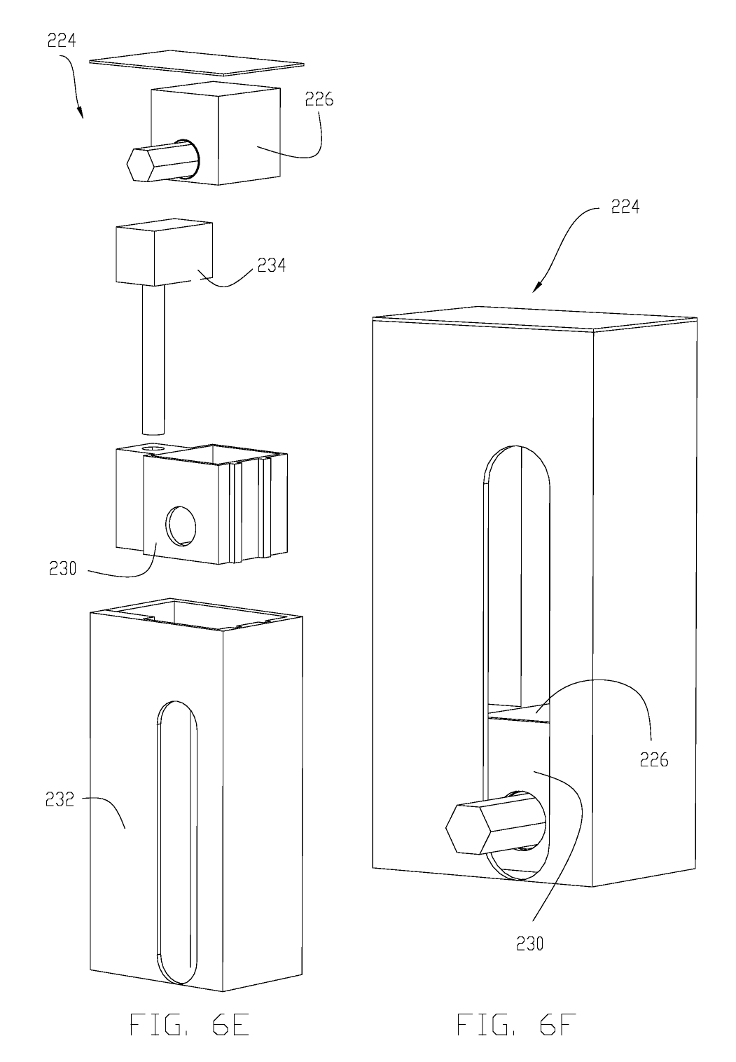

Reference is now made to FIGS. 6A & 6B, which are respective simplified partially pictorial and partially schematic exploded partial view illustrations of a three-directional palletized load transporter 200 preferably employed in a dynamically configurable automated warehousing system in accordance with a preferred embodiment of the present invention, to FIGS. 6C & 6D, which are respective simplified partially pictorial and partially schematic assembled view illustrations of the three-directional palletized load transporter 200 of FIGS. 6A & 6B, and to FIGS. 6E & 6F, which are respective simplified exploded view and assembled view pictorial illustrations of a Z-axis wheel positioning assembly forming part of the three-directional palletized load transporter of FIGS. 6A-6D.

The transporter 200 preferably comprises a generally planar, generally square chassis 202 onto which are mounted four X-axis driving assemblies 204. Each X-axis driving assembly 204 preferably includes an electric step motor 206, mounted on chassis 202 for selectably driving a wheel 216. Wheels 216 are configured for travel along and within longitudinal recesses 122 formed in track elements 112.

The transporter 200 also preferably comprises four Y-axis driving assemblies 224. Each Y-axis driving assembly 224 preferably includes an electric step motor 226 for selectably driving a wheel 228. Wheels 228 are configured for travel along and within longitudinal recesses 132 formed in track elements 114.

Each electric step motor 226 is preferably mounted onto a selectably vertically positionable motor mount 230, which is preferably selectably vertically positionable within a vertical track element 232 as by a linear motor 234, which is fixed to vertical track element 232. Each vertical track element 232 is fixed to chassis 202 adjacent a corner thereof.

A Z-axis load lifting assembly 264 is also preferably mounted onto chassis 202. The Z-axis load lifting assembly 264 preferably includes a pair of multi-shaft linear motors 266, which are each mounted on chassis 202 and are operative for selectably positioning along the Z-axis, a palletized load side support assembly 280. Each palletized load side support assembly 280 preferably includes a base element 282 onto which are slidably mounted a pair of oppositely extendible palletized load corner supports 284, which are each selectably positionable along an X-axis relative to base element 282 as by a linear motor 286.

A transporter controller 290 preferably governs operation of the various electric motors and is associated with a transporter wireless communicator 292 for control and status feedback communication with other parts of the automated warehousing system, which are described hereinbelow with reference to FIG. 22.

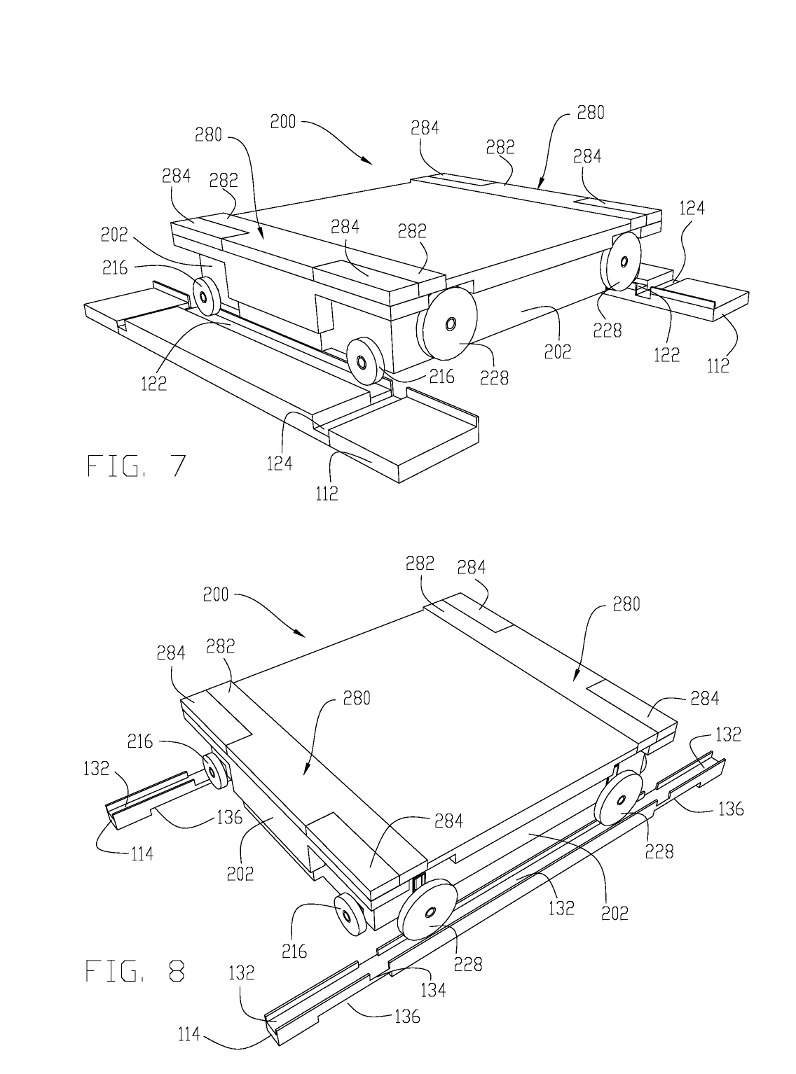

Reference is now made to FIG. 7, which is a simplified illustration of the three-directional palletized load transporter 200 of FIGS. 6A & 6B in a first operative orientation wherein wheels 216 are configured for travel along and within longitudinal recesses 122 formed in track elements 112 and wheels 228 are raised with respect to chassis 202. In this first operative orientation, the load lifting assemblies 264 and the palletized load side support assemblies 280 are in their downwardmost positions and the extendible palletized load corner supports 284 are fully retracted.

Reference is now made to FIG. 8, which is a simplified illustration of the three-directional palletized load transporter 200 of FIGS. 6A & 6B in a second operative orientation wherein wheels 228 are lowered with respect to chassis 202 and are thus configured for travel along and within longitudinal recesses 132 formed in track elements 114. In this second operative orientation, chassis 202 and wheels 216 are raised relative to their position in the first operative orientation shown in FIG. 7, the palletized load side support assemblies 280 are in their downwardmost positions and the extendible palletized load corner supports 284 are fully retracted.

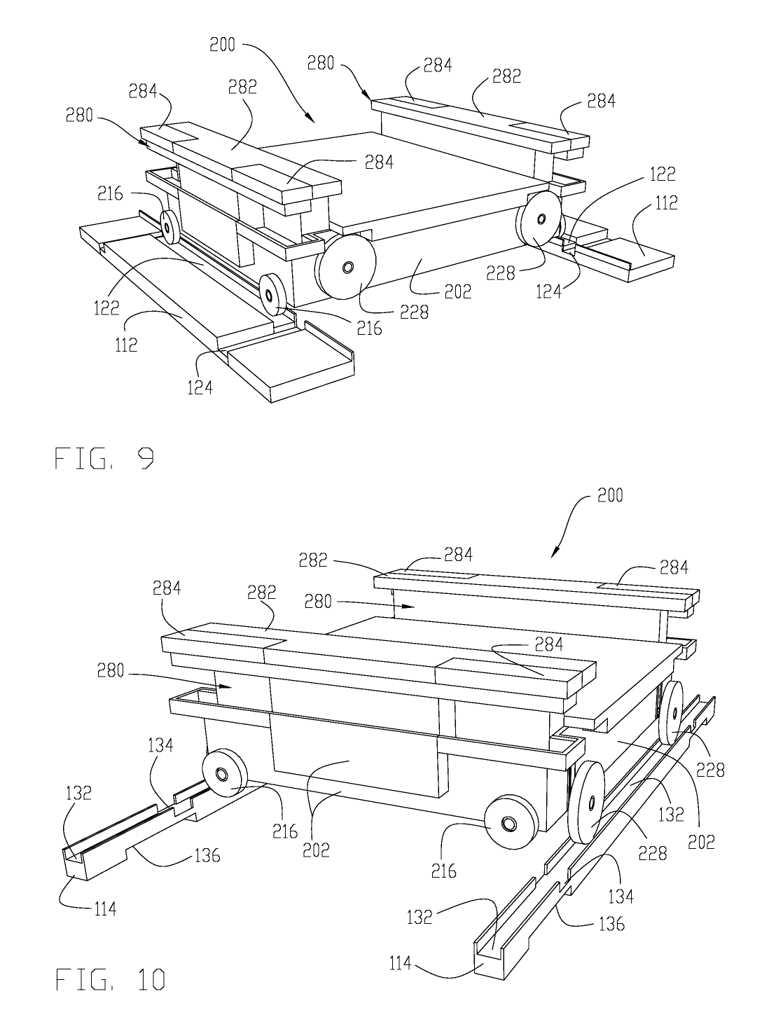

Reference is now made to FIG. 9, which is a simplified illustration of the three-directional palletized load transporter 200 of FIGS. 6A & 6B in a third operative orientation wherein wheels 216 are configured for travel along and within longitudinal recesses 122 formed in track elements 112 and wheels 228 are raised with respect to chassis 202. In this third operative orientation, the palletized load side support assemblies 280 are in their raised positions and the extendible palletized load corner supports 284 are fully retracted.

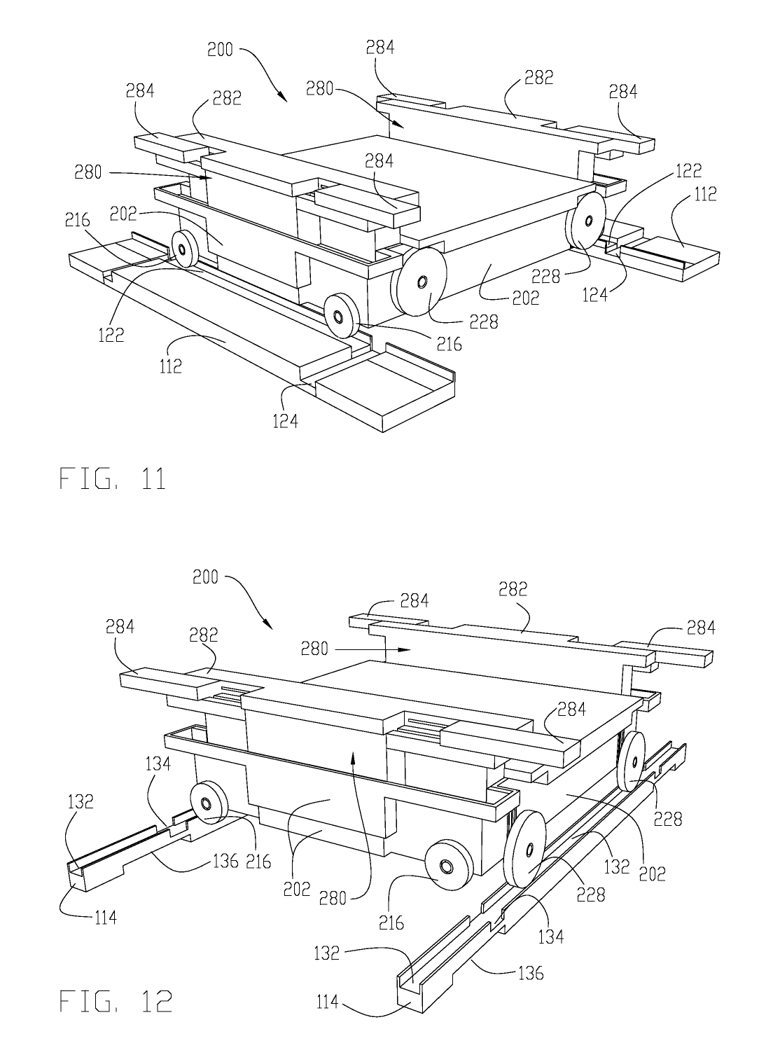

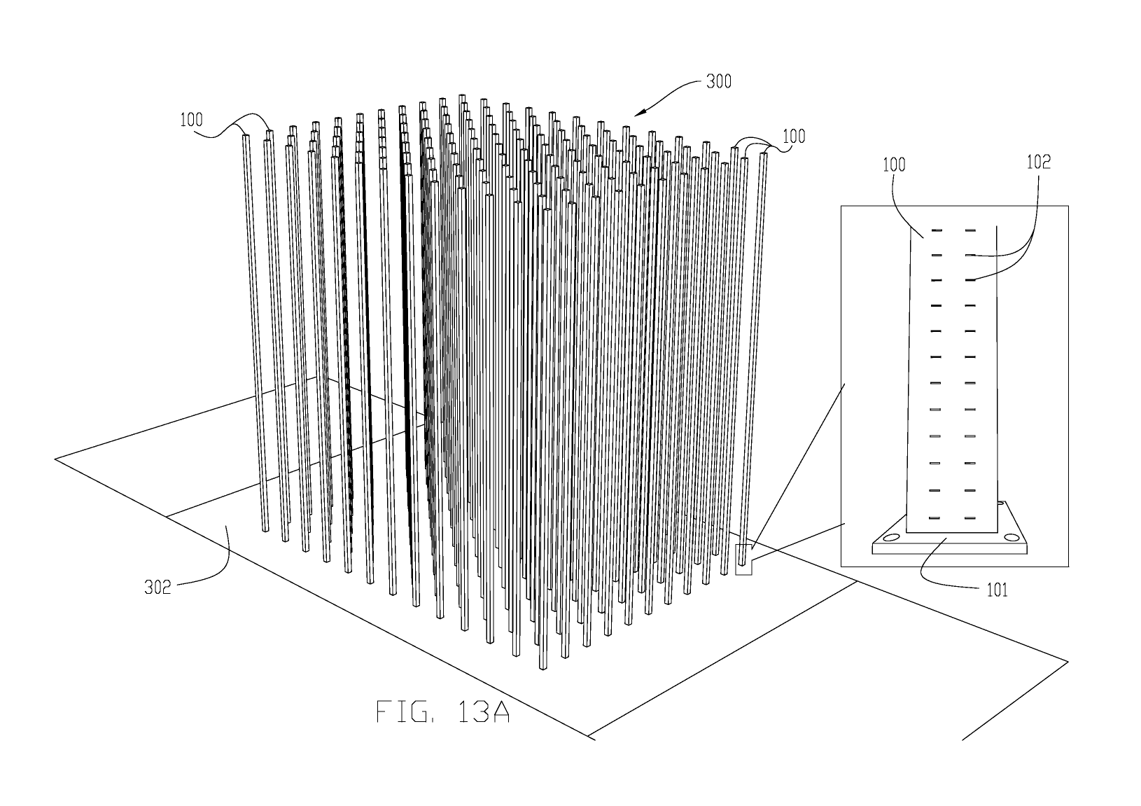

Reference is now made to FIG. 10, which is a simplified illustration of the three-directional palletized load transporter 200 of FIGS. 6A & 6B in a fourth operative orientation wherein wheels 228 are lowered with respect to chassis 202 and are thus configured for travel along and within longitudinal recesses 132 formed in track elements 114. In this fourth operative orientation, chassis 202 and wheels 216 are raised relative to their position in the third operative orientation shown in FIG. 9, the palletized load side support assemblies 280 are in their raised positions and the extendible palletized load corner supports 284 are fully retracted.

Reference is now made to FIG. 11, which is a simplified illustration of the three-directional palletized load transporter 200 of FIGS. 6A & 6B in a fifth operative orientation wherein wheels 216 are configured for travel along and within longitudinal recesses 122 formed in track elements 112 and wheels 228 are raised with respect to chassis 202. In this fifth operative orientation, the palletized load side support assemblies 280 are in their raised positions and the extendible palletized load corner supports 284 are fully extended.

Reference is now made to FIG. 12, which is a simplified illustration of the three-directional palletized load transporter 200 of FIGS. 6A & 6B in a sixth operative orientation wherein wheels 228 are lowered with respect to chassis 202 and are thus configured for travel along and within longitudinal recesses 132 formed in track elements 114. In this sixth operative orientation, chassis 202 and wheels 216 are raised relative to their position in the fifth operative orientation shown in FIG. 11, the palletized load side support assemblies 280 are in their raised positions and the extendible palletized load corner supports 284 are fully extended.

It is appreciated that three-directional palletized load transporter 200 is typically operational in the orientations of FIGS. 7 & 8 when being moved within a dynamically configurable automated warehouse in an unloaded condition and is typically operational in one of the orientations shown in FIGS. 9-12 when being moved within a dynamically configurable automated warehouse in a loaded condition.

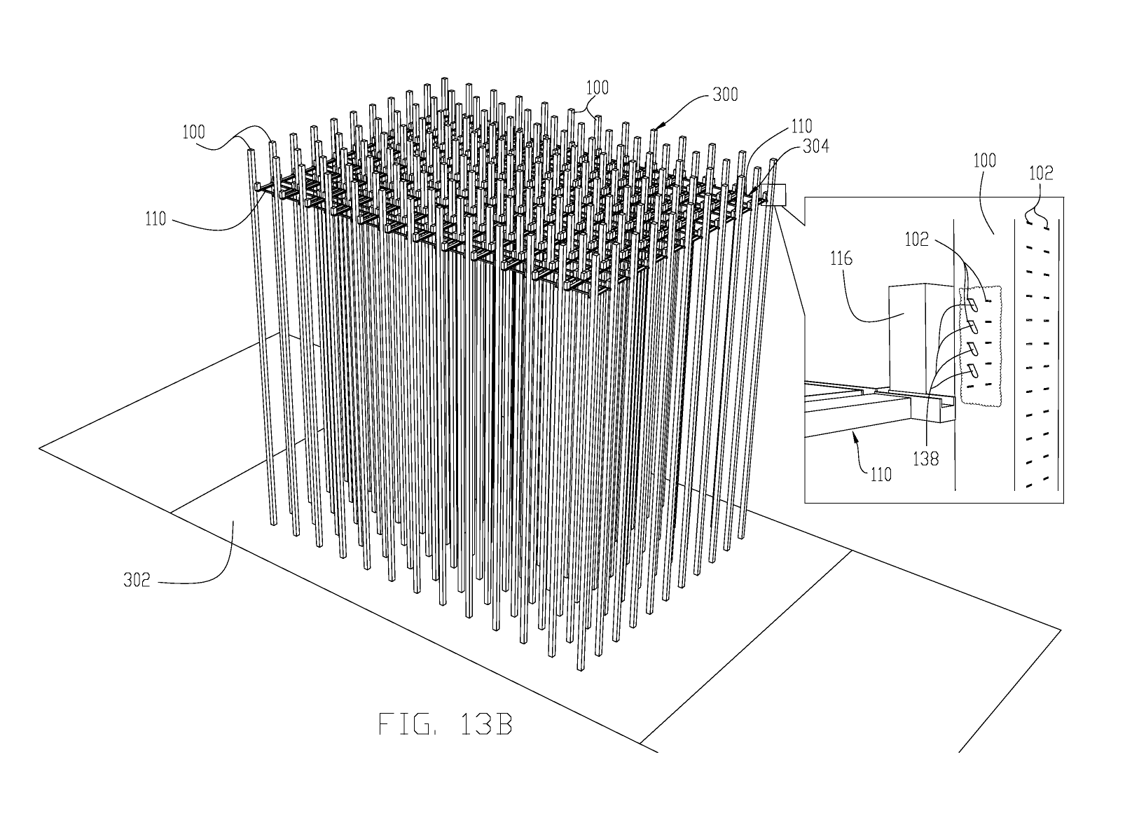

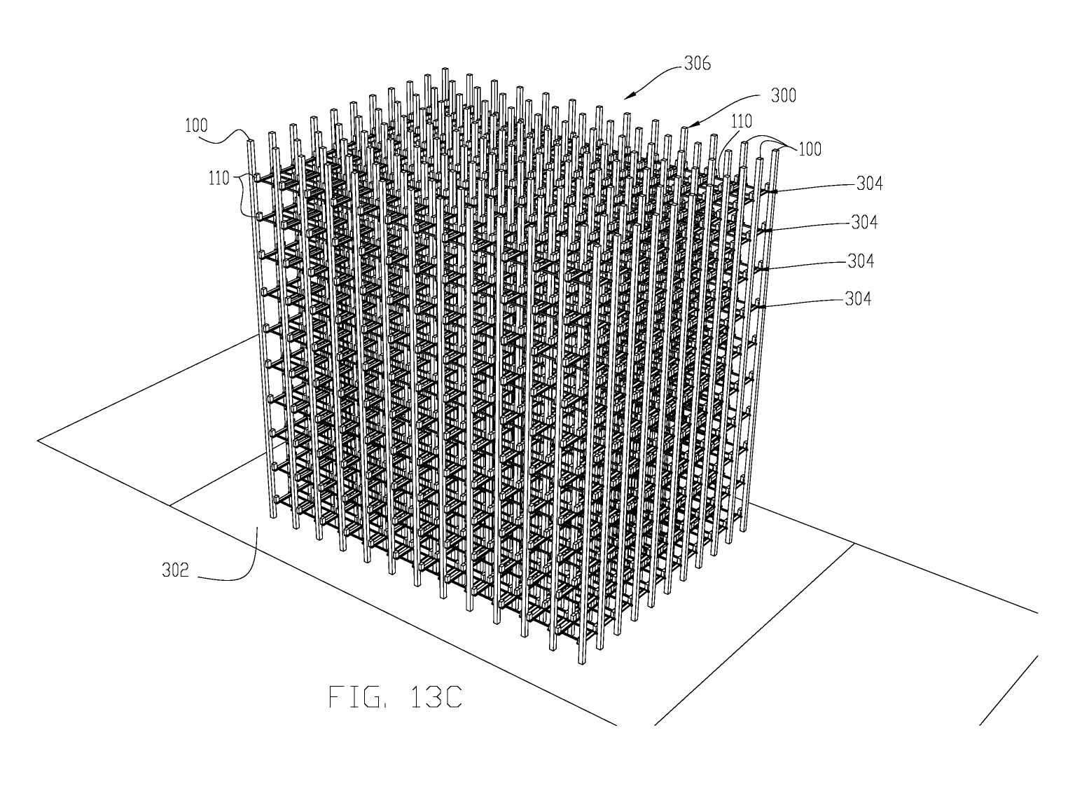

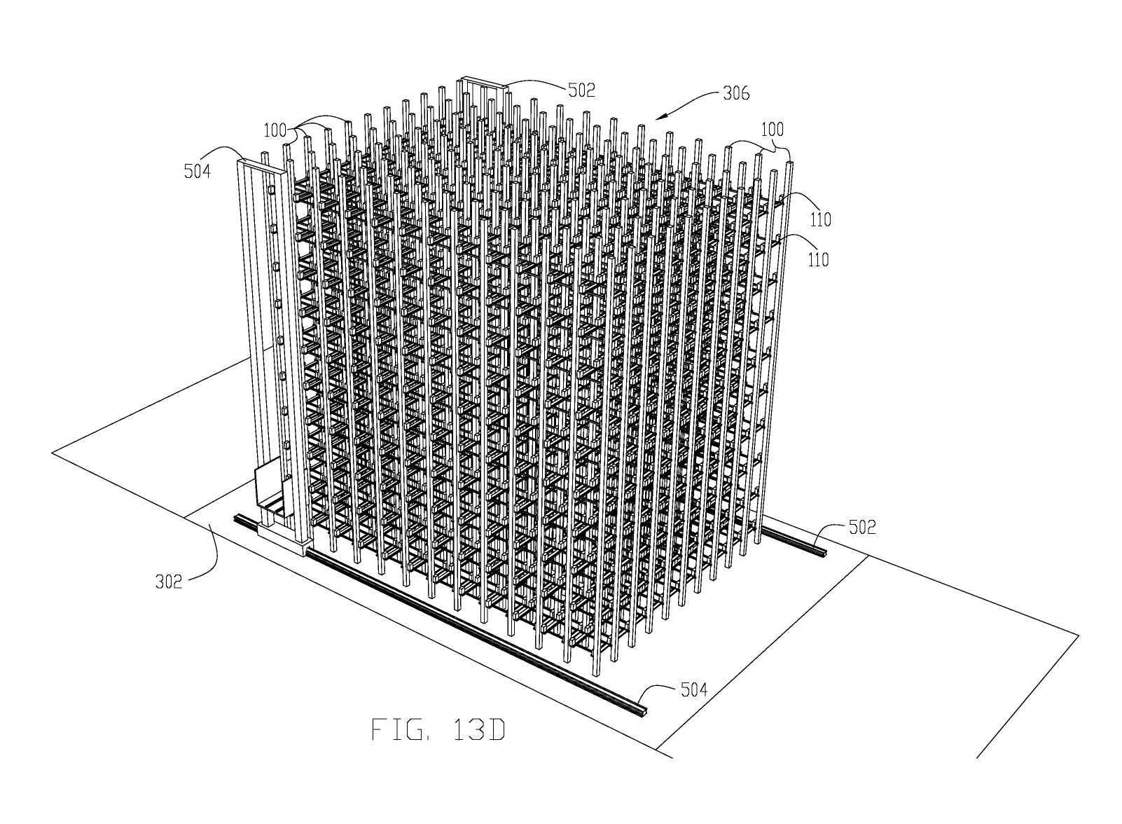

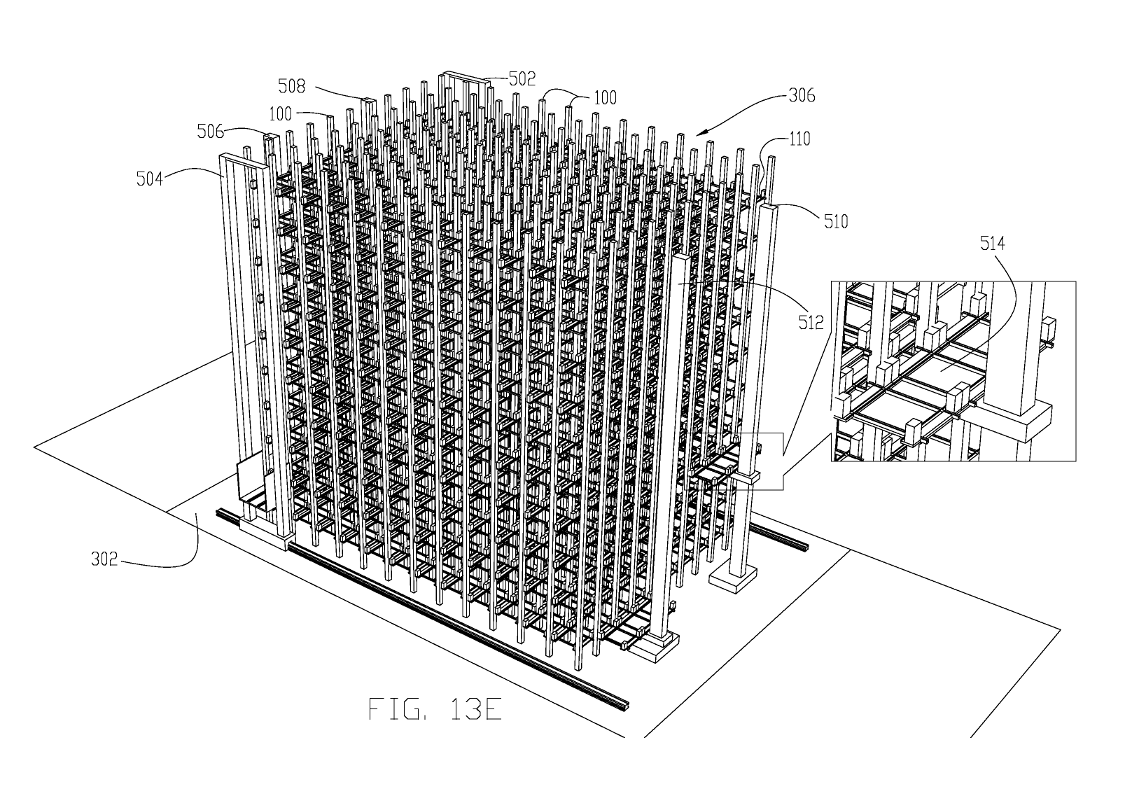

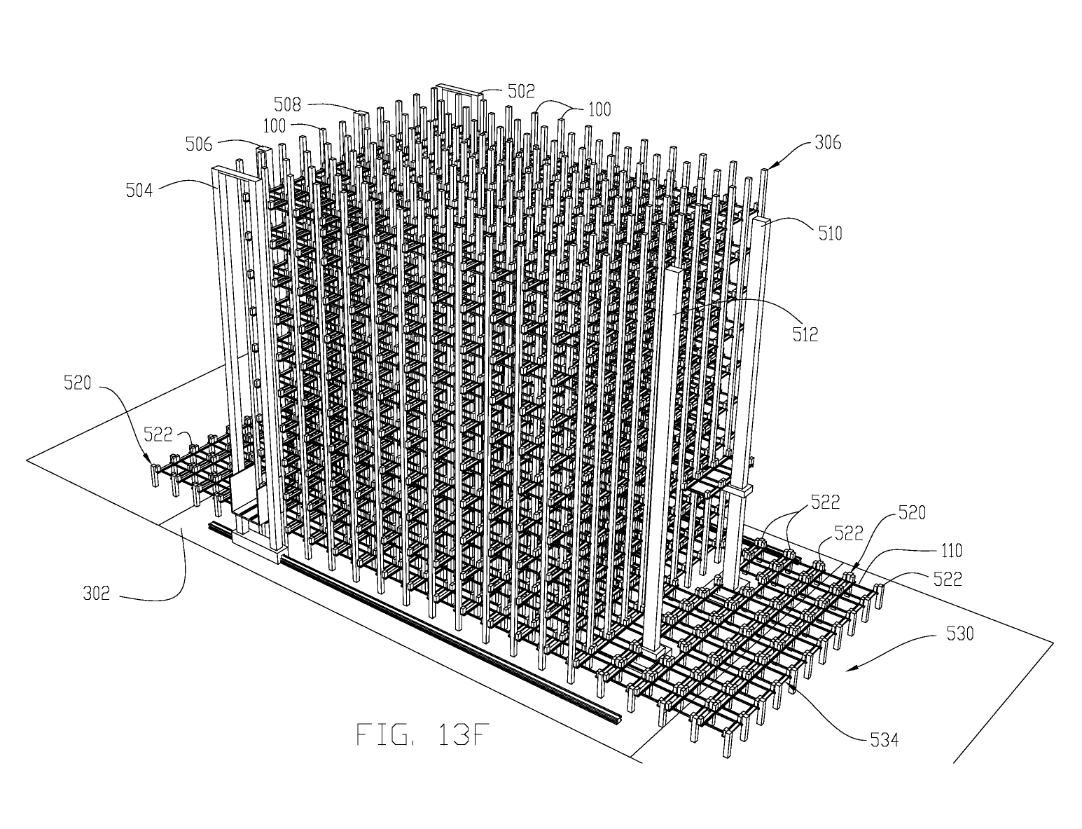

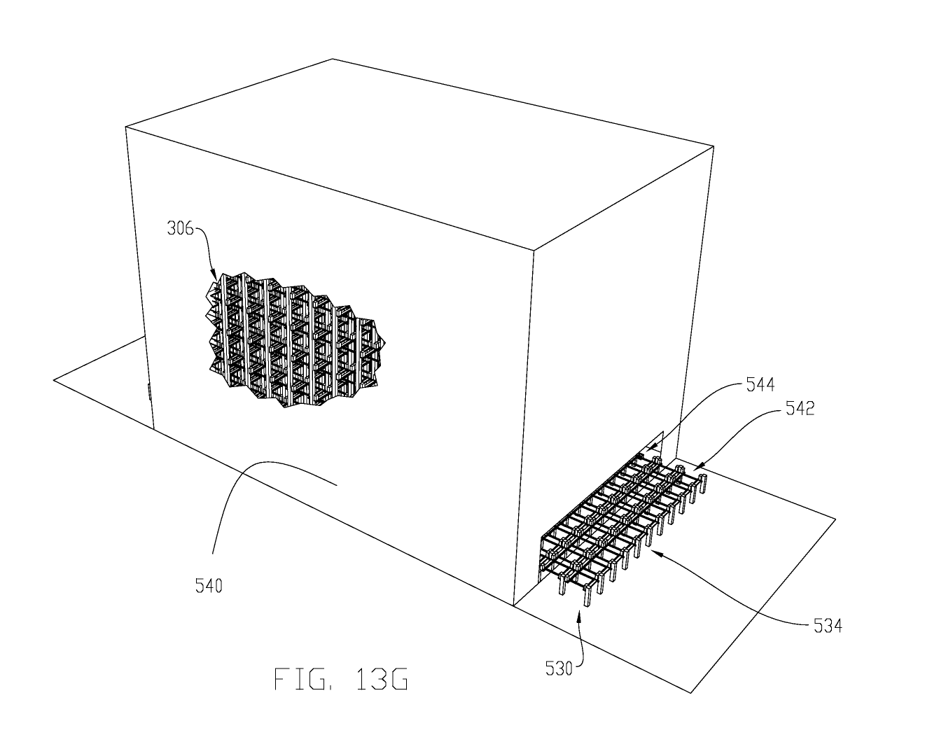

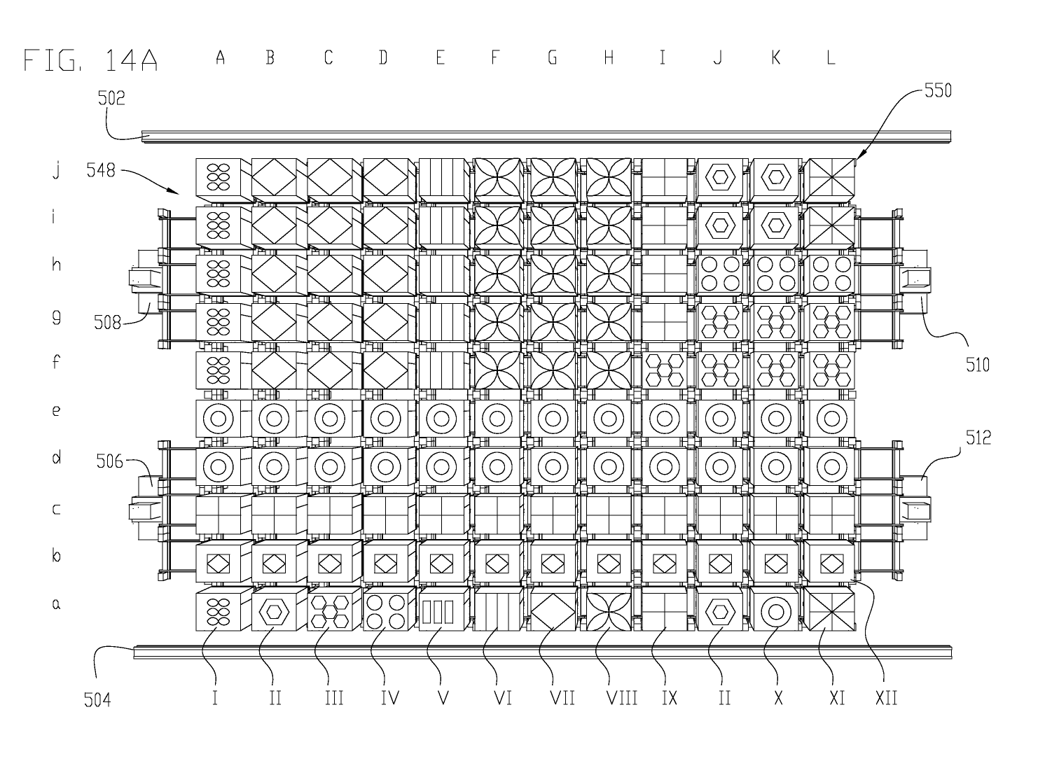

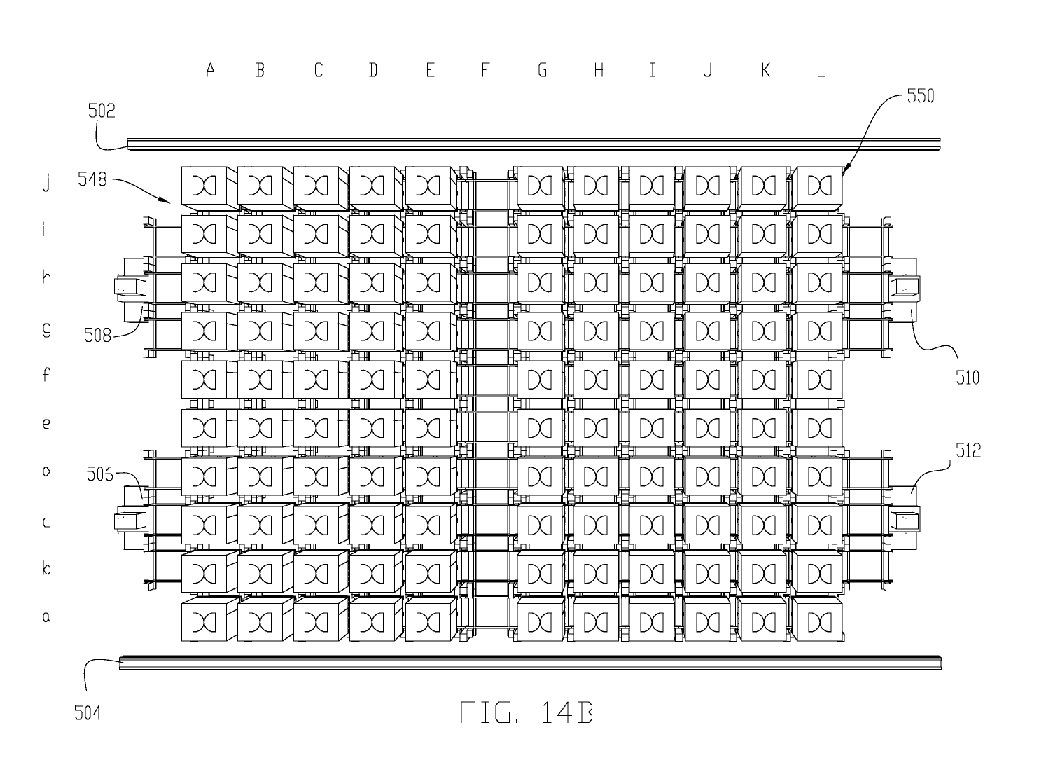

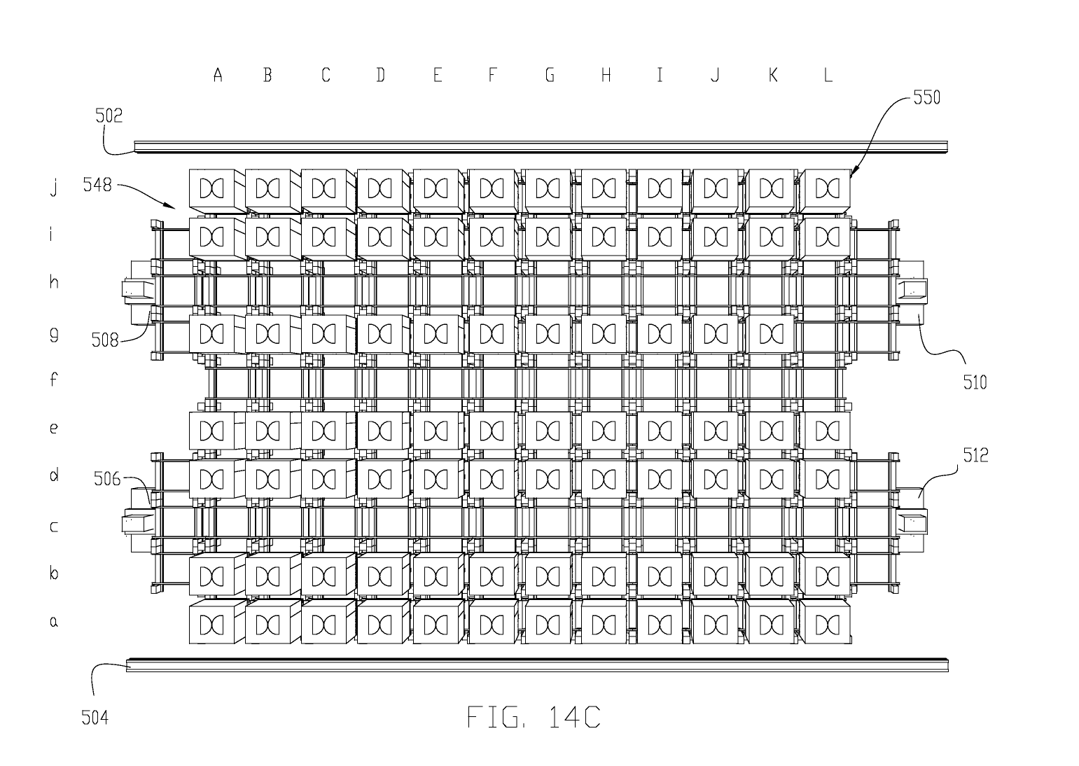

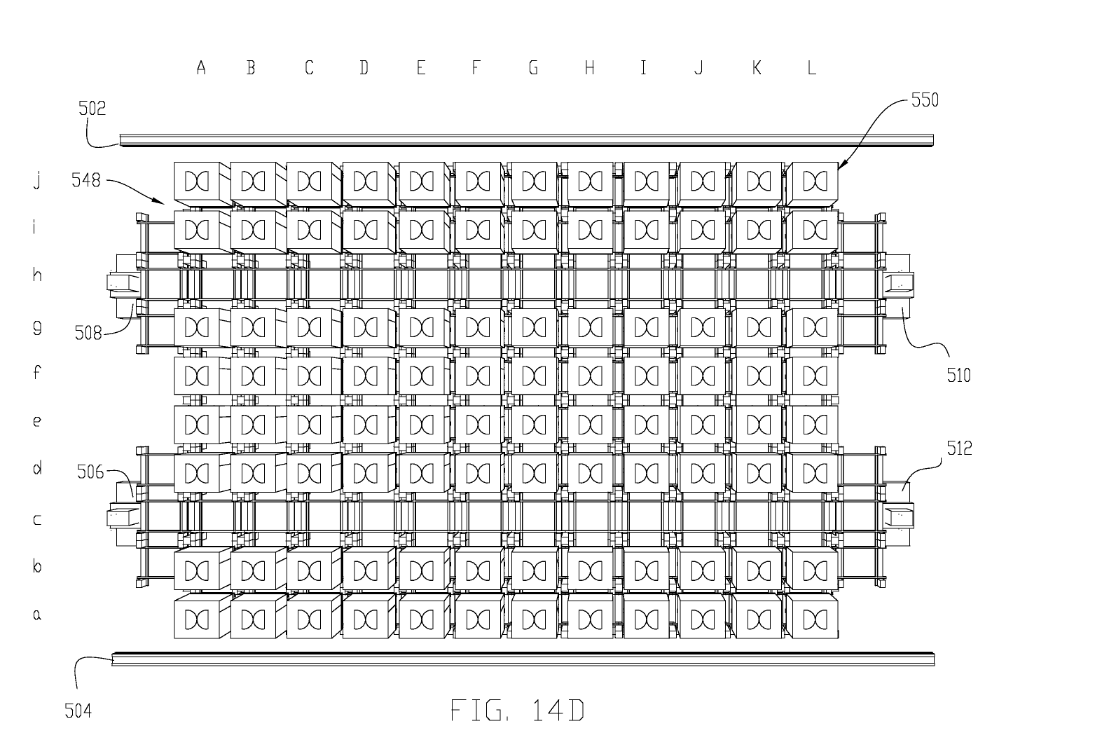

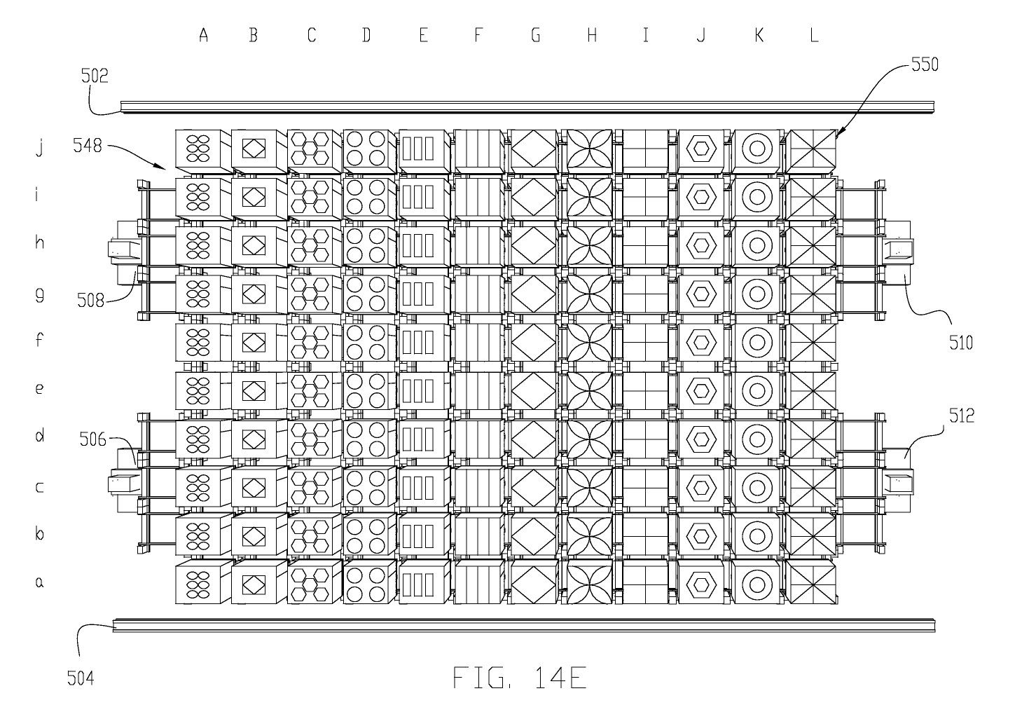

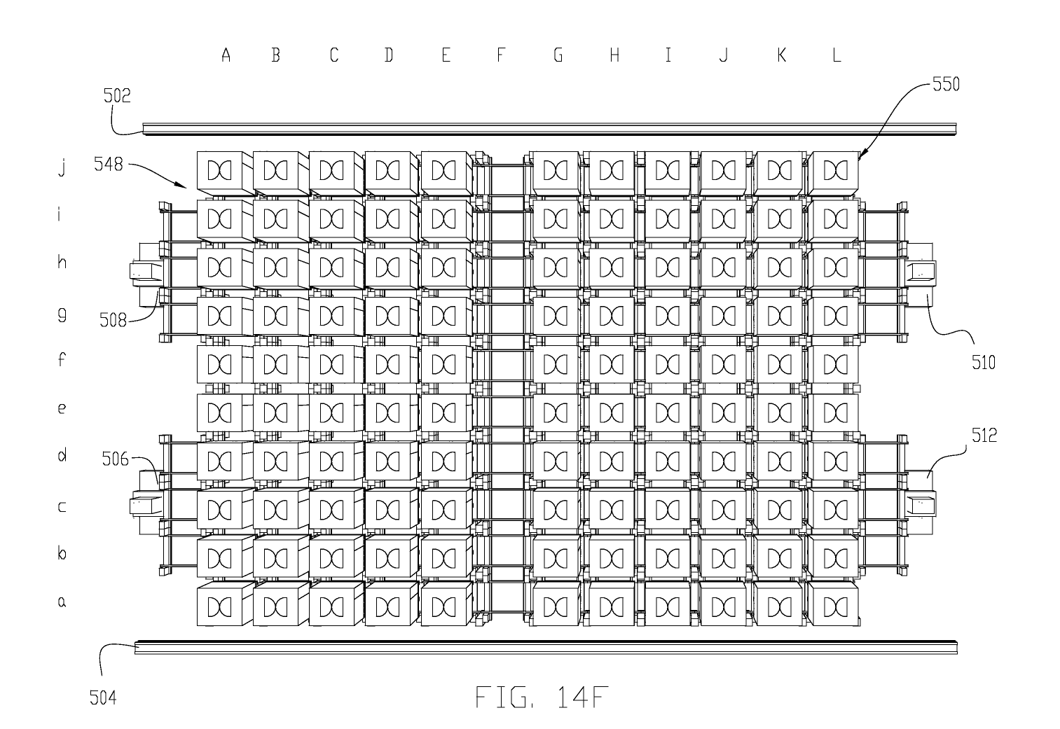

Reference is now made to FIGS. 13A, 13B, 13C, 13D, 13E, 13F and 13G, which are simplified illustrations of various stages in the construction of a dynamically configurable automated warehousing system in accordance with a preferred embodiment of the present invention. FIG. 13A shows an array 300 of pillar elements 100, having mounting slots 102 formed along at least two surfaces therealong, which are bolted via respective mounting elements 101 onto a support surface, such as a concrete slab 302. In the illustrated embodiment, array 300 includes 13 rows of pillar elements 100, each containing 11 pillar elements.

Turning to FIG. 13B, it is seen that a multiplicity of modular multi-track support elements 110 are mounted onto array 300, preferably by means of engagement of mounting protrusions 138 (FIG. 2A) in mounting slots 102 of pillar elements 100. FIG. 13B shows an uppermost level 304 of modular multi-track support elements 110 being mounted onto pillar elements 100. In the illustrated embodiment, a total of 120 modular multi-track support elements 110 are provided on each level.

FIG. 13C illustrates an assembled three-dimensional array 306 of modular multi-track support elements 110 mounted on pillar elements 100, the assembled three-dimensional array 306 including a total of ten levels 304 of modular multi-track support elements 110.

FIG. 13D shows installation of first and second tracked palletized load handling cranes 502 and 504 on respective opposite sides of the assembled three-dimensional array 306. Cranes 502 and 504 may be any suitable crane, preferably a model MTB 7, commercially available from Mecalux SA of Spain.

FIG. 13E shows installation of a pair of palletized load handling elevators 506, 508, 510 and 512 on two respective opposite sides of the assembled three-dimensional array 306 on which cranes 502 and 504 are not located. Elevators 506, 508, 510 and 512 may be any suitable elevator, preferably a model Scando 650 FC-XL, commercially available from Alimak AB of Sweden. Preferably, load platforms 514 of elevators 506, 508, 510 and 512 are each configured to define recesses and tracks identical to those in modular multi-track support elements 110 and aligned with corresponding recesses and tracks in adjacent ones of modular multi-track support elements 110. Preferably, the load platforms 514 of each of elevators 506, 508, 510 and 512 accommodate three palletized loads.

It is appreciated that, while the illustrated embodiment shown in FIG. 13E includes palletized load handling elevators on two opposite sides of array 306 and tracked palletized load handling cranes on two other opposite sides of array 306, elevators and cranes may be interchangeable and thus either only cranes or only elevators, as well as any other combination of cranes and elevators, may be utilized on all four sides of array 306.

FIG. 13F illustrates installation of an array 520 of typically short pillars 522, for supporting typically one level of modular multi-track support elements 110, defining a staging area in the vicinity of elevators 506, 508, 510 and 512 and outside three-dimensional array 306. FIG. 13F also shows an example of a staging area 530 defined by an array 534 of modular multi-track support elements 110 mounted on pillars 522, outside of three-dimensional array 306.

FIG. 13G illustrates installation of an enclosure 540 for three-dimensional array 306 which typically encloses part of the staging area 530 defined by array 534. Preferably, enclosure 540 separates an exterior portion 542 of the staging area from an interior portion 544 thereof.

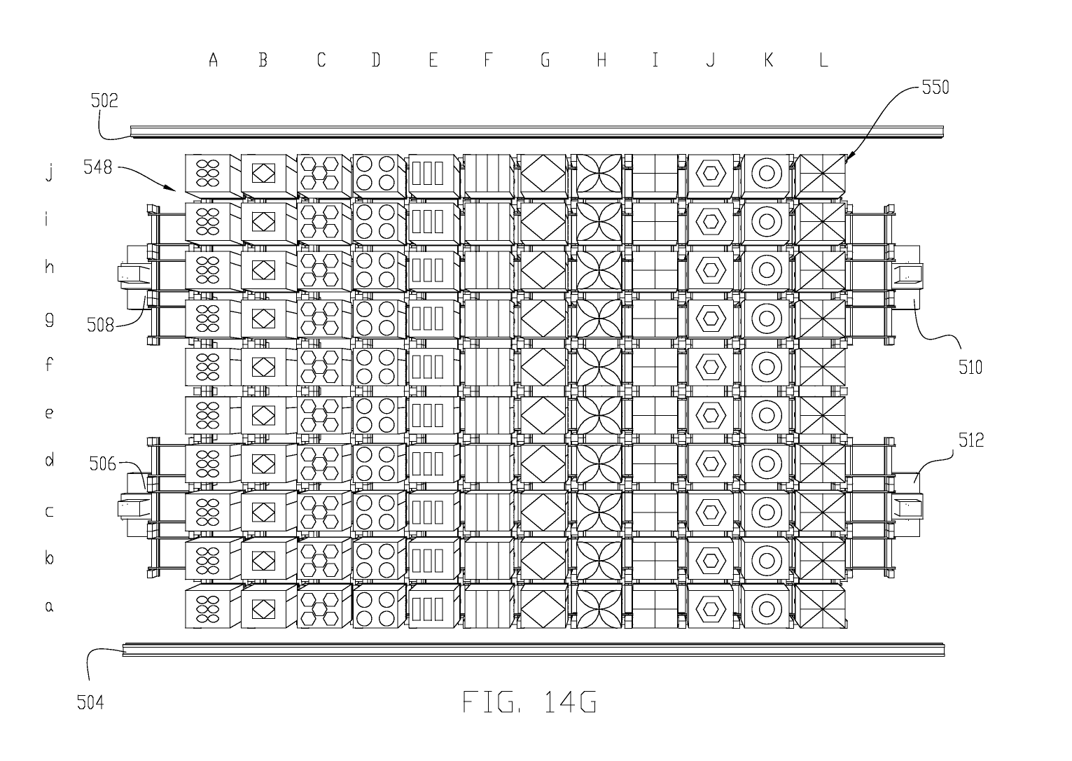

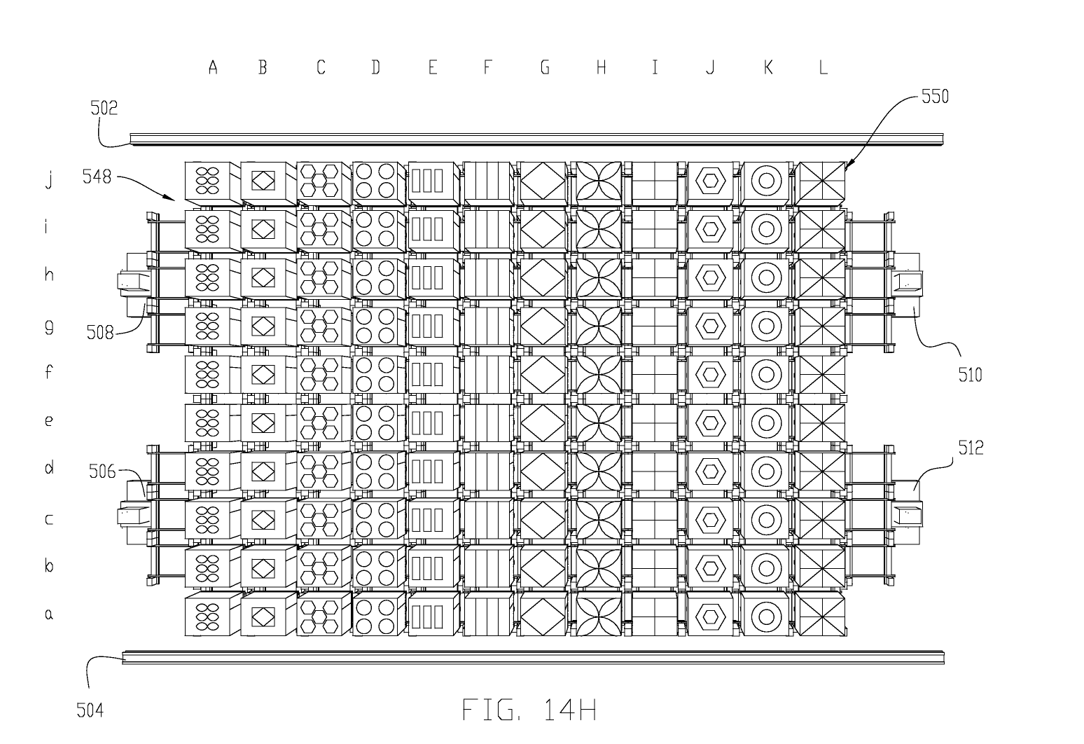

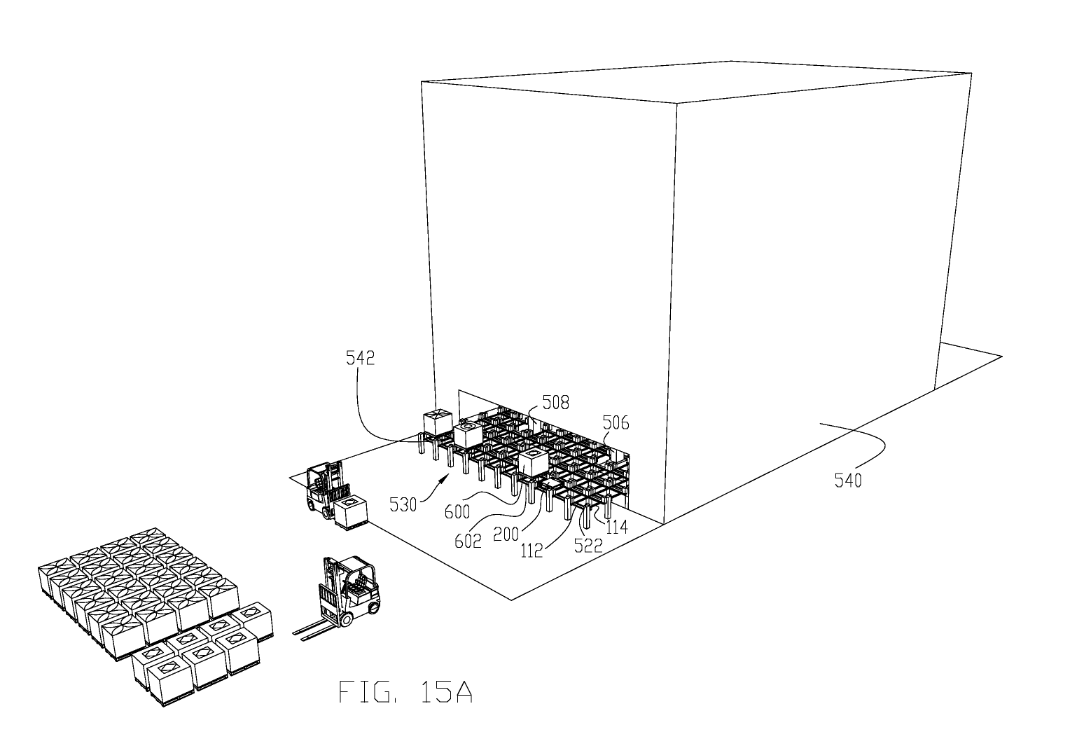

Reference is now made to FIGS. 14A, 14B, 14C, 14D, 14E, 14F, 14G and 14H, which are simplified illustrations of various operational configurations of the dynamically configurable automated warehousing system of FIGS. 1A-12 in accordance with a preferred embodiment of the present invention.

Turning to FIG. 14A, there is seen a simplified diagram of a first typical configuration of one level of the dynamically configurable automated warehousing system of FIGS. 1A-12, typically including a 10×12 grid 548 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j, corresponding to columns labeled in small letters.

In the configuration of FIG. 14A there are typically shown 12 different types of palletized loads, each identified by a different symbol and by a different Roman numeral, namely I, II, III, IV, V, VI, VII, VIII, IX, X, XI and XII.

It is a particular feature of a preferred embodiment of the present invention that the various types of palletized loads are arranged in different depth arrangements, in terms of accessibility to an edge of the grid 548. For example, it is seen that the palletized loads are arranged in the following arrangement:

It is seen that the palletized load storage/travel locations 550 arranged along column a are all readily and directly accessible by crane 504 and accordingly there is no particular advantage in having the same type of palletized loads in these palletized load storage/travel locations 550. It is thus seen that various types of loads, here types I, II, III, IV, V, VI, VII, VIII, IX, II, X and XI are typically stored in the palletized load storage/travel locations 550 arranged along column a.

It is further seen that the palletized load storage/travel locations 550 arranged along each of columns b, c and d are accessible by respective elevators 506 and 512 and are arranged up to six deep. The palletized load storage/travel locations 550 arranged along each of columns b, c and d are particularly suitable for storing the same type of palletized loads. It is thus seen that loads of type XII are typically stored at all of the palletized load storage/travel locations 550 arranged along column b, that loads of type IX are typically stored at all of the palletized load storage/travel locations 550 arranged along column c and that loads of type X are typically stored at all of the palletized load storage/travel locations 550 arranged along column d.

It is still further seen that the palletized load storage/travel locations 550 arranged along columns e do not have direct elevator access and are most conveniently accessed via column d. Accordingly the palletized load storage/travel locations 550 arranged along column e are preferably used to store the same type of loads as those stored at the palletized load storage/travel locations 550 arranged along column d. It is thus seen that loads of type X are typically stored at all of the palletized load storage/travel locations 550 arranged along column e.

It is yet further seen that the palletized load storage/travel locations 550 at each of respective rows A, B, C, D, E, F, G and H adjacent crane 502, extending along columns, f, g, h, i and j provide up to 5 deep storage and are preferably each used to store the same type of loads. It is thus seen that loads of type I are typically stored at palletized load storage/travel locations 550 in row A at columns f, g, h, i and j; that loads of type VII are typically stored at palletized load storage/travel locations 550 in rows B, C & D at columns f, g, h, i and j, that loads of type VI are typically stored at palletized load storage/travel locations 550 in row E at columns f, g, h, i and j, and that loads of type VIII are typically stored at palletized load storage/travel locations 550 in rows F, G & H at columns f, g, h, i and j.

It is additionally seen that the palletized load storage/travel locations 550 at row I, extending along columns, g, h, i and j, provide up to 4 deep storage and are preferably each used to store the same type of loads. It is thus seen that loads of type IX are typically stored at palletized load storage/travel locations 550 in row I, extending along columns g, h, i and j.

It is further seen that the palletized load storage/travel locations 550 at each of respective rows J, K and L, extending along columns, g and h, provide up to 3 deep storage and are preferably each used to store the same type of loads. It is thus seen that loads of type III are typically stored at palletized load storage/travel locations 550 in rows J, K and L, extending along column g, and loads of type IV are typically stored at palletized load storage/travel locations 550 in rows J, K and L, extending along column h.

It is still further seen that the palletized load storage/travel locations 550 at each of respective rows J, K and L, extending along columns, i and j, provide up to 2 deep storage and are preferably each used to store the same type of loads. It is thus seen that loads of types II, II and XI are typically stored at palletized load storage/travel locations 550 in respective rows J, K and L, extending along columns i and j.

Reference is now made to FIG. 14B, which is a simplified diagram of a second typical configuration of one level of the dynamically configurable automated warehousing system of FIGS. 1A-12, typically including a 10×12 grid 548 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j.

It is a particular feature of the present invention that the configuration of FIG. 14A may be readily and automatically converted to the configuration of FIG. 14B and vice versa, without requiring any structural modifications to the grid 548 or to the automated warehousing system.

It is a further particular feature of a preferred embodiment of the present invention that a selectable one of the rows (or columns) of the palletized load storage/travel locations 550 is typically left free of palletized loads. For example, it is seen that the palletized loads in FIG. 14B are arranged in up to 5 deep and 6 deep storage. This arrangement is particularly suitable when each pallet may contain different loads and each specific palletized load may need to be accessed at any given time. One example of an application requiring this type of arrangement is physical archived file storage.

Reference is now made to FIG. 14C, which is a simplified diagram of a third typical configuration of one level of the dynamically configurable automated warehousing system of FIGS. 1A-12, typically including a 10×12 grid 548 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j.

It is a particular feature of the present invention that the configuration of any of FIGS. 14A-14C may be readily and automatically converted to the configuration of any other of FIGS. 14A-14C and vice versa, without requiring any structural modifications to the grid 548 or to the automated warehousing system.

It is a further particular feature of a preferred embodiment of the present invention that selectable multiple rows (or columns) of the palletized load storage/travel locations 550 are typically left free of palletized loads in order to provide single deep pallet storage. This arrangement is particularly suitable when each pallet may contain different loads and each specific palletized load may need to be accessed at any given time. One example of an application requiring this type of arrangement is physical archived file storage.

Reference is now made to FIG. 14D, which is a simplified diagram of a fourth typical configuration of one level of the dynamically configurable automated warehousing system of FIGS. 1A-12, typically including a 10×12 grid 548 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j.

It is a particular feature of the present invention that the configuration of any of FIGS. 14A-14D may be readily and automatically converted to the configuration of any other of FIGS. 14A-14D and vice versa, without requiring any structural modifications to the grid 548 or to the automated warehousing system.

It is a further particular feature of a preferred embodiment of the present invention that selectable multiple rows (or columns) of the palletized load storage/travel locations 550 are typically left free of palletized loads in order to provide 2 deep palletized load storage. This arrangement is particularly suitable when each pallet may contain different loads and each specific palletized load may need to be accessed at any given time. One example of an application requiring this type of arrangement is physical archived file storage.

Reference is now made to FIG. 14E, which is a simplified diagram of a fifth typical configuration of one level of the dynamically configurable automated warehousing system of FIGS. 1A-12, typically including a 10×12 grid 548 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j.

It is a particular feature of the present invention that the configuration of any of FIGS. 14A-14E may be readily and automatically converted to the configuration of any other of FIGS. 14A-14E and vice versa, without requiring any structural modifications to the grid 548 or to the automated warehousing system.

In the embodiment of FIG. 14E there is provided a flow rack type of deep palletized load storage, wherein movement of the palletized loads is provided by the three-directional palletized load transporter of FIGS. 6A & 6B. Accordingly, each row contains the same type of palletized loads. Typically, the palletized loads may be supplied using crane 502 and removed using crane 504 or vice versa.

Reference is now made to FIG. 14F, which is a simplified diagram of a sixth typical configuration of one level of the dynamically configurable automated warehousing system of FIGS. 1A-12, typically including a 10×12 grid 548 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j.

It is a particular feature of the present invention that the configuration of any of FIGS. 14A-14F may be readily and automatically converted to the configuration of any other of FIGS. 14A-14F and vice versa, without requiring any structural modifications to the grid 548 or to the automated warehousing system.

It is a further particular feature of a preferred embodiment of the present invention that selectable multiple rows (or columns) of the palletized load storage/travel locations 500 are typically left free of palletized loads in order to provide mobile rack type palletized load storage wherein entire rows of palletized loads may be moved by the three-directional palletized load transporters of FIGS. 6A & 6B. It is appreciated that the configuration shown in FIG. 14F may be identical to that shown in FIG. 14B.

Reference is now made to FIG. 14G, which is a simplified diagram of a seventh typical configuration of one level of the dynamically configurable automated warehousing system of FIGS. 1A-12, typically including a 10×12 grid 548 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j.

It is a particular feature of the present invention that the configuration of any of FIGS. 14A-14G may be readily and automatically converted to the configuration of any other of FIGS. 14A-14G and vice versa, without requiring any structural modifications to the grid 548 or to the automated warehousing system.

It is a further particular feature of a preferred embodiment of the present invention that radio shuttle type palletized load storage is provided, wherein movement of the palletized loads is provided by the three-directional palletized load transporter 200 of FIGS. 6A & 6B. Accordingly, each row contains the same type of palletized loads. Typically, the palletized loads may be supplied and removed using either or both of cranes 502 and 504 according to a LIFO or FIFO sequence.

Reference is now made to FIG. 14H, which is a simplified diagram of an eighth typical configuration of one level of the dynamically configurable automated warehousing system of FIGS. 1A-12, typically including a 10×12 grid 458 of mutually adjacent palletized load storage/travel locations 550 along two mutually opposite edges of which are arranged cranes 502 and 504 and at specific locations along two other mutually opposite edges of which are arranged elevators 506, 508, 510 and 512. The individual palletized load storage/travel locations 550 are individually identified by a pair of letters, Nn, one of which is capitalized and the other of which is not. Thus it is seen that there are typically 12 rows of individual palletized load storage/travel locations 550, respectively labeled A, B, C, D, E, F, G, H, I, J, K and L and that each row includes ten individual palletized load storage/travel locations 550, respectively labeled a, b, c, d, e, f, g, h, i and j.

It is a particular feature of the present invention that the configuration of any of FIGS. 14A-14H may be readily and automatically converted to the configuration of any other of FIGS. 14A-14H and vice versa, without requiring any structural modifications to the grid 548 or to the automated warehousing system.

It is a further particular feature of a preferred embodiment of the present invention that multiple push back type palletized load storage functionality may be provided using one or more of cranes 502 and 504 and elevators 506, 508, 510 and 512. This arrangement is suitable for operation in a LIFO storage sequence. It is appreciated that the configuration shown in FIGS. 14G and 14H may be identical to that shown in FIG. 14E.

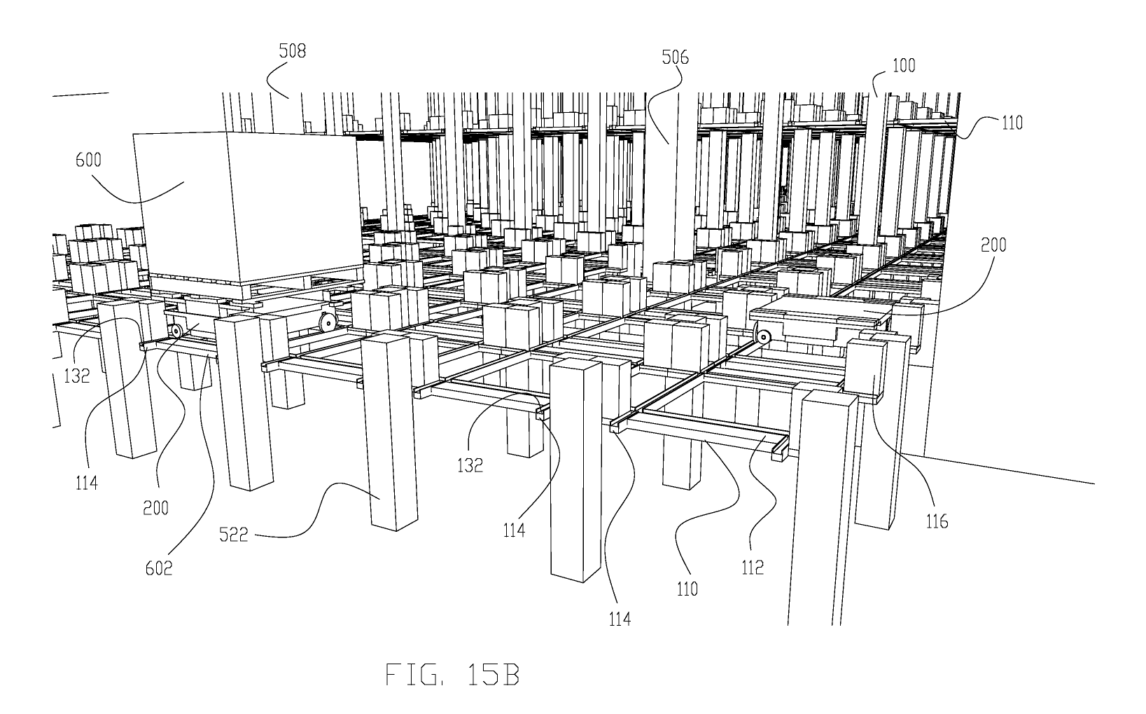

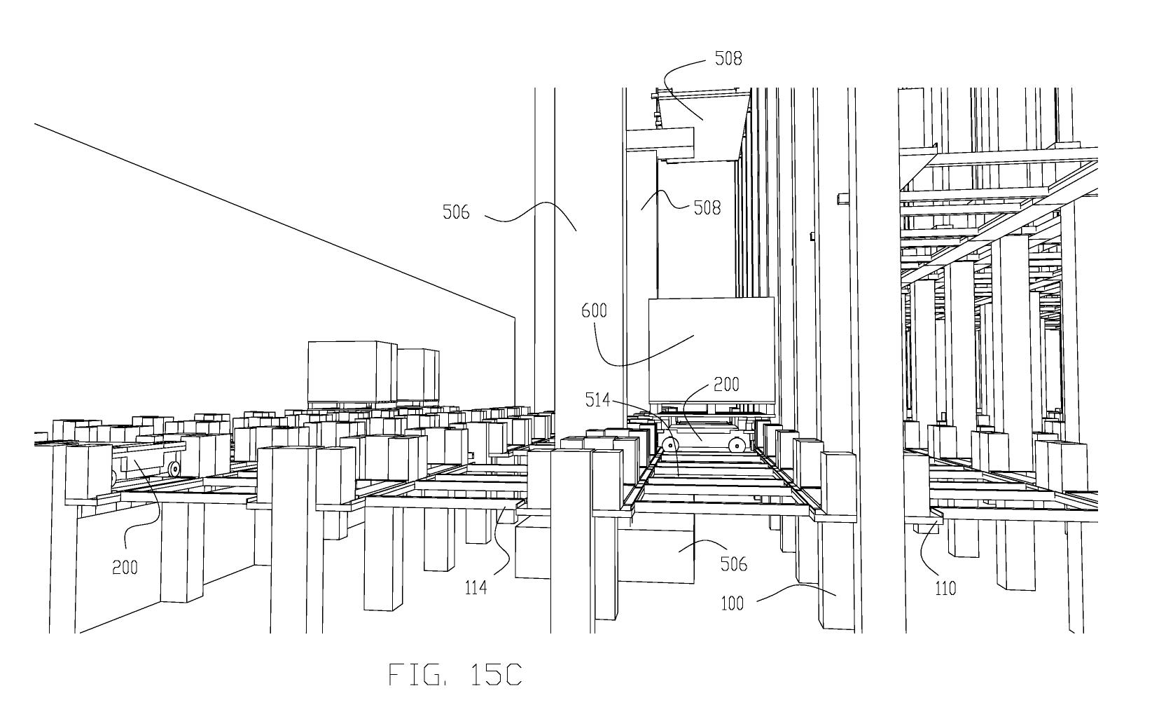

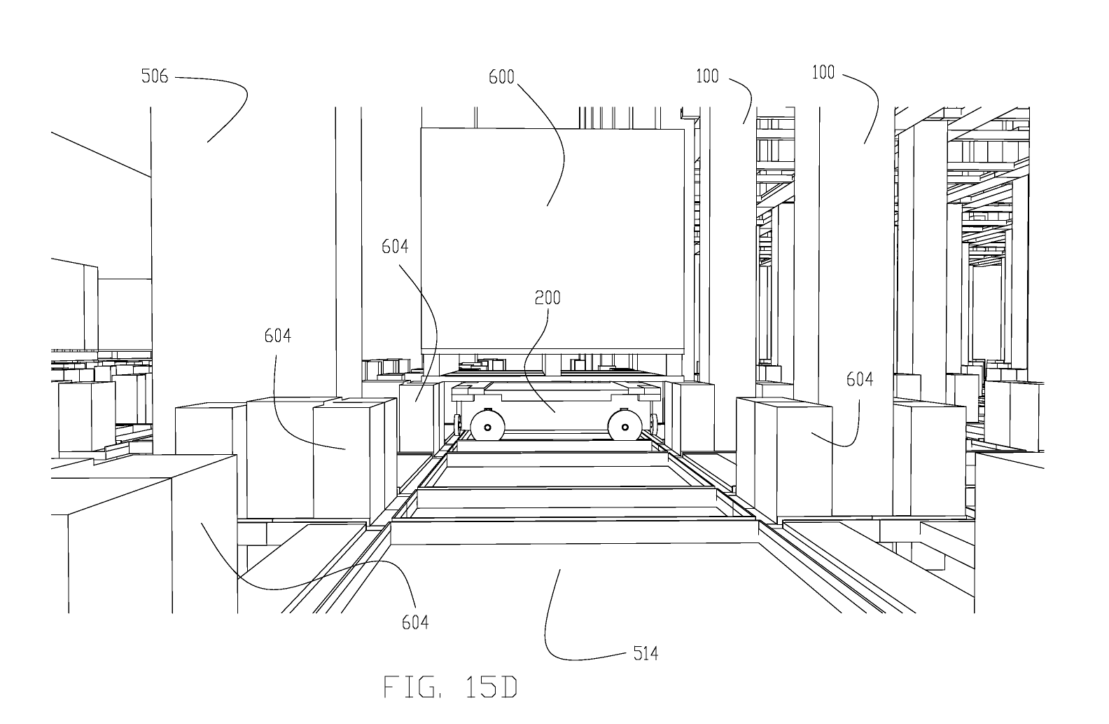

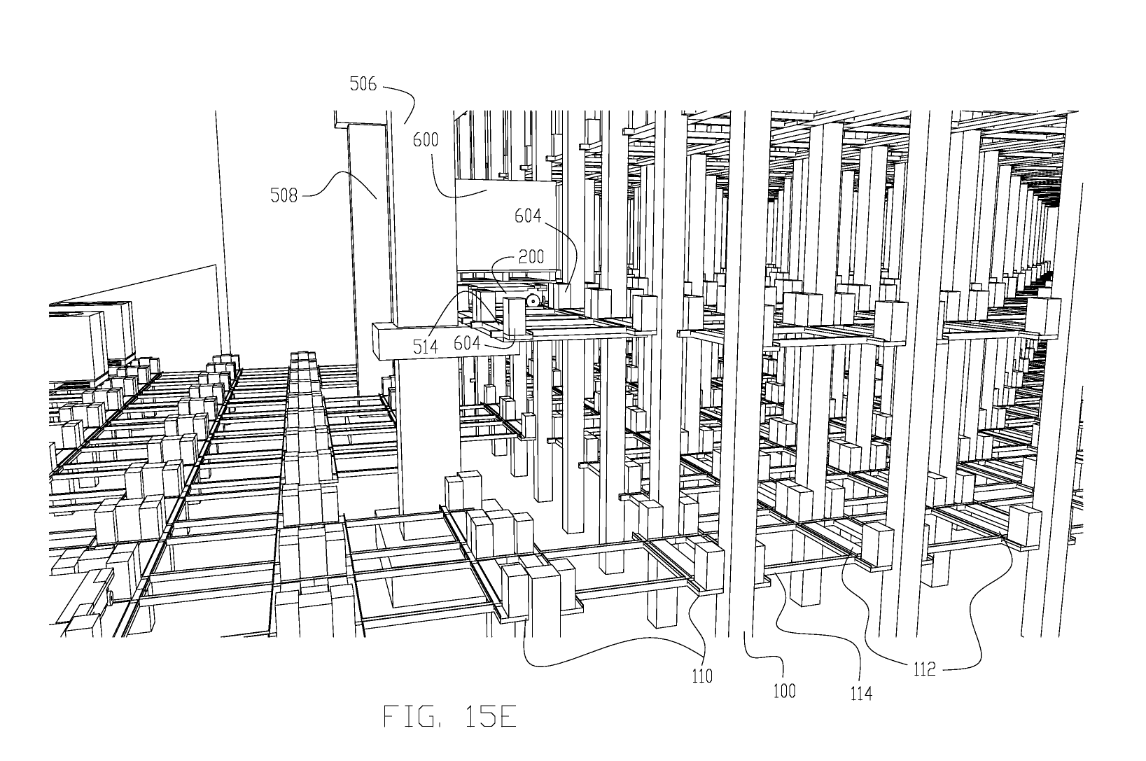

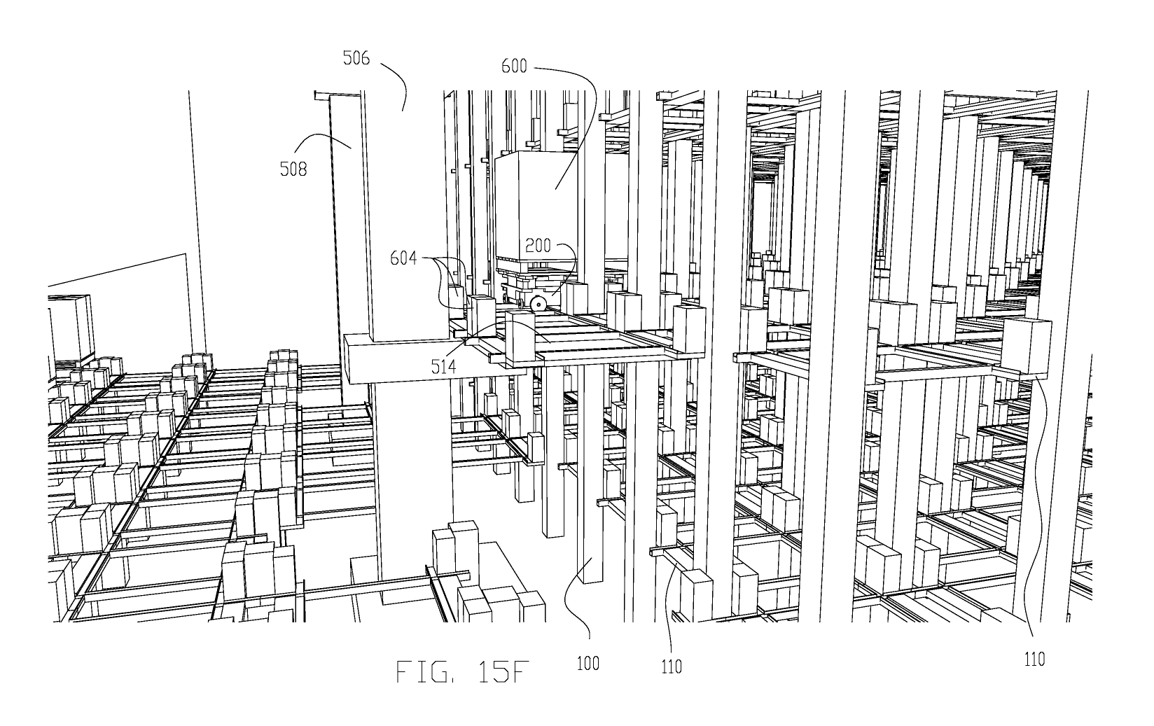

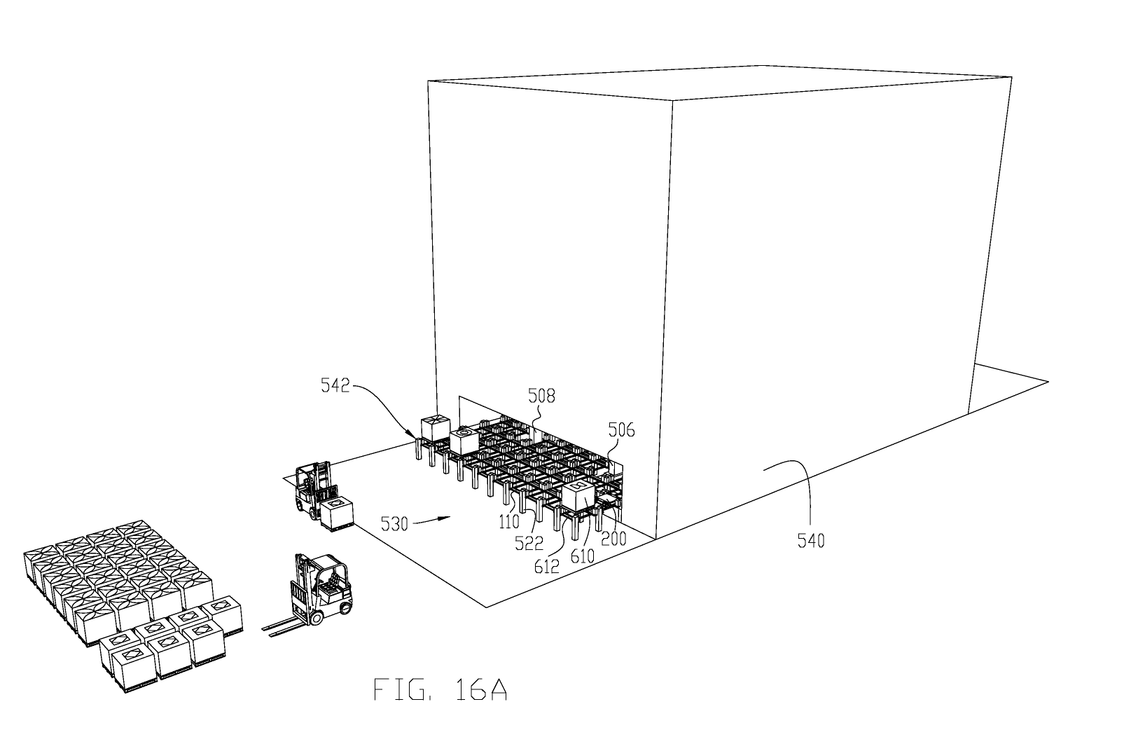

Reference is now made to FIGS. 15A, 15B, 15C, 15D, 15E and 15F, which are simplified illustrations of various stages in one aspect of the operation of the dynamically configurable automated warehousing system of FIGS. 1A-12.

FIG. 15A shows loading of a palletized load 600 onto a palletized load support location 602 at the exterior portion 542 of the staging area 530.

FIG. 15B shows a three-directional palletized load transporter 200 in underlying engagement with palletized load 600 after engaging and lifting the palletized load 600. As seen in FIG. 15B, the three-directional palletized load transporter 200 is in its sixth operative orientation (FIG. 12) wherein the load lifting assemblies 264 and the palletized load side support assemblies 280 are in their raised positions and the extendible palletized load corner supports 284 are fully extended.

FIG. 15C shows the three-directional palletized load transporter 200 traveling along and within longitudinal recesses 132 formed in track elements 114 arranged along a Y axis carrying palletized load 600 onto elevator 506. As seen in FIG. 15B, the three-directional palletized load transporter 200 is in its sixth operative orientation (FIG. 12) wherein the load lifting assemblies 264 and the palletized load side support assemblies 280 are in their raised positions and the extendible palletized load corner supports 284 are fully extended.

FIG. 15D shows the three-directional palletized load transporter 200 carrying palletized load 600 positioned on load platform 514 in elevator 506.

It is appreciated that transporter 200 may retain palletized load 600 during raising and lowering of palletized loads 600 by elevators 506, 508, 510 and 512 and may continue to travel within dynamically configurable automated warehouse at different levels thereof.

Alternatively, as illustrated in FIG. 15D, palletized load 600 may be positioned by transporter 200 onto load support elements 604 forming part of load platform 514, similar to load support and pillar mounting elements 116 of modular multi-track support element 110 shown in FIGS. 2A-2B. In FIG. 15D, the three-directional palletized load transporter 200 is shown in its second operative orientation (FIG. 8) wherein the load lifting assemblies 264 and the palletized load side support assemblies 280 are in their lowered positions and the extendible palletized load corner supports 284 are fully retracted.

It is appreciated that transporter 200 may not accompany palletized load 600 to a different level of the dynamically configurable automated warehouse. In this alternative, palletized load 600 may be removed from load platform 514 by a three-directional palletized load transporter 200 different from the three-directional palletized load transporter 200 which loaded palletized load 600 onto load platform 514.

FIG. 15E shows lifting operation of elevator 506, whereby both the three-directional palletized load transporter 200 and the palletized load 600 are typically raised to a desired level for storage of the palletized load 600. In FIG. 15E, the three-directional palletized load transporter 200 is shown in its second operative orientation (FIG. 8) wherein the load lifting assemblies 264 and the palletized load side support assemblies 280 are in their lowered positions and the extendible palletized load corner supports 284 are fully retracted.

FIG. 15F shows operation of a three-directional palletized load transporter 200, which may or may not be the same transporter which loaded palletized load 600 onto elevator 506, removing palletized load 600 from load platform 514 of elevator 506. In FIG. 15F, the three-directional palletized load transporter 200 is shown in its sixth operative orientation (FIG. 12) wherein the load lifting assemblies 264 and the palletized load side support assemblies 280 are in their raised positions and the extendible palletized load corner supports 284 are fully extended.

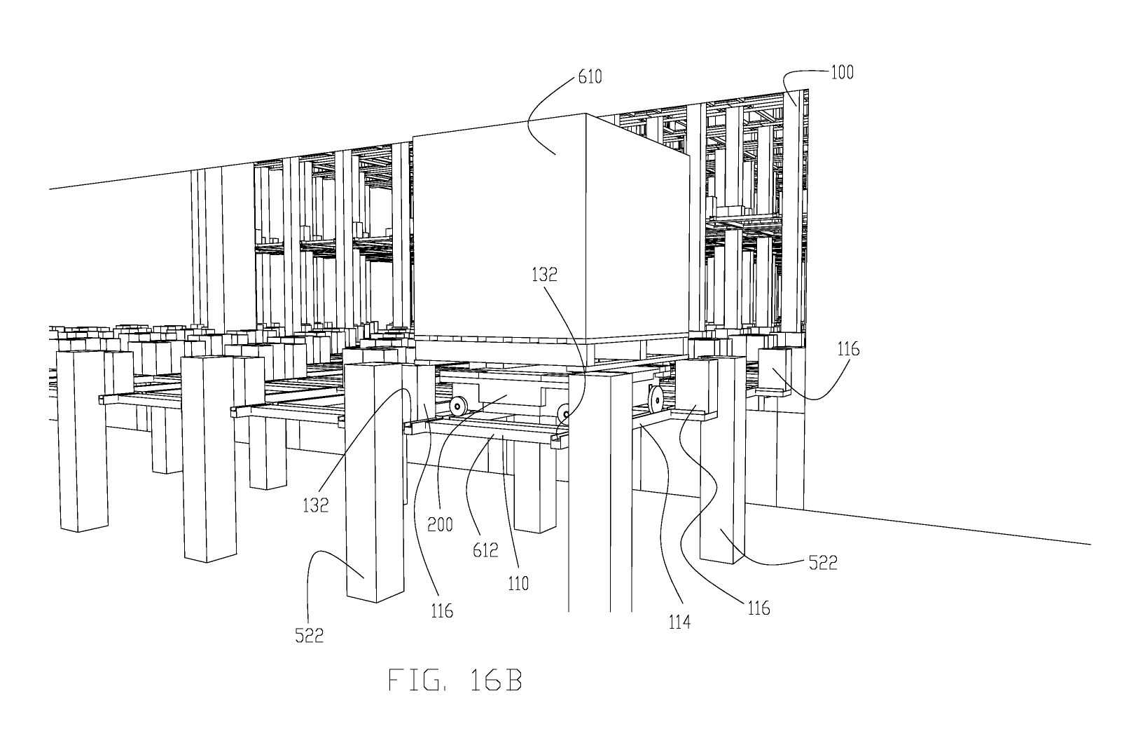

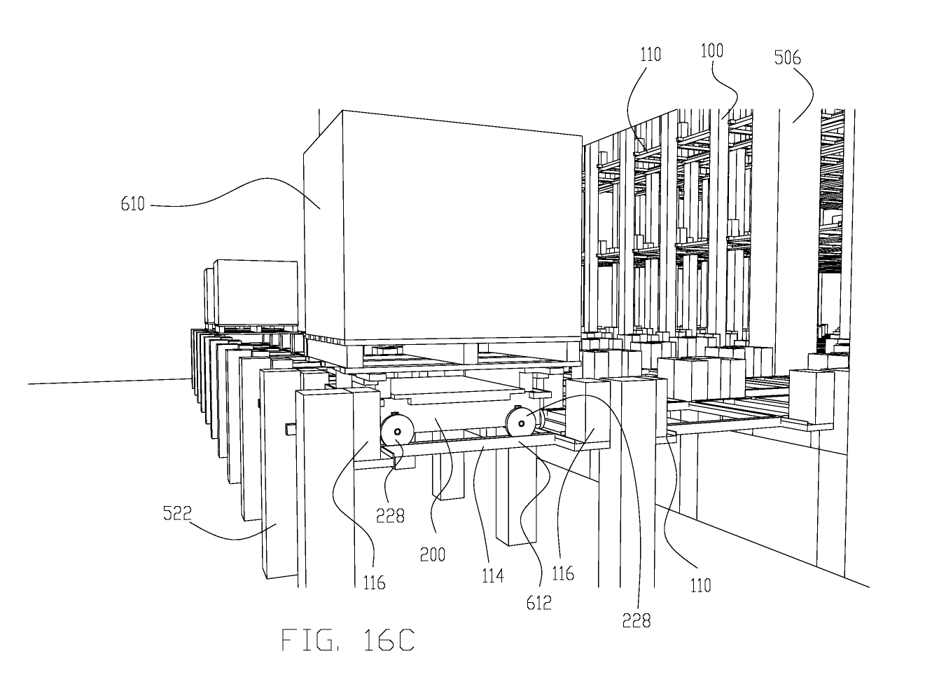

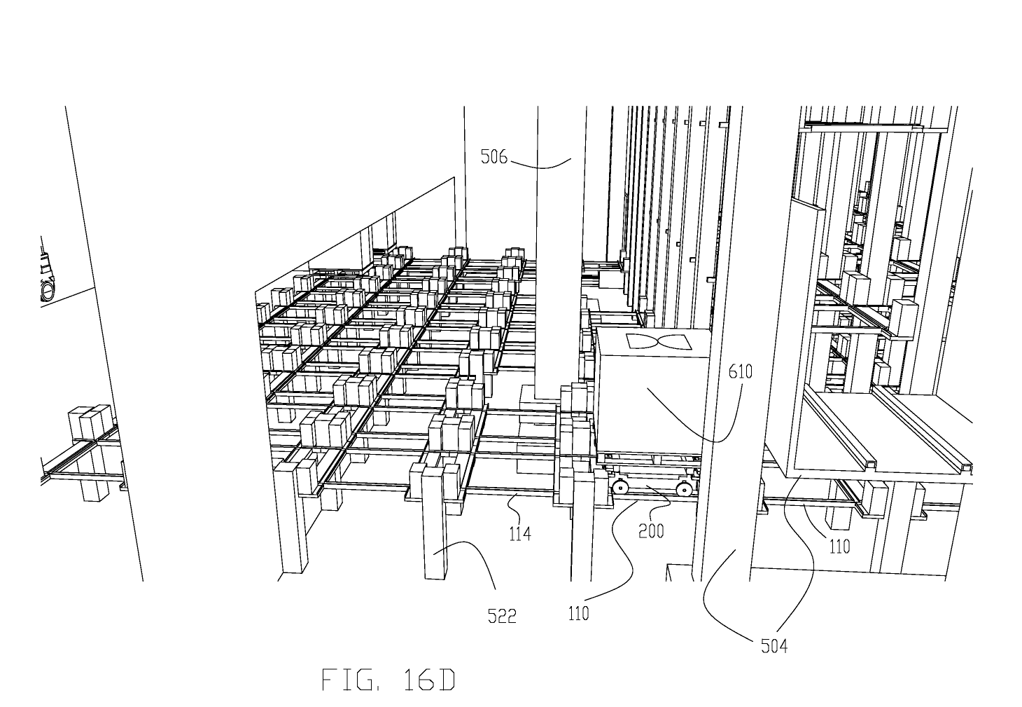

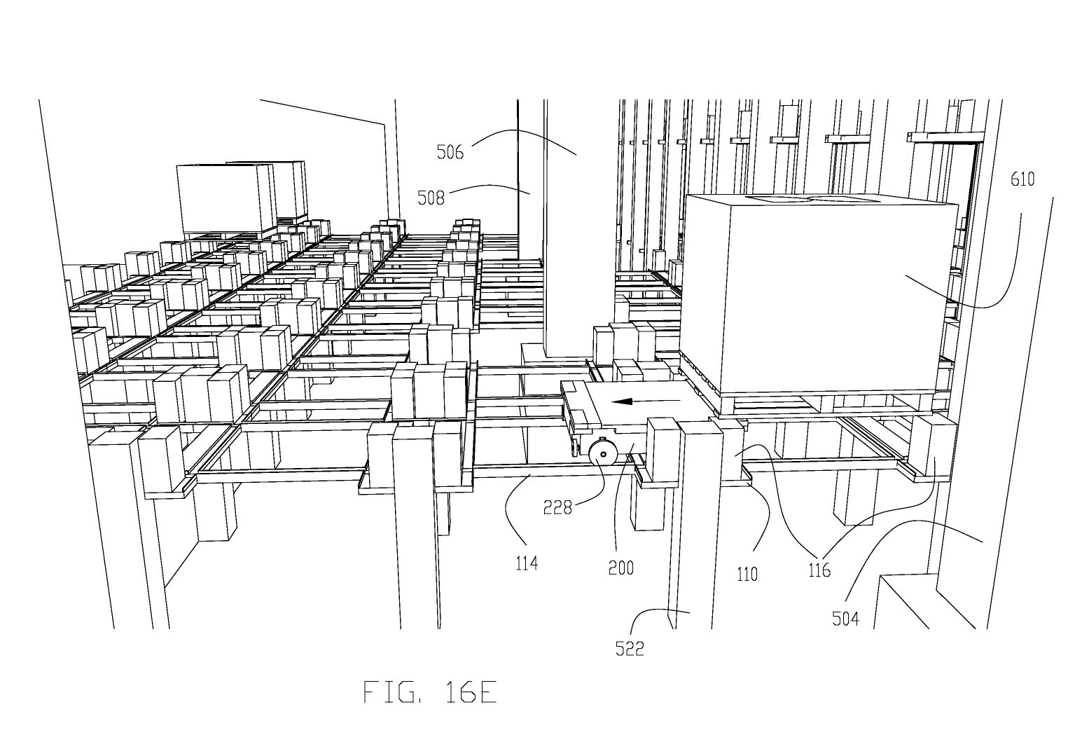

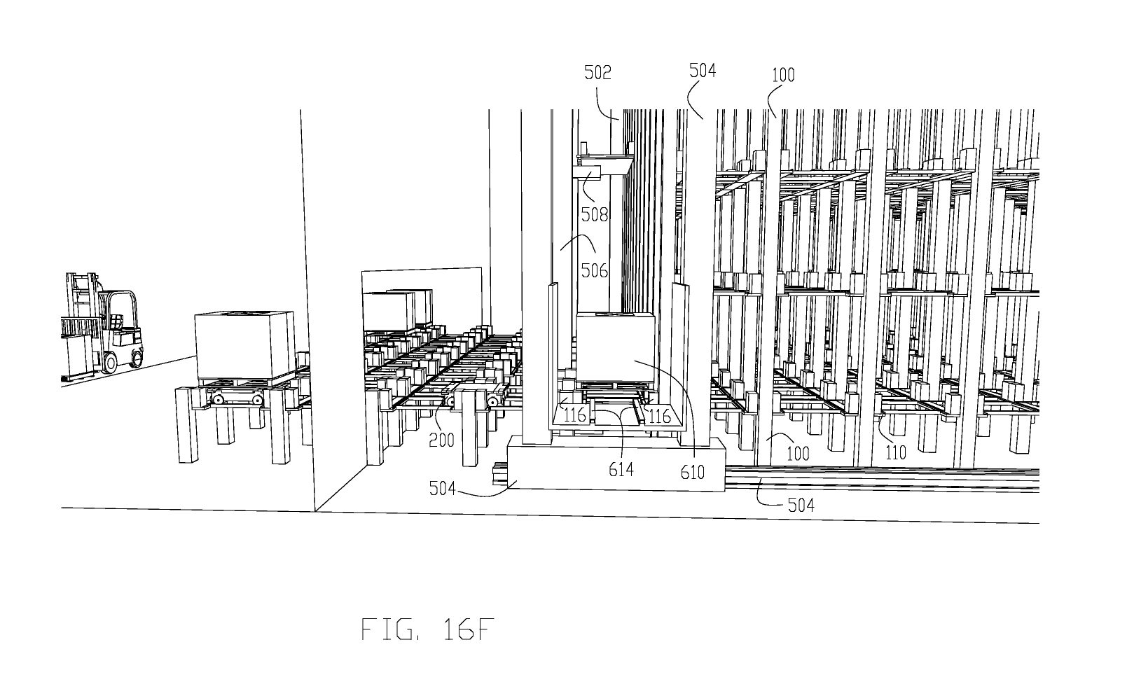

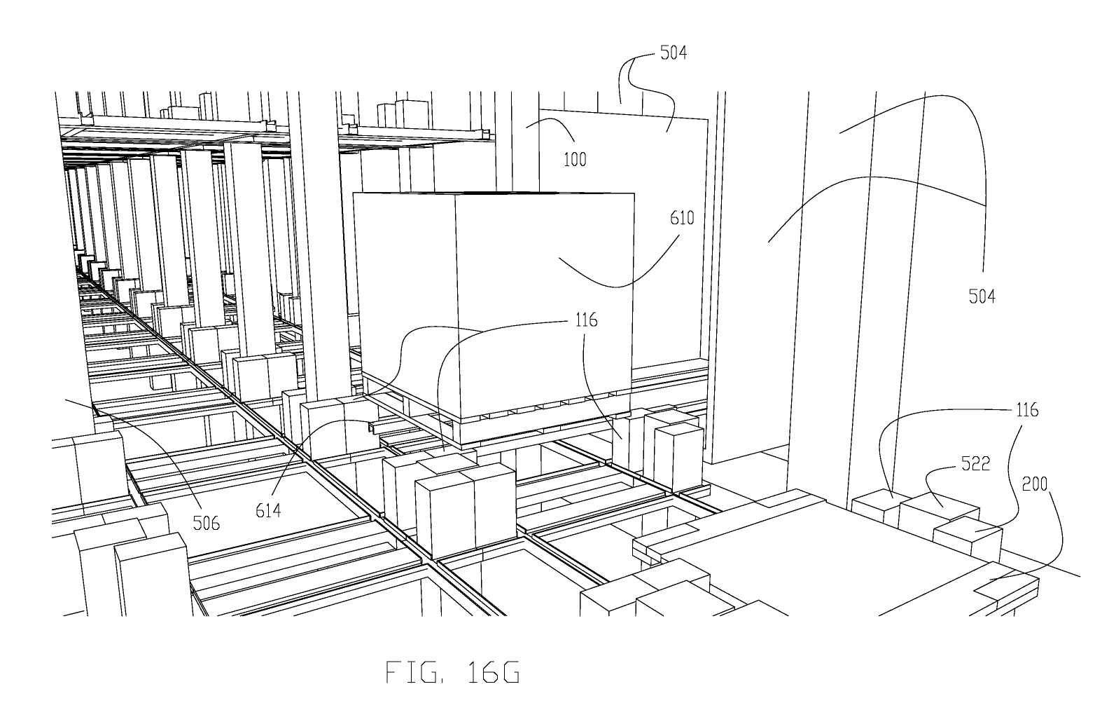

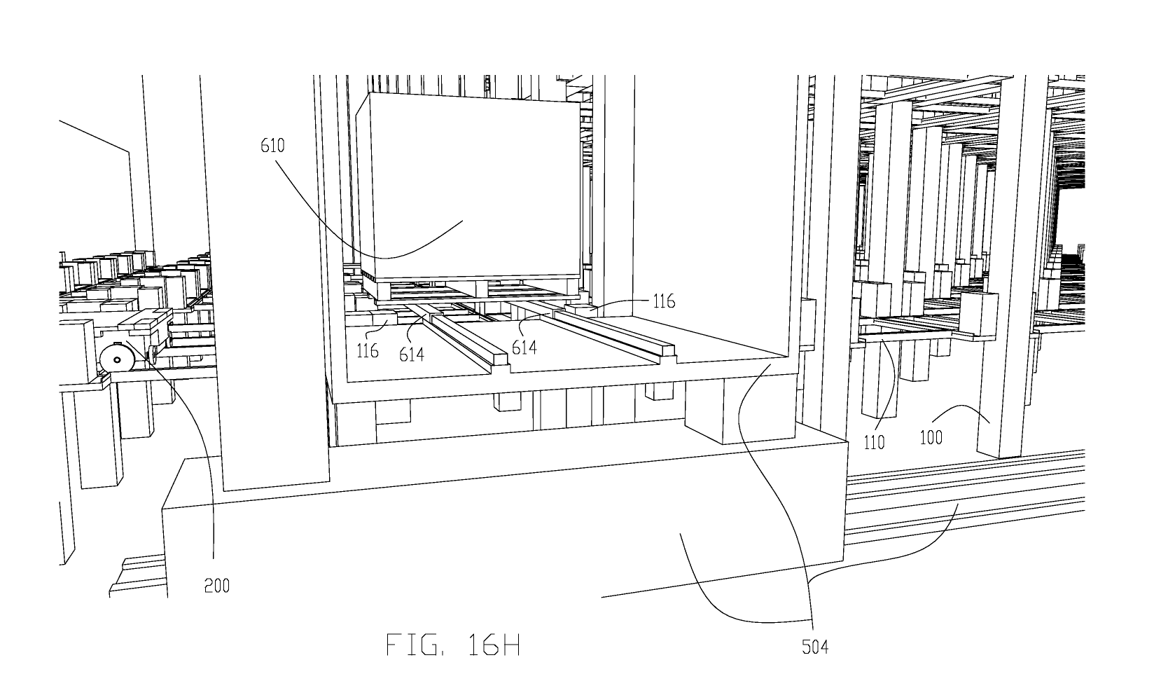

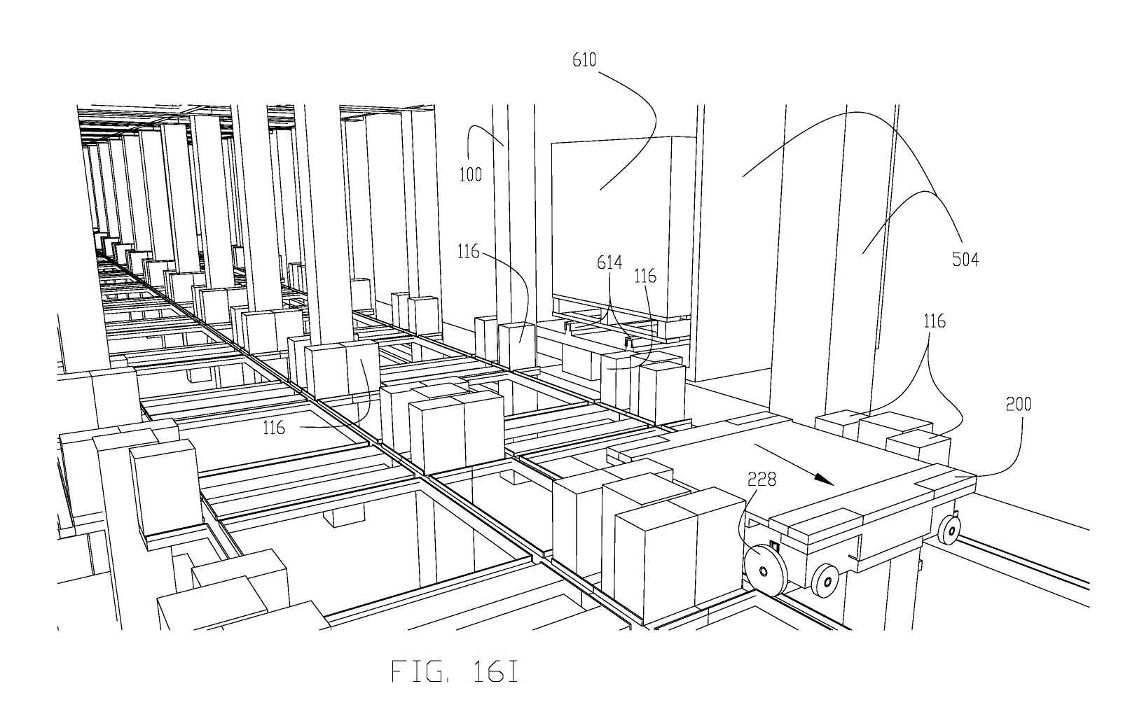

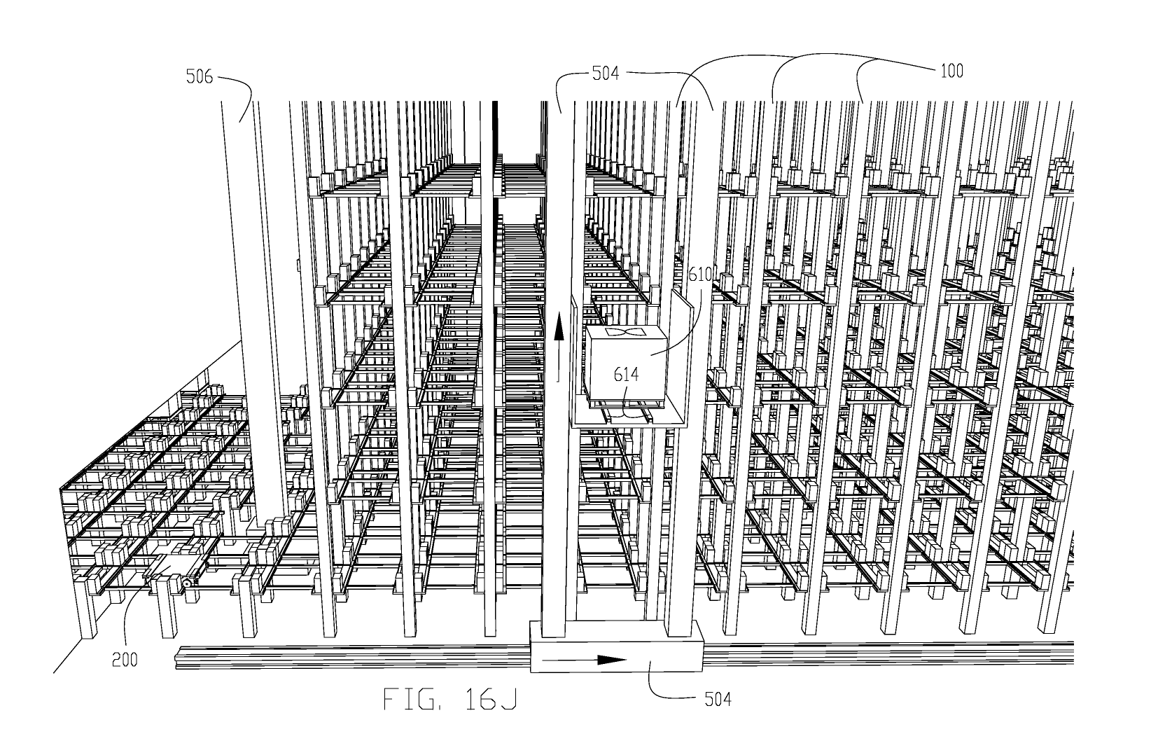

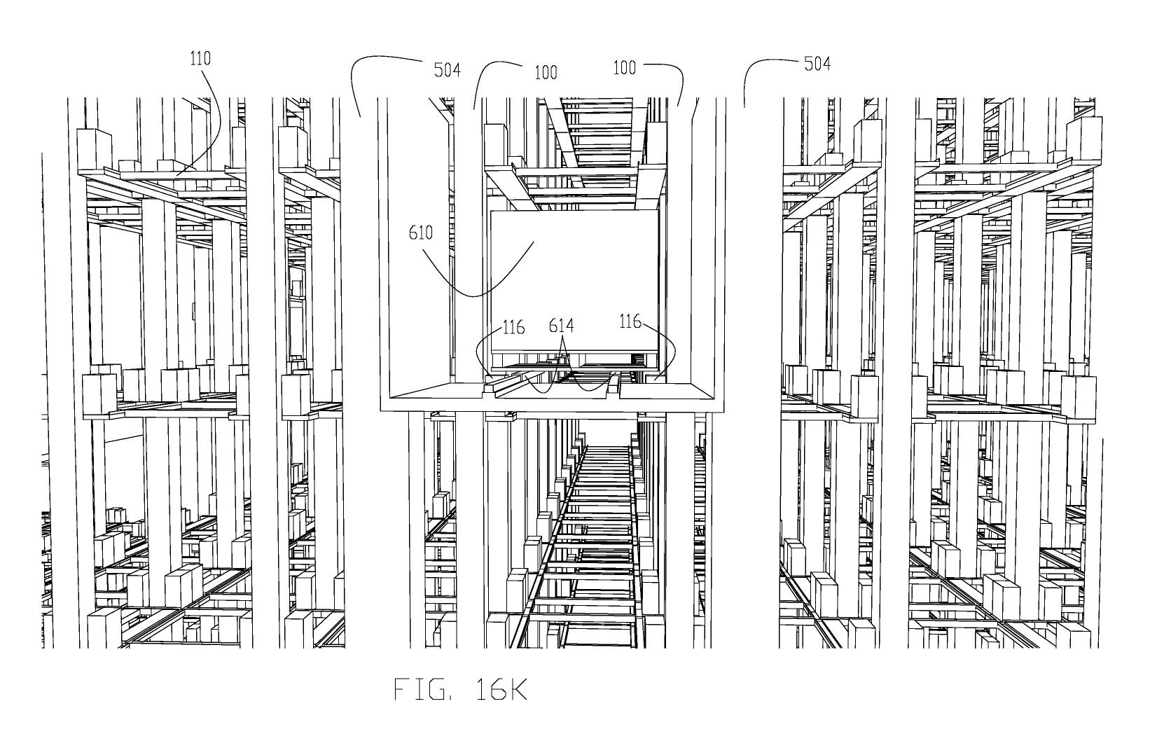

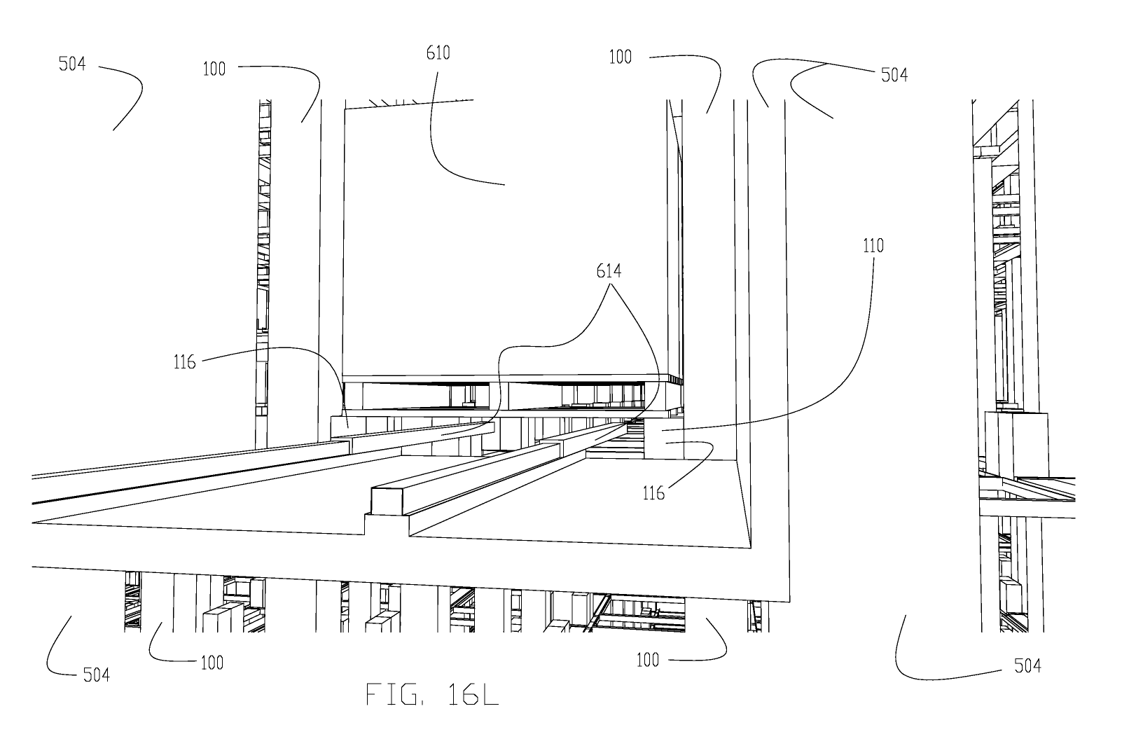

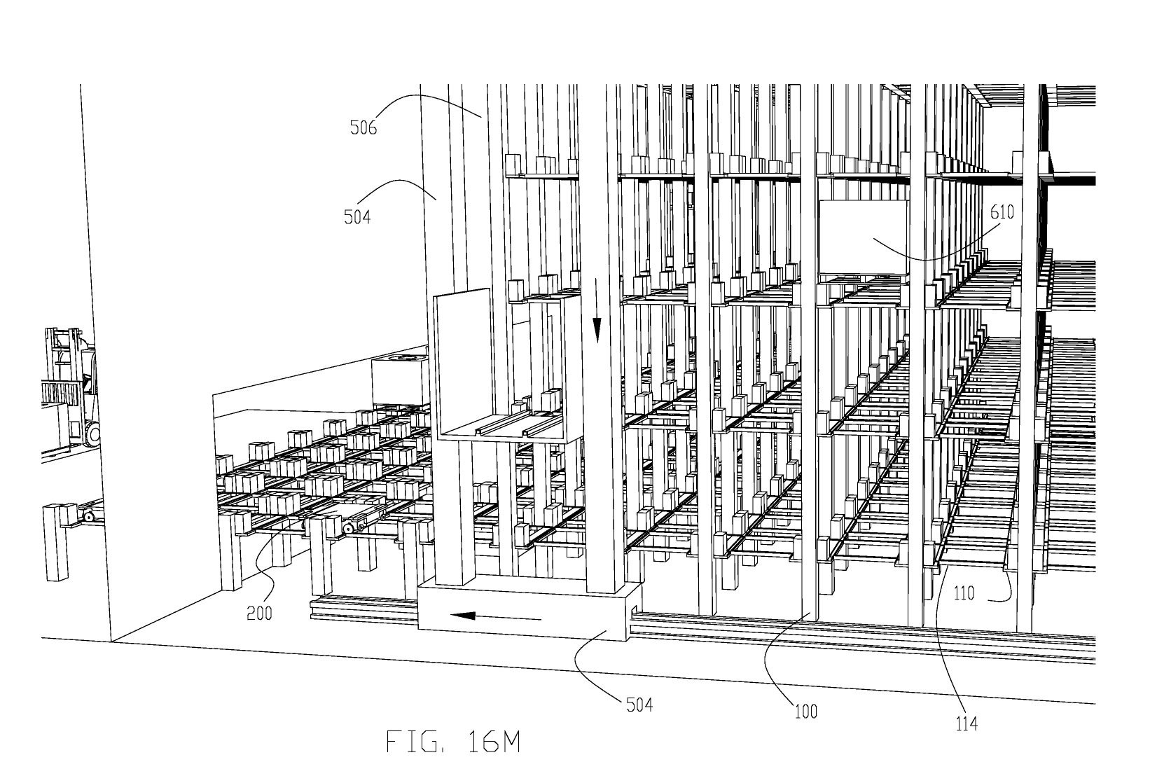

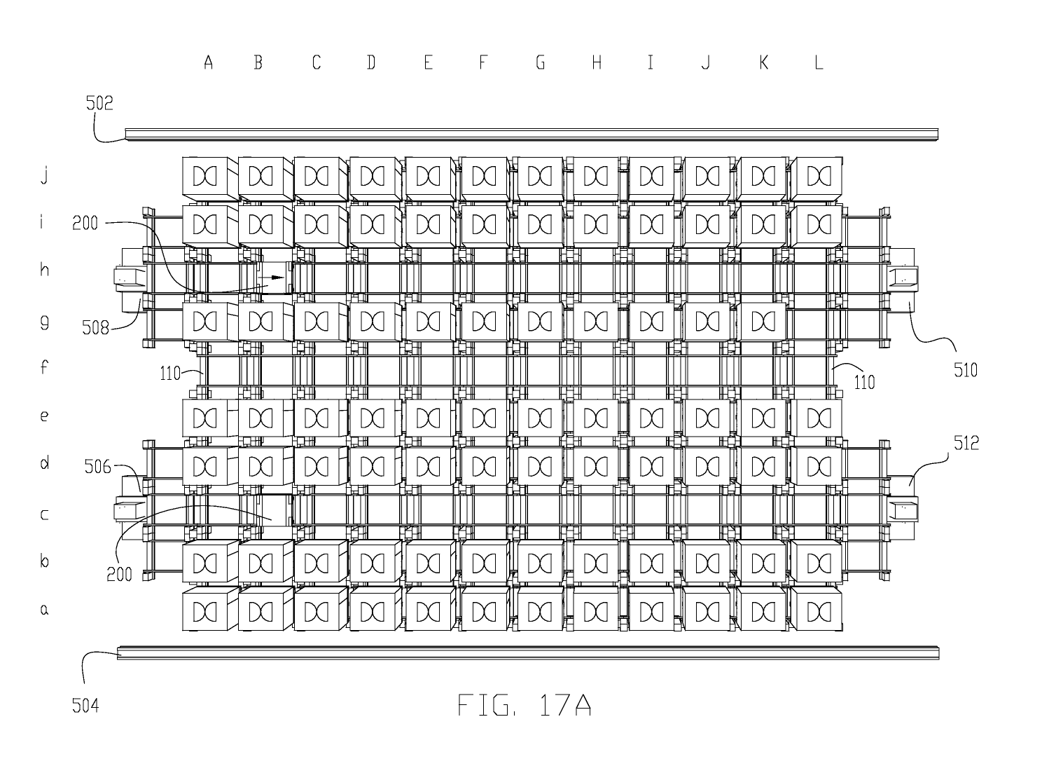

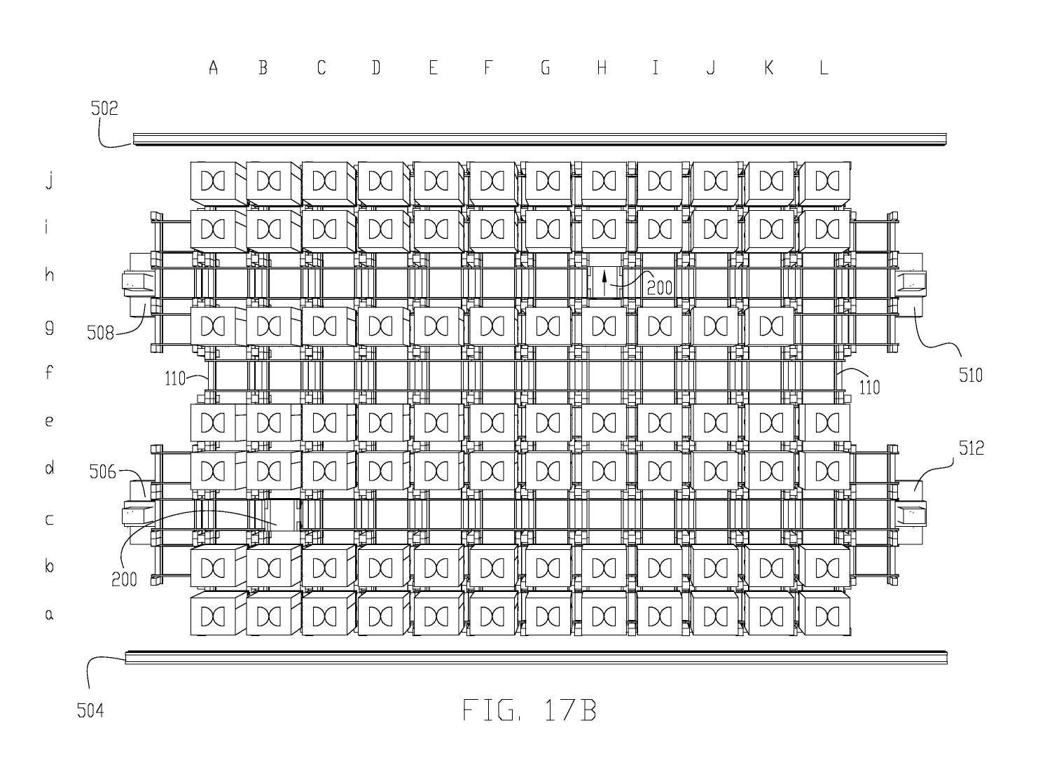

Reference is now made to FIGS. 16A, 16B, 16C, 16D, 16E, 16F, 16G, 16H, 16I, 16J, 16K, 16L & 16M, which are simplified illustrations of various stages in another aspect of the operation of the dynamically configurable automated warehousing system of FIGS. 1A-12.

FIG. 16A shows loading of a palletized load 610 onto a palletized load support location 612 at the exterior portion 542 of the staging area 530.

FIG. 16B shows a three-directional palletized load transporter 200 located within longitudinal recesses 132 formed in track elements 114 arranged along a Y axis into underlying engagement with palletized load 610. It is appreciated that the three-directional palletized load transporter 200 is in its second operative orientation as shown in FIG. 8.

FIG. 16C shows operation of three-directional palletized load transporter 200 to engage and lift the palletized load 610. As seen in FIG. 16C, the three-directional palletized load transporter 200 is in its sixth operative orientation, as shown in FIG. 12 wherein the load lifting assemblies 264 and the palletized load side support assemblies 280 are in their raised positions and the extendible palletized load corner supports 284 are fully extended. Here it is seen that wheels 228 are lowered with respect to chassis 202 and are configured for travel along and within longitudinal recesses 132 formed in track elements 114 along a Y-axis.

FIG. 16D shows initial travel of the three-directional palletized load transporter 200 along and within longitudinal recesses 132 formed in track elements 114 arranged along a Y axis carrying palletized load 610 towards crane 504. As seen in FIG. 16D, the three-directional palletized load transporter 200 is in its sixth operative orientation, as shown in FIG. 12 wherein the load lifting assemblies 264 and the palletized load side support assemblies 280 are in their raised positions and the extendible palletized load corner supports 284 are fully extended.

FIG. 16E shows the three-directional palletized load transporter 200 carrying palletized load 610 at an edge of three-dimensional array 306. At this point, as seen in FIG. 16E, the three-directional palletized load transporter 200 assumes its second operative orientation, wherein wheels 228 are lowered with respect to chassis 202 and are configured for travel along and within longitudinal recesses 132 formed in track elements 114 along a Y-axis. In this second operative orientation, load lifting assemblies 264 and the palletized load side support assemblies 280 are in their lowered positions and the extendible palletized load corner supports 284 are fully retracted. As seen in FIG. 16E, transporter 200 has positioned palletized load 610 on load support and pillar mounting elements 116 of a modular multi-track support element 110 located adjacent crane 504 and is moving in a direction away from palletized load 610.

FIG. 16F shows crane 504 being positioned adjacent palletized load 610 for movement thereof. FIGS. 16G, 16H and 16I show extension and retraction of extendible forks 614 of crane 504 to load palletized load 610 onto crane 504.

FIG. 16J shows crane 504 moving palletized load 610 upwards and sideways to a designated location in the dynamically configurable automated warehouse. FIGS. 16K and 16L show extension of extendible forks 614 of crane 504 to unload palletized load 610 from crane 504 onto load support and pillar mounting elements 116 of a modular multi-track support element 110 located at the designated location adjacent crane 504.

FIG. 16M shows crane 504 moving to a different location within the dynamically configurable automated warehouse.

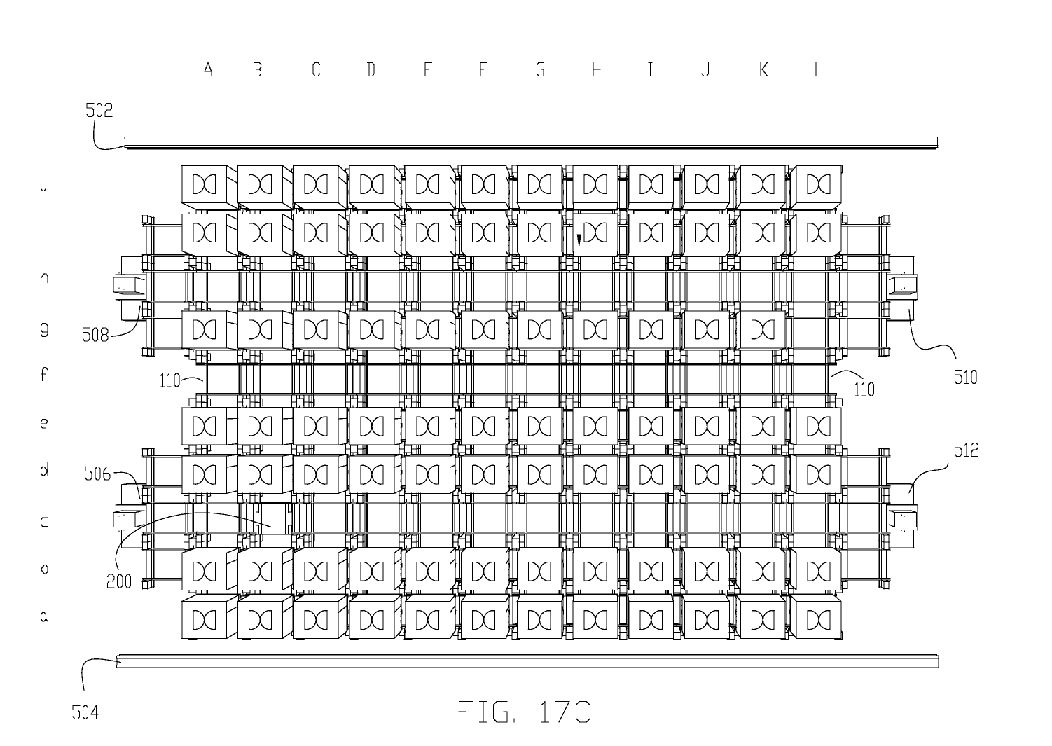

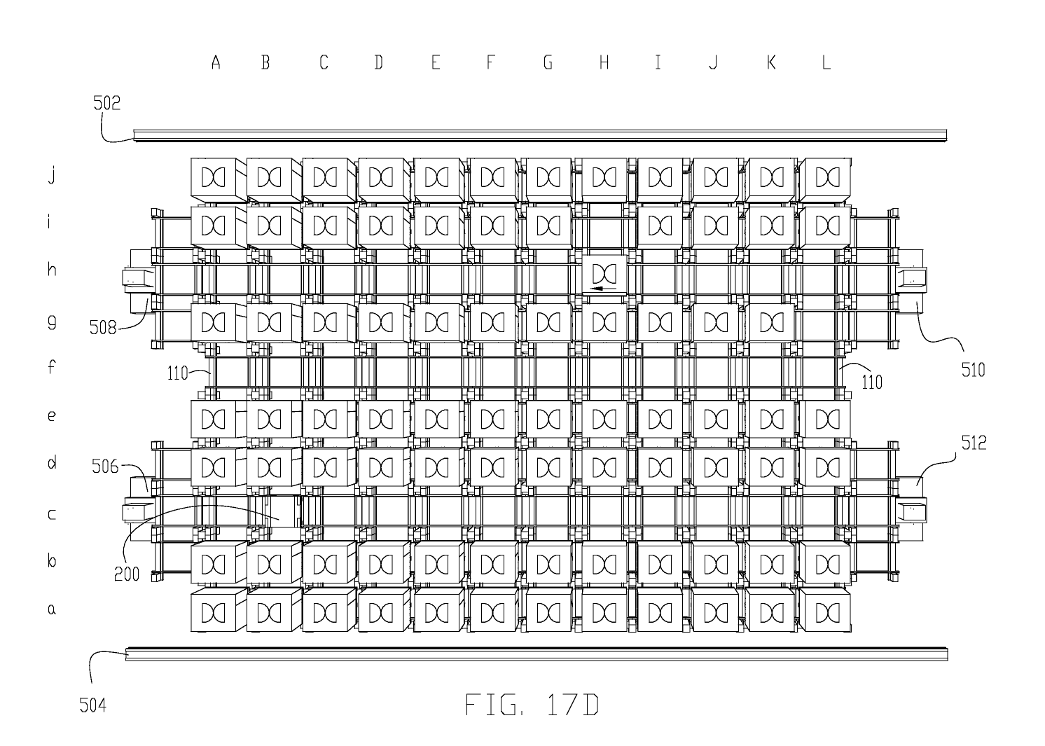

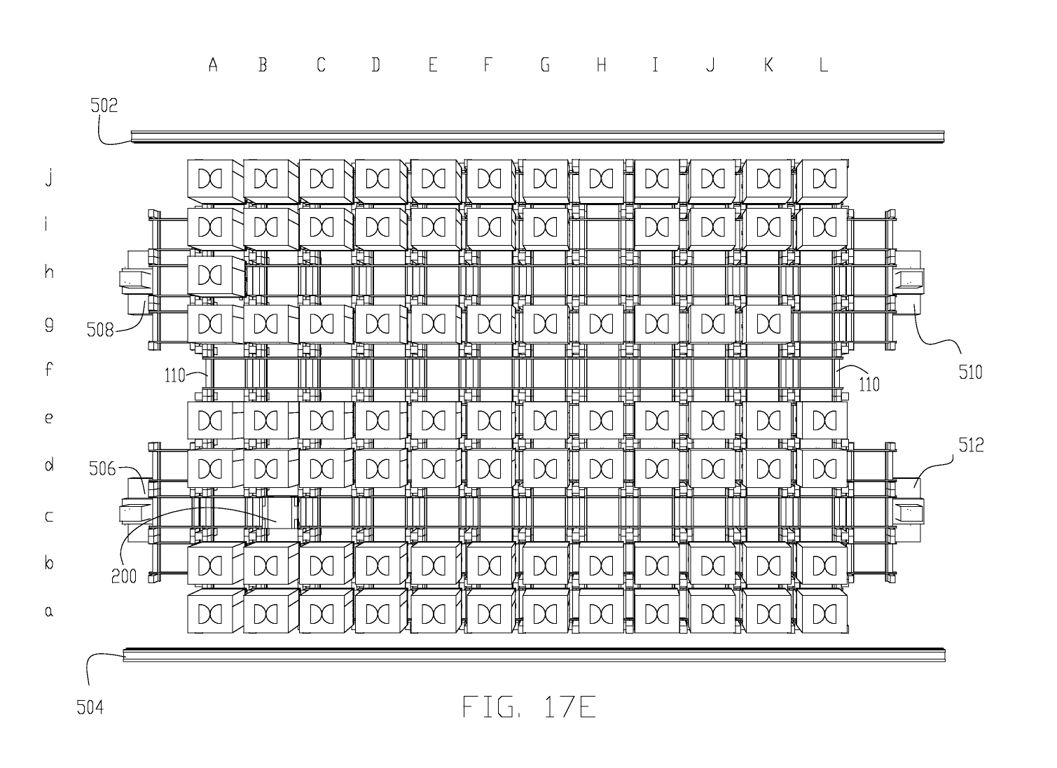

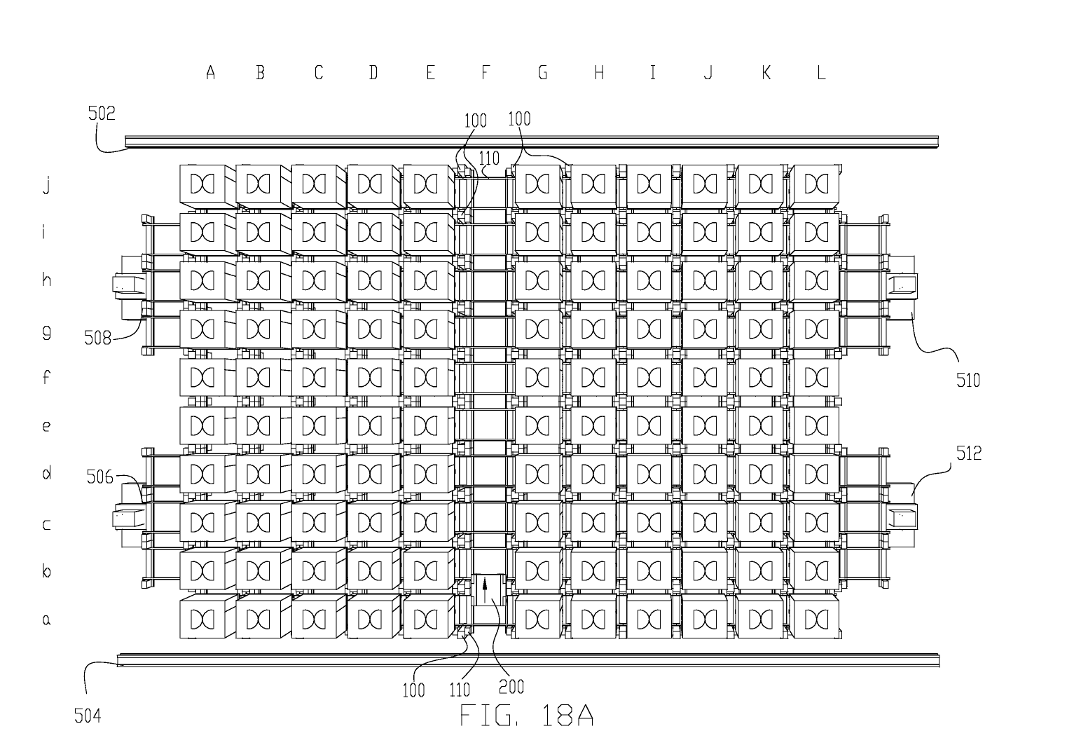

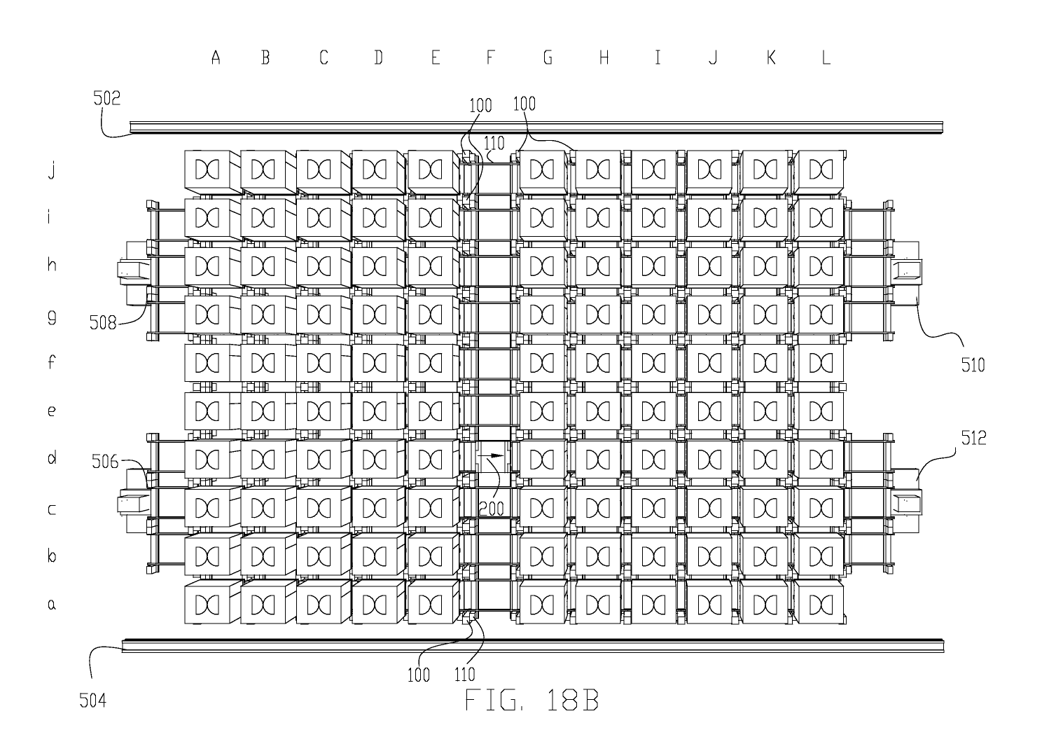

Reference is now made to FIGS. 17A-17E, which are simplified illustrations of various stages in a further aspect of the operation of the dynamically configurable automated warehousing system of FIGS. 1A-12, which are combinable with one or both aspects of the operation of the dynamically configurable automated warehousing system of FIGS. 1A-12 shown in FIGS. 15A-16M.

FIGS. 17A-17E show stages in the operation of the dynamically configurable automated warehousing system of FIGS. 1A-12 in its third typical configuration, as shown in FIG. 14C, arranged for single deep palletized load storage, whereby the palletized load at location Hi is accessed. FIGS. 17A and 17B together show a three-directional palletized load transporter 200 (FIGS. 6A & 6B) moving along column h from location Ah to location Hh. FIG. 17C shows three-directional palletized load transporter 200 raising the palletized load at location Hi. FIGS. 17D and 17E together show three-directional palletized load transporter 200 moving the palletized load along column h from location Hh to location Ah at which it can be lowered as necessary by elevator 508.

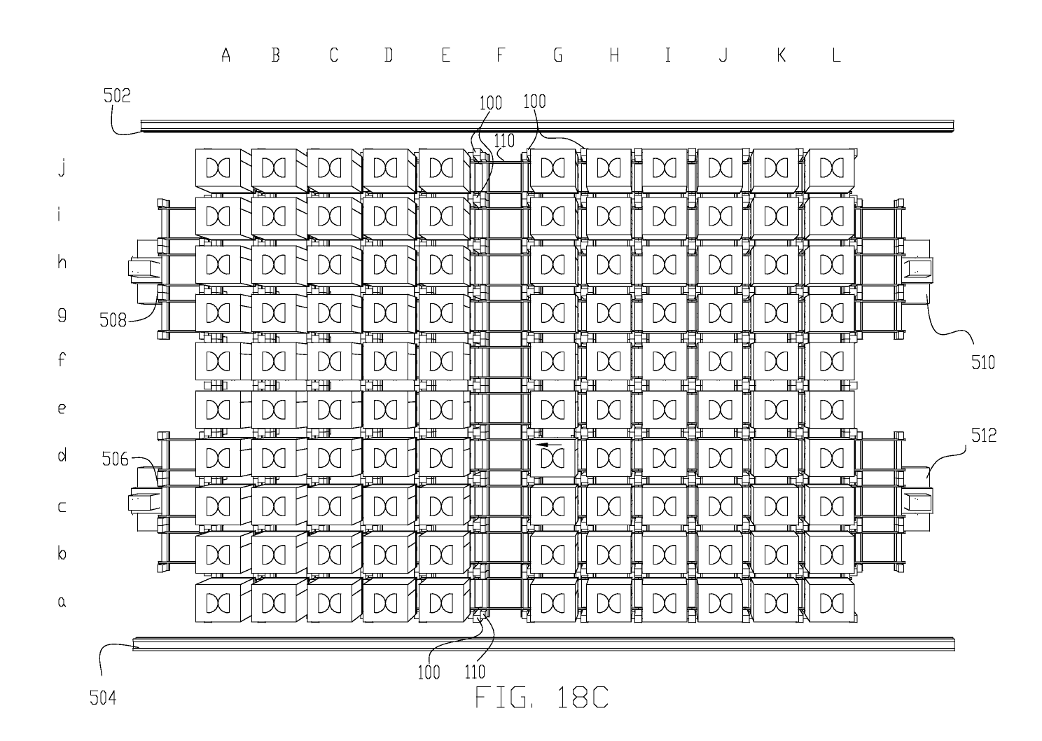

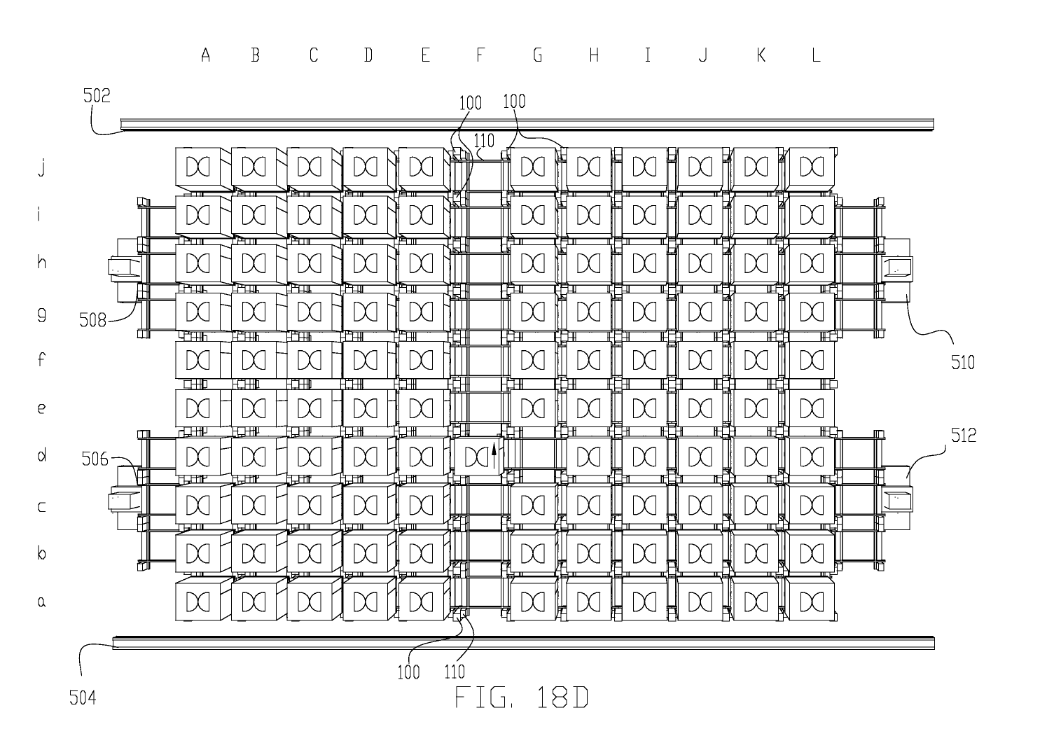

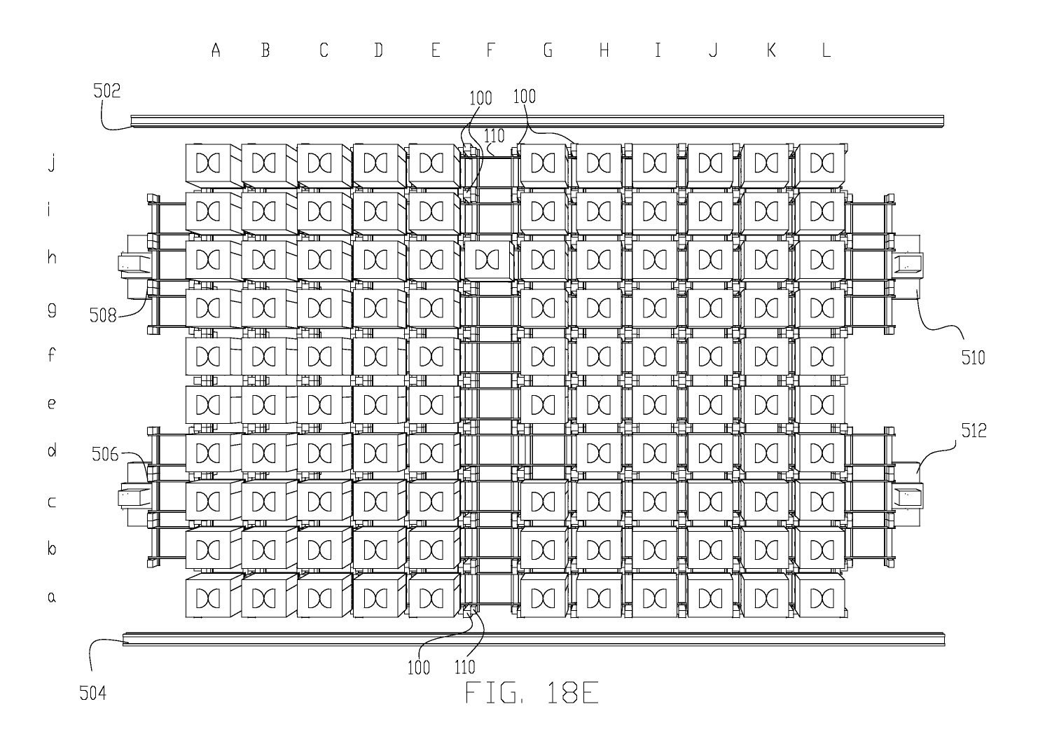

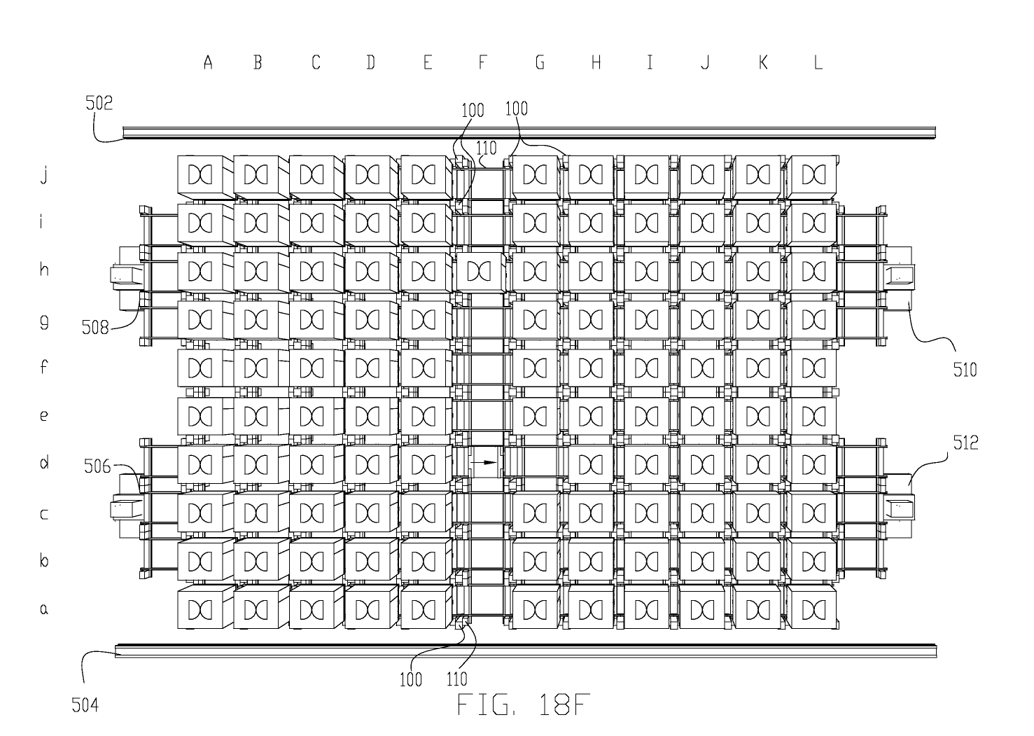

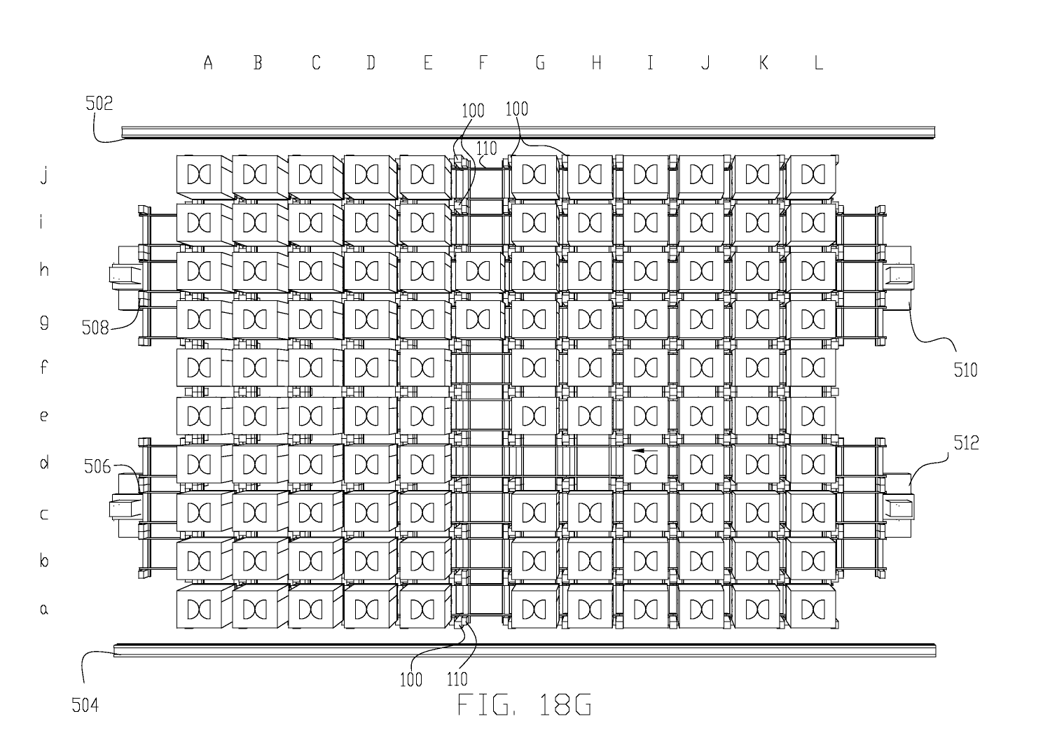

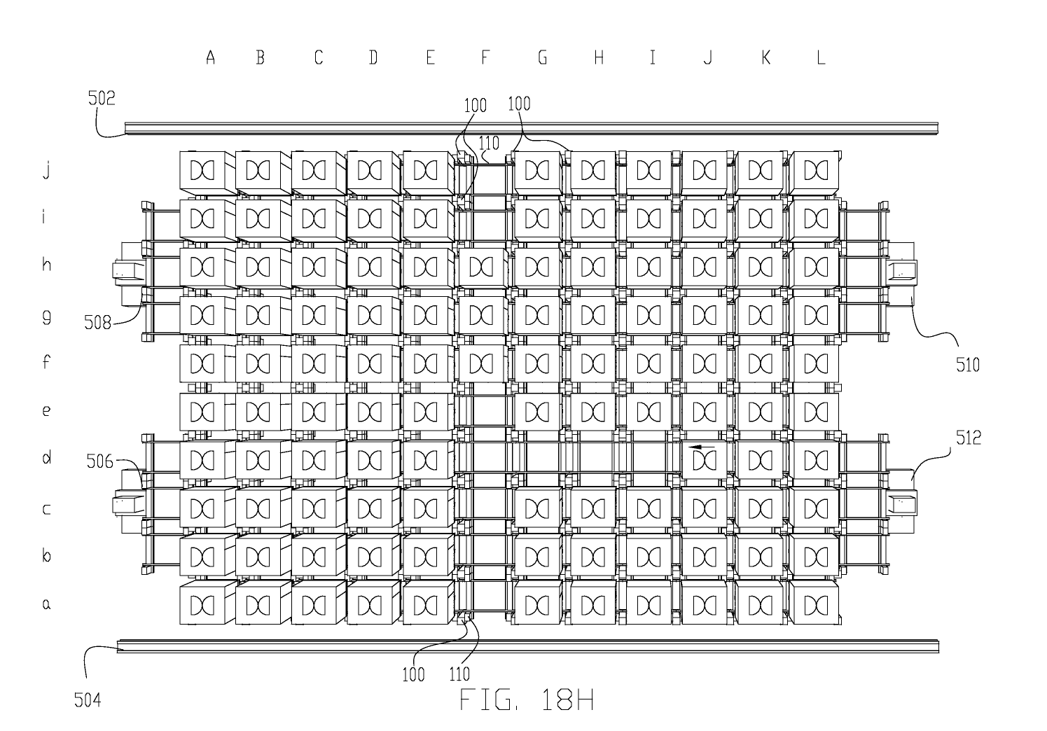

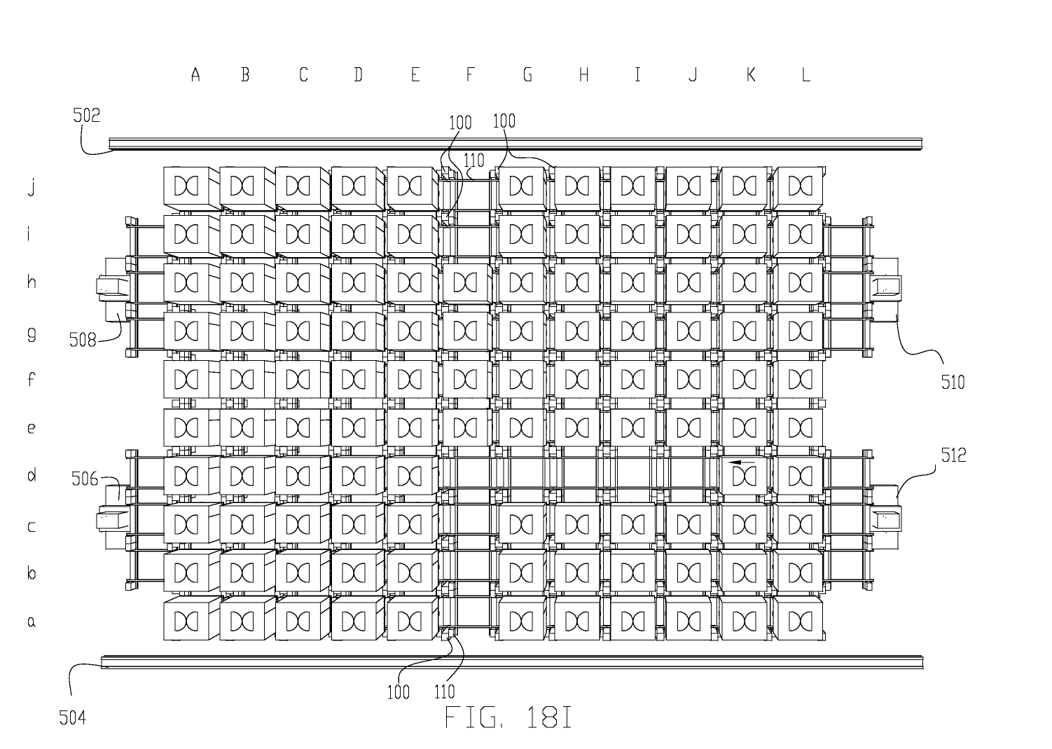

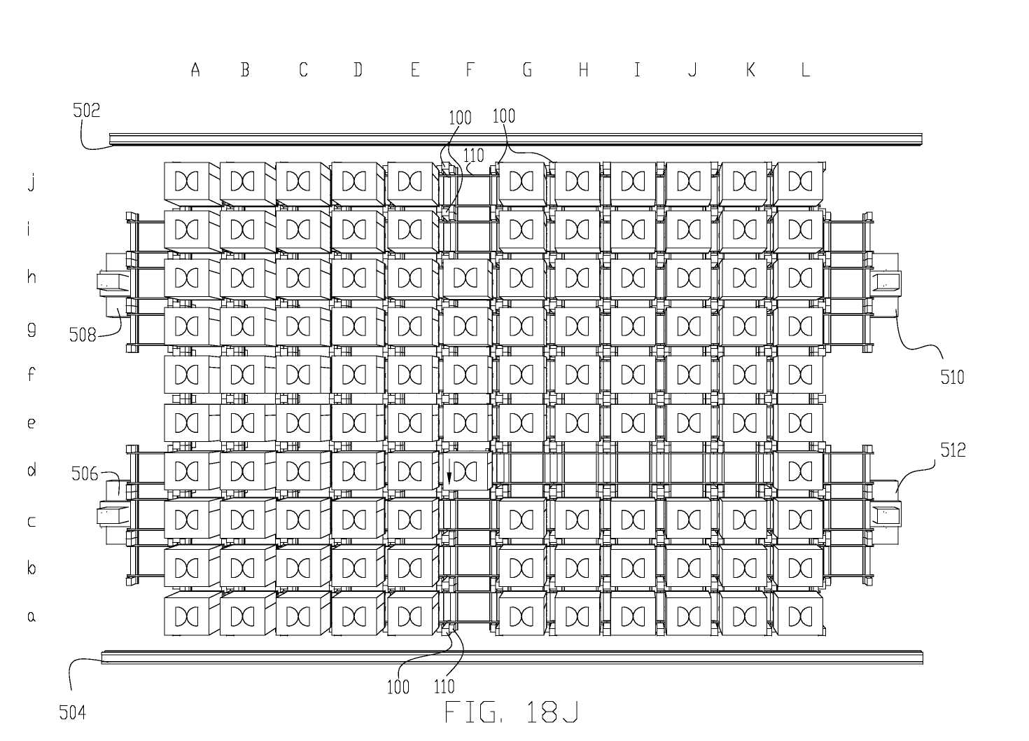

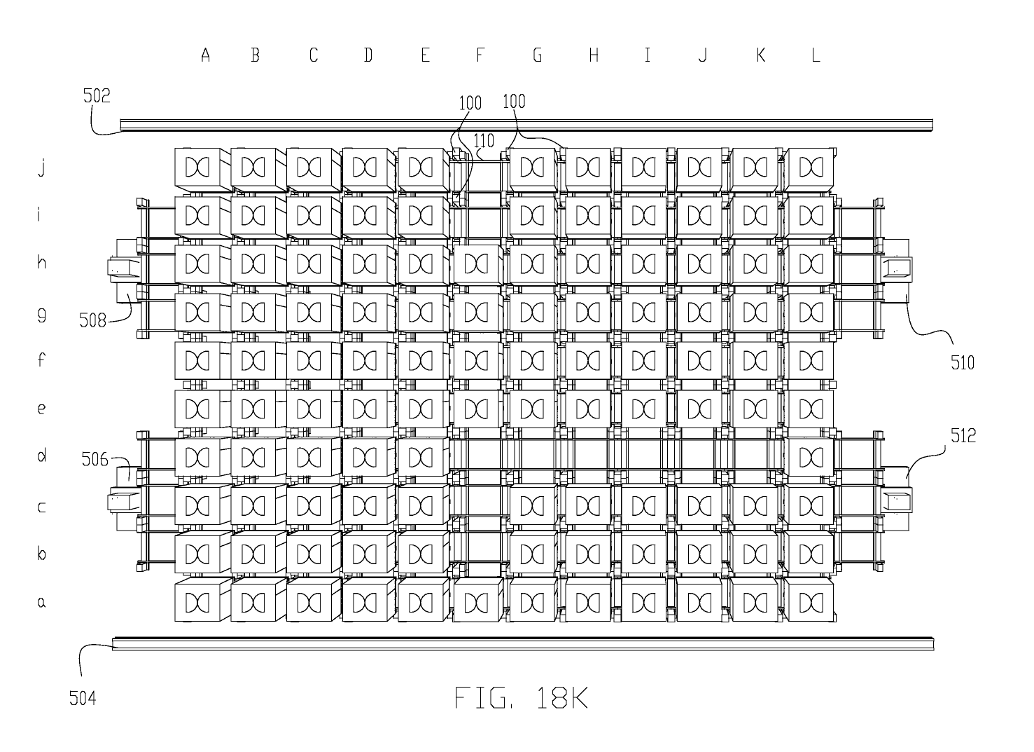

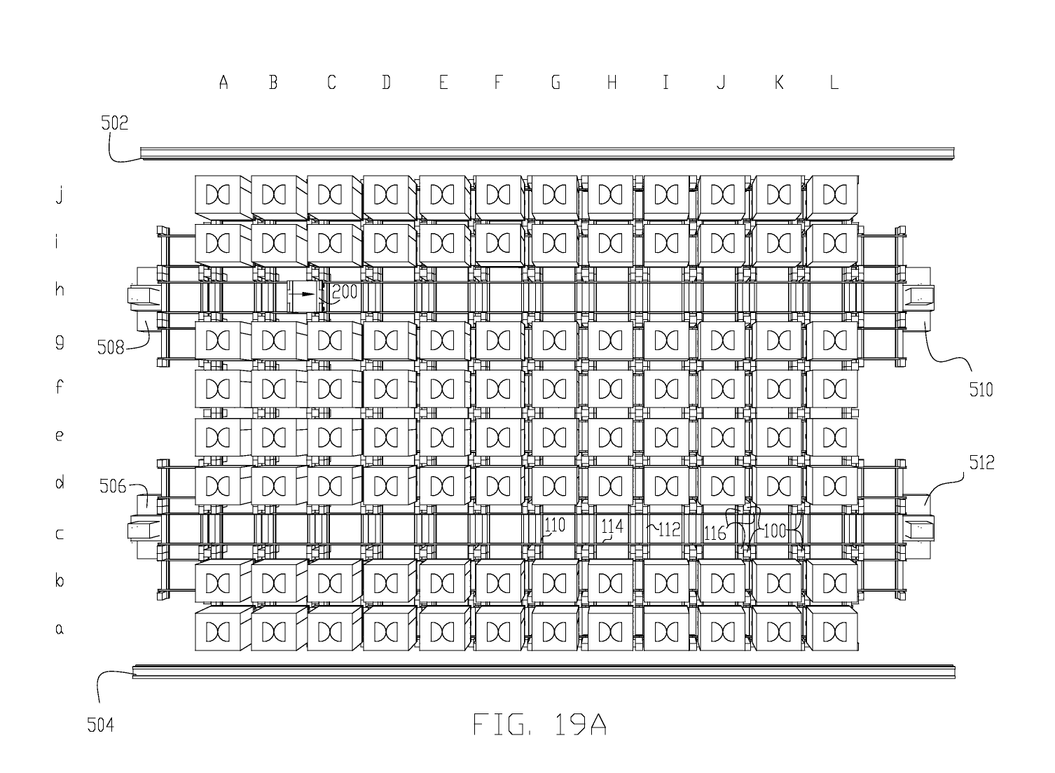

Reference is now made to FIGS. 18A-18K, which are simplified illustrations of various stages in a yet further aspect of the operation of the dynamically configurable automated warehousing system of FIGS. 1A-12, which are combinable with one or both aspects of the operation of the dynamically configurable automated warehousing system of FIGS. 1A-12 shown in FIGS. 15A-16M.

FIGS. 18A-18K show stages in the operation of the dynamically configurable automated warehousing system of FIGS. 1A-12 in its second typical configuration, as shown in FIG. 14B, arranged for storage of palletized loads, each of which may be different from the other, whereby the palletized load at location Kd is accessed. FIGS. 18A & 18B together show a three-directional palletized load transporter 200 (FIGS. 6A & 6B) moving along row F from location Fa to location Fd. FIGS. 18C-181 together show various steps for temporary relocation of palletized loads originally at locations Gd, Hd, Id, Jd to temporary locations along row F. It is appreciated that although not specifically illustrated herein, the orientations shown in FIGS. 7-12 are assumed by the three-directional palletized load transporter 200 (FIGS. 6A & 6B) multiple times as appropriate. FIGS. 18J & 18K together show three-directional palletized load transporter 200 (FIGS. 6A & 6B) moving the palletized load along column d and row F from location Kd to location Fa at which it can be lowered as necessary by crane 504.

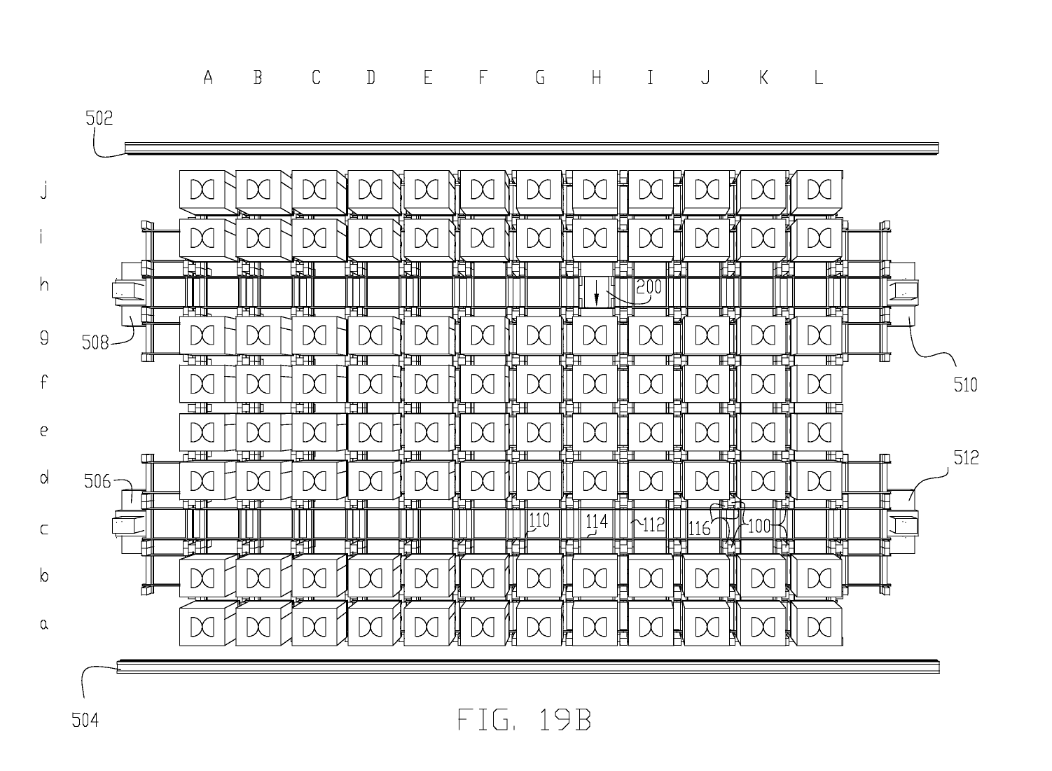

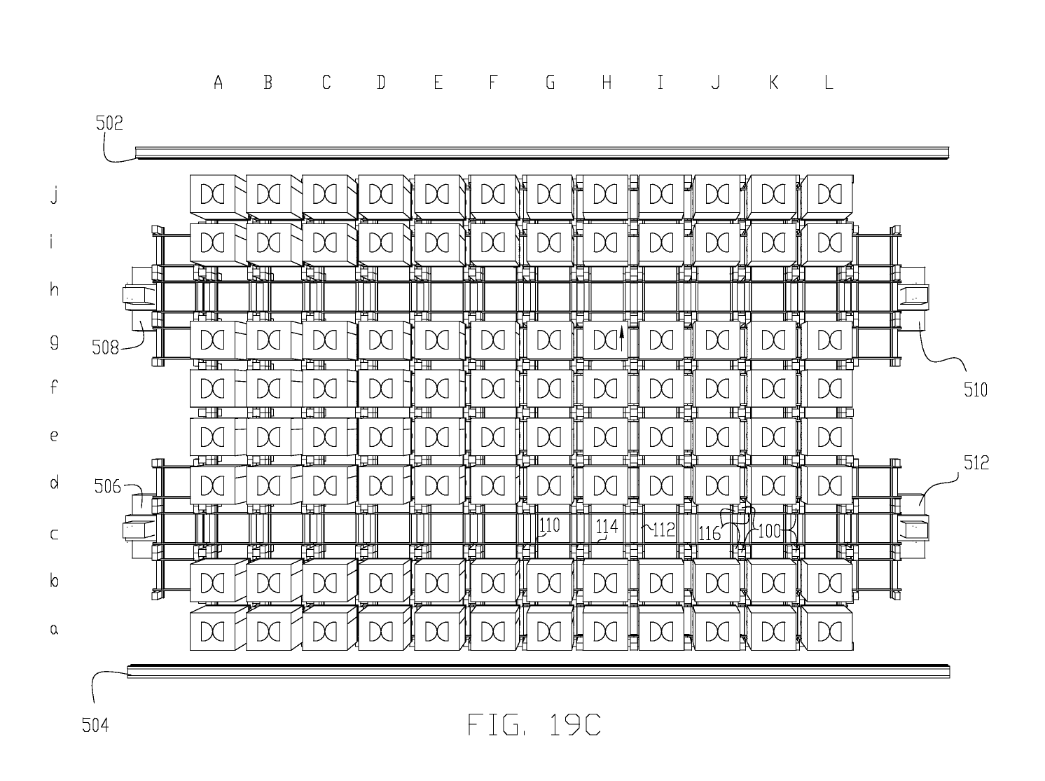

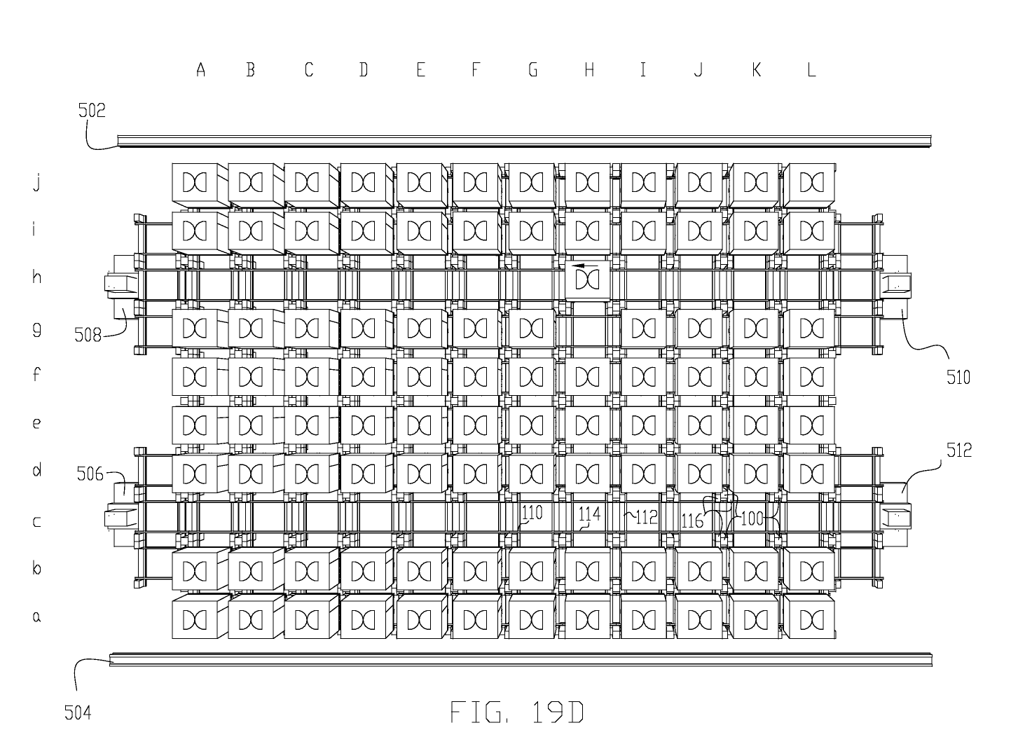

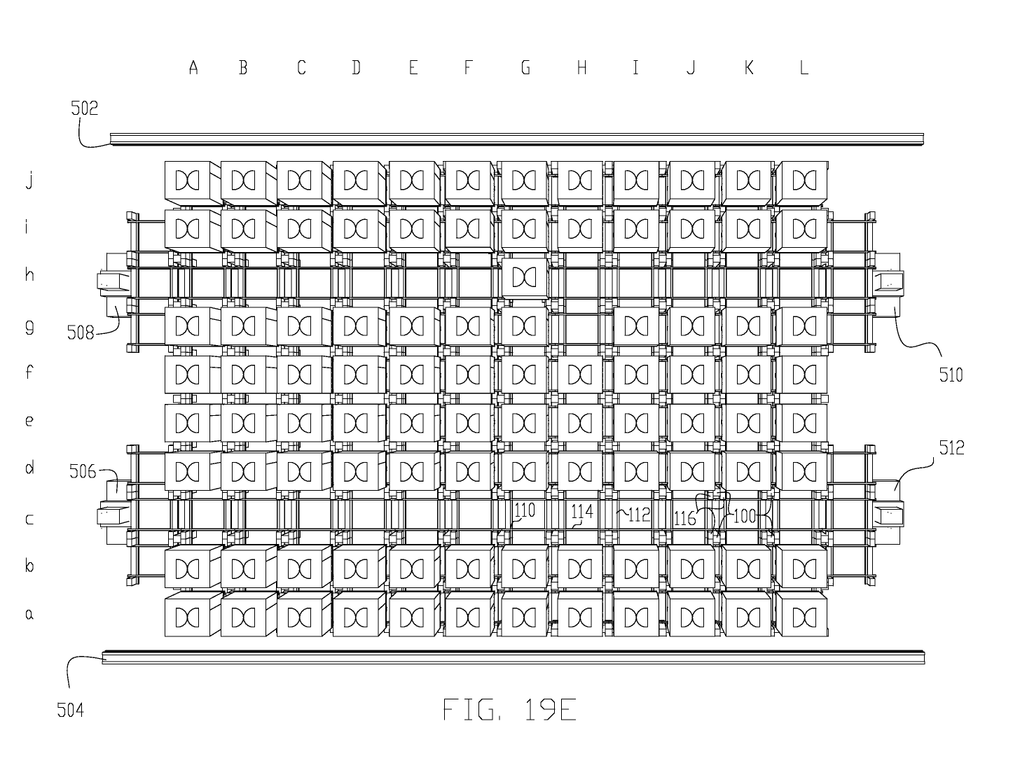

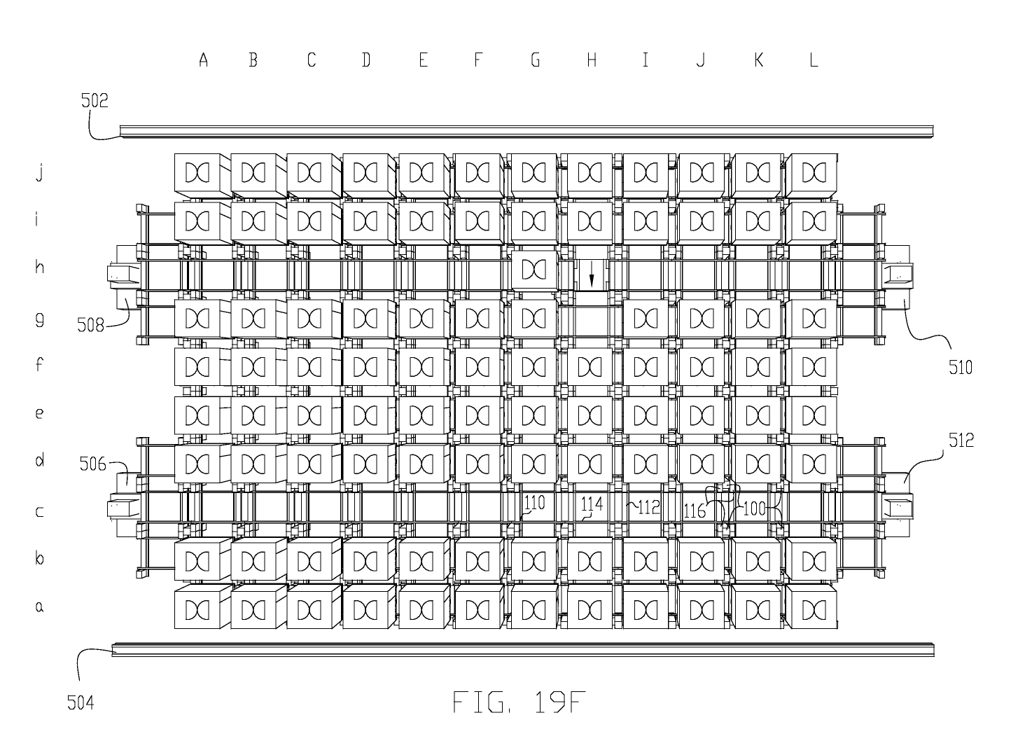

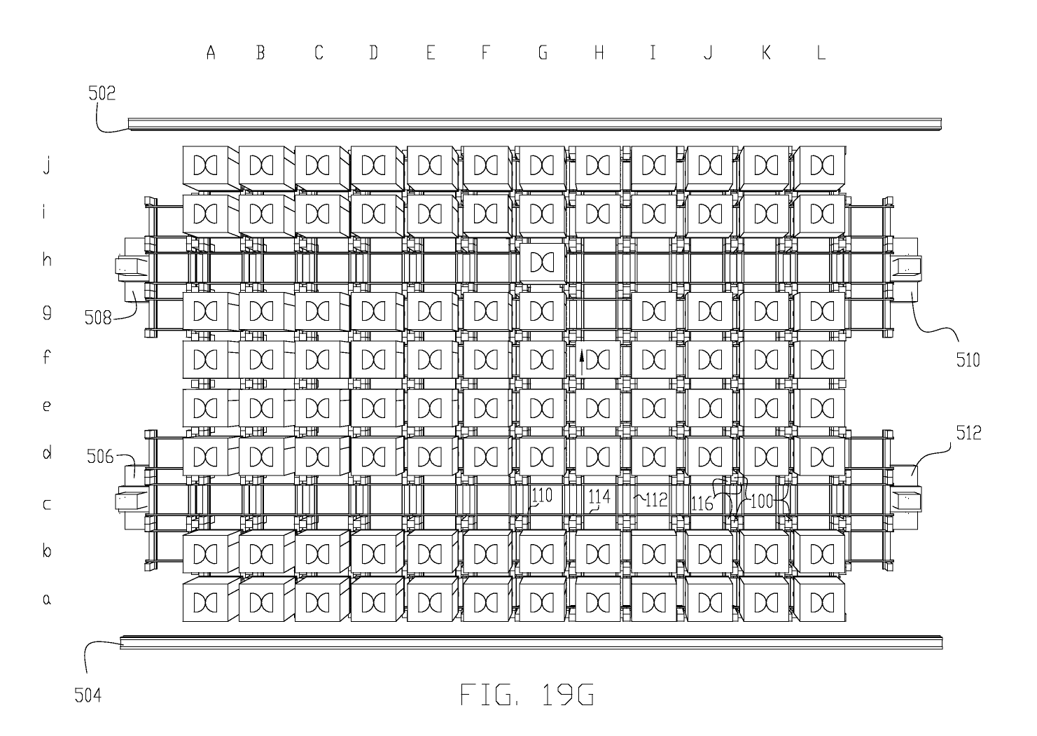

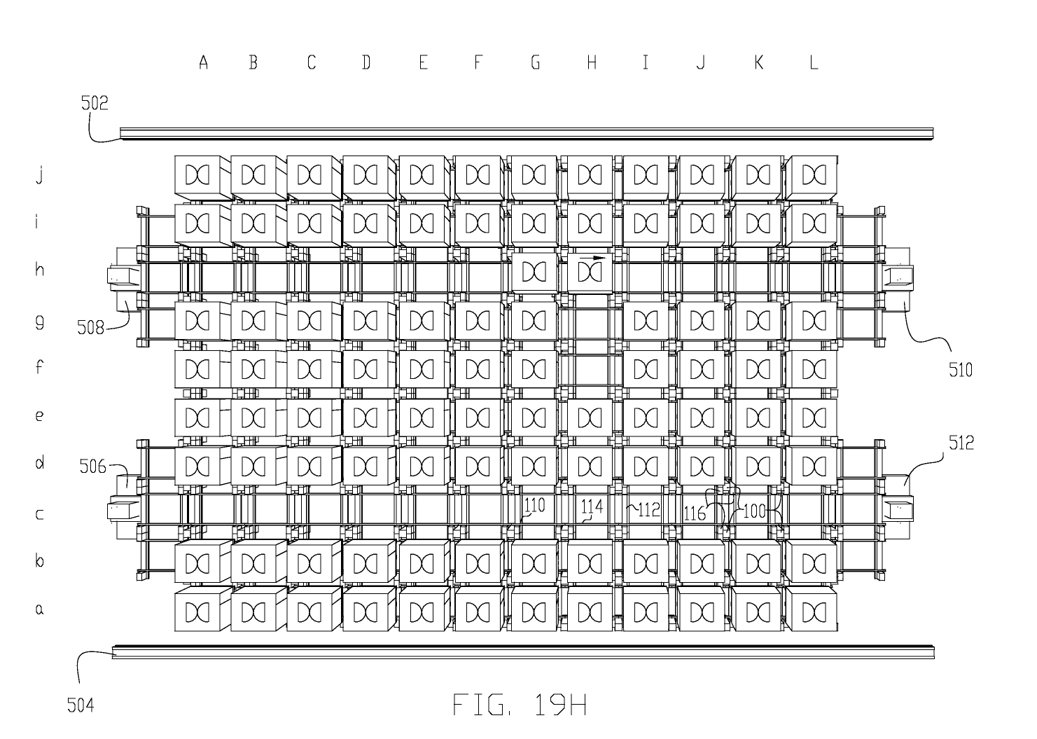

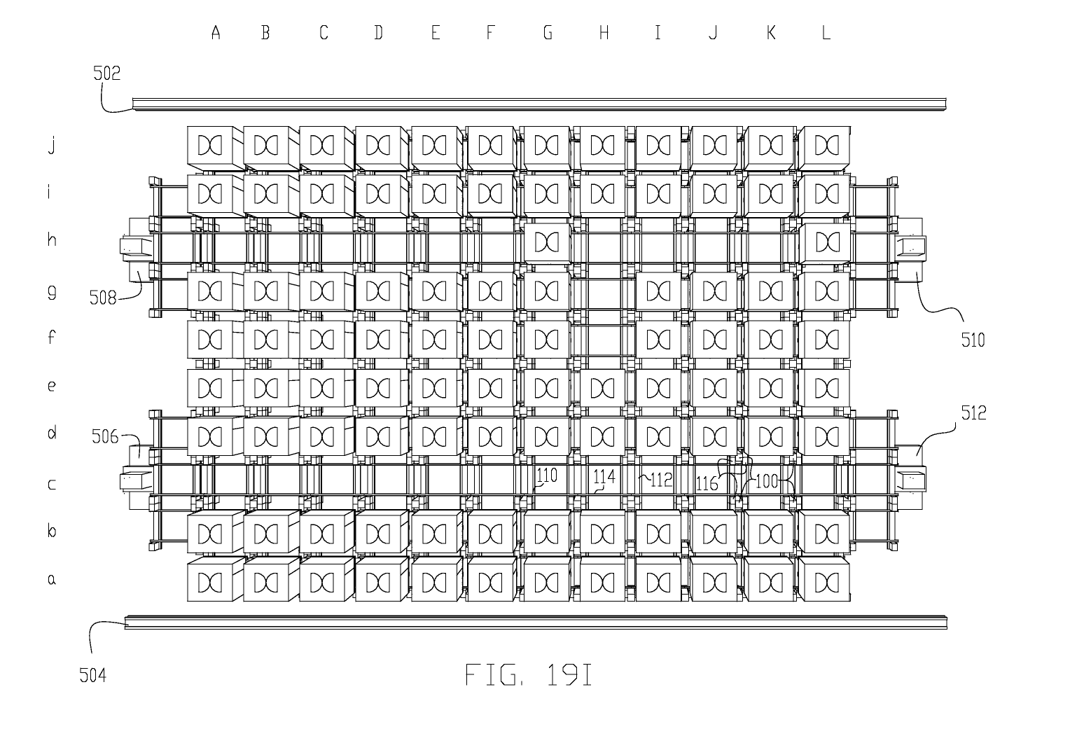

Reference is now made to FIGS. 19A-19I, which are simplified illustrations of various stages in a still further aspect of the operation of the dynamically configurable automated warehousing system of FIGS. 1A-12, which are combinable with one or both aspects of the operation of the dynamically configurable automated warehousing system of FIGS. 1A-12 shown in FIGS. 15A-16M.

FIGS. 19A-19I show stages in the operation of the dynamically configurable automated warehousing system of FIGS. 1A-12 in its fourth typical configuration, as shown in FIG. 14D, arranged for 2 deep storage of palletized loads, whereby the palletized load at location Hf is accessed. FIGS. 19A & 19B together show a three-directional palletized load transporter 200 (FIGS. 6A & 6B) moving along column h from location Bh to location Hh. FIGS. 19C-19E together shows raising of the palletized load at location Hg and temporary relocation of this palletized load to location Gh. It is appreciated that although not specifically illustrated herein, the orientations shown in FIGS. 7-12 are assumed by the three-directional palletized load transporter 200 (FIGS. 6A & 6B) multiple times as appropriate. FIGS. 19F-19I together show three-directional palletized load transporter 200 (FIGS. 6A & 6B) moving the palletized load at location Hf along row H and column h from location Hf to location Lh at which it can be lowered as necessary by elevator 510.

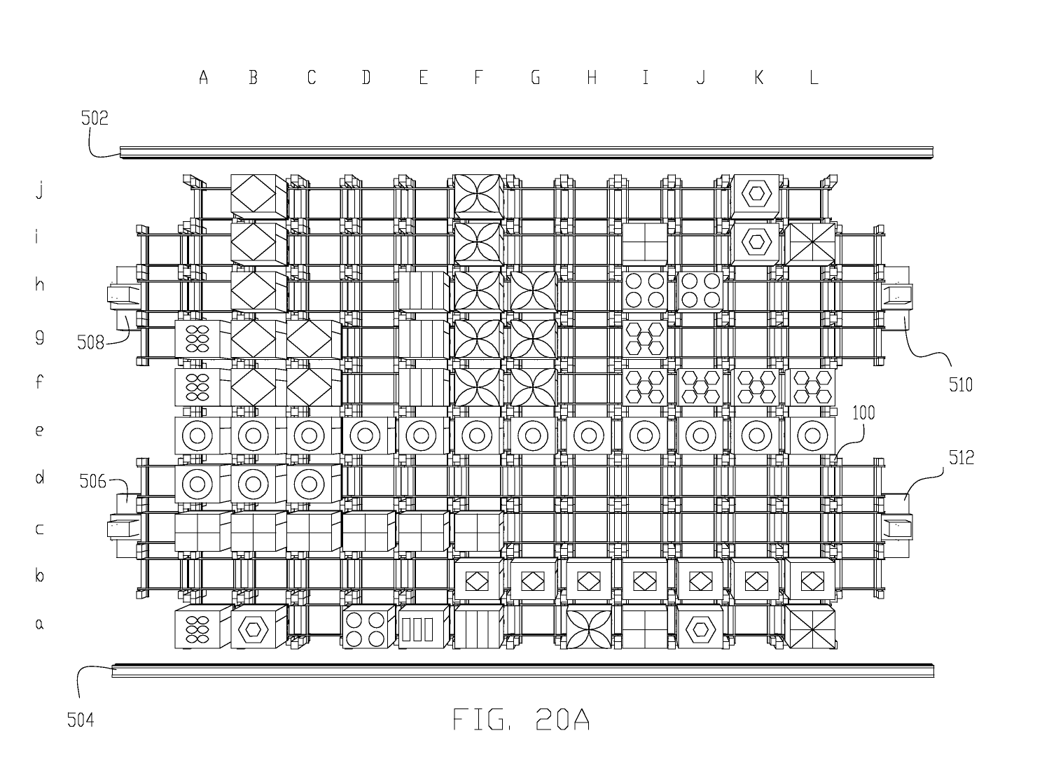

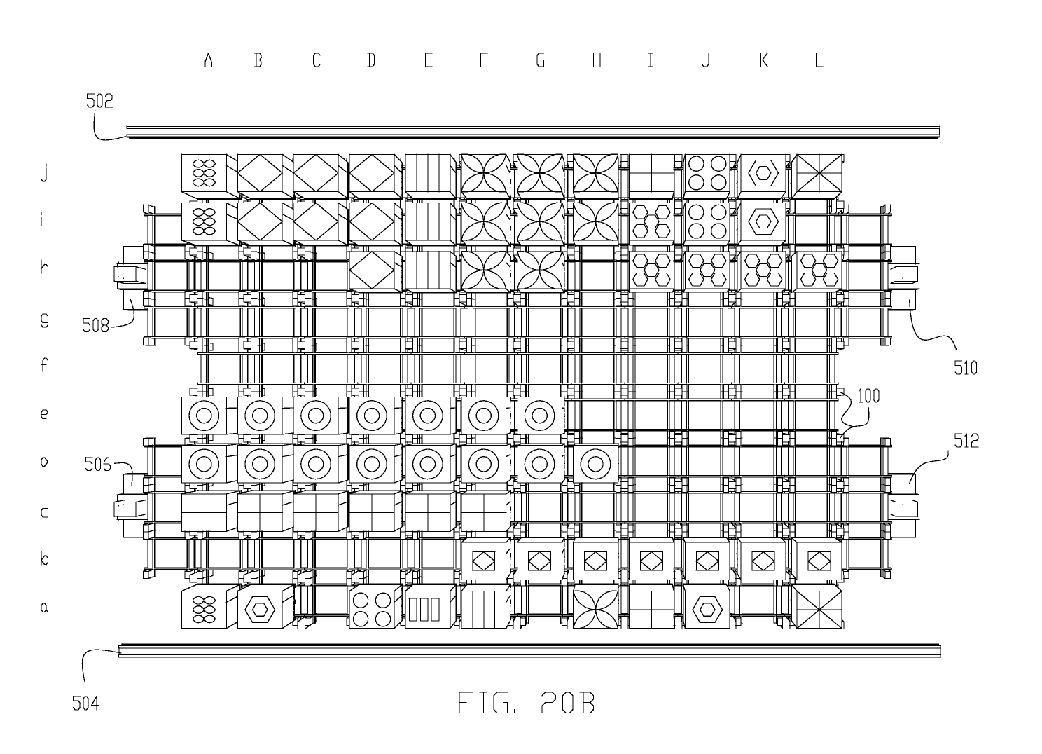

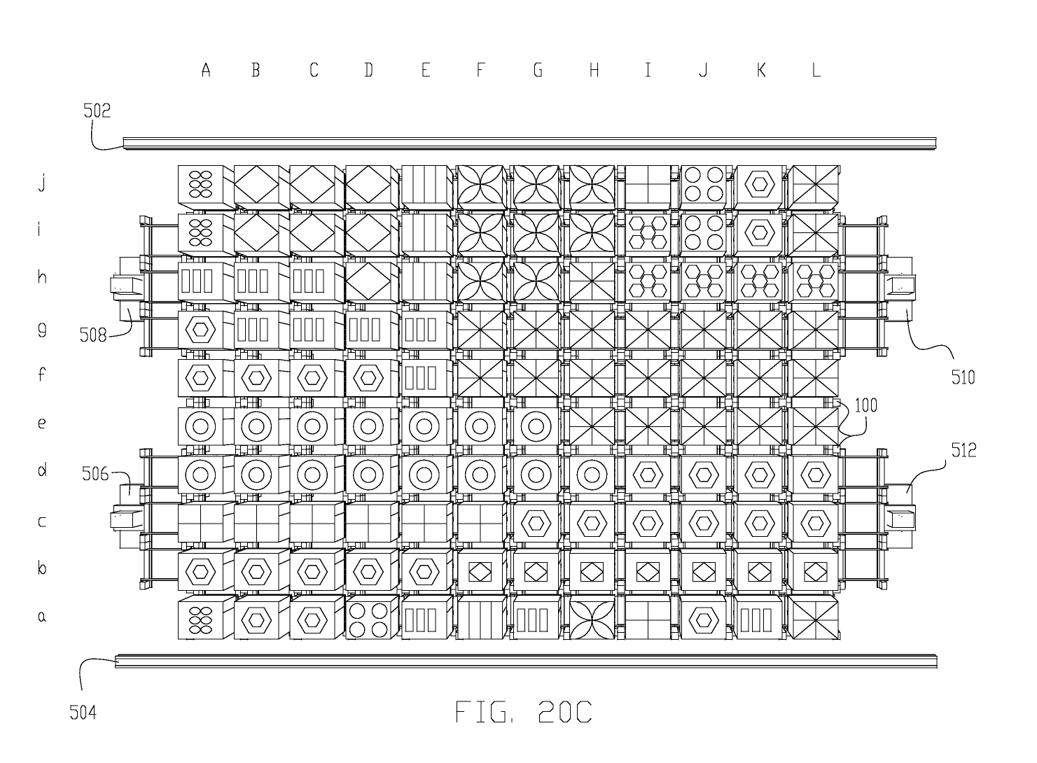

Reference is now made to FIGS. 20A, 20B and 20C, which are simplified illustrations of various stages in another further aspect of the operation of the dynamically configurable automated warehousing system of FIGS. 1A-12, which are combinable with one or both aspects of the operation of the dynamically configurable automated warehousing system of FIGS. 1A-12 shown in FIGS. 15A-16M.

FIG. 20A shows one level of the automated warehousing system of FIGS. 1A-12 organized in a manner shown in FIG. 14A, wherein various types of palletized loads are arranged in various depth arrangements depending on the quantity and retrieval requirements thereof. FIG. 20A illustrates a typical state of operation where some of the palletized loads have been removed. At this stage, prior to entry of new palletized loads, it is preferably to reposition the remaining palletized loads, taking into account quantities of the palletized loads to be received and their expected retrieval requirements.

FIG. 20B shows a typical rearrangement of the palletized loads shown in FIG. 20A. This rearrangement typical involves the following relocations of palletized loads, indicated hereinbelow in Table 1 by the row and column designations of the storage locations thereof:

TABLE 1

| Step # | From Location | To Location |
|---|---|---|
| 1 | Cg | Cj |
| 2 | Cf | Ci |
| 3 | Bh | Dj |
| 4 | Bg | Di |
| 5 | Bf | Dh |
| 6 | Eh | Ej |
| 7 | Eg | Ei |
| 8 | Ef | Eh |
| 9 | Ag | Aj |
| 10 | Af | Ai |
| 11 | Gh | Gj |
| 12 | Gg | Gi |
| 13 | Gf | Gh |
| 14 | Fg | Hj |
| 15 | Ff | Hi |
| 16 | Ii | Ij |
| 17 | Jh | Jj |
| 18 | Ih | Ji |
| 19 | Ig | Ii |
| 20 | If | Ih |
| 21 | Jf | Jh |
| 22 | Kf | Kh |
| 23 | Lf | Lh |
| 24 | Li | Lj |
| 25 | Ie | Dd |
| 26 | Je | Ed |
| 27 | Ke | Fd |
| 28 | Le | Gd |
| 29 | He | Hd |

It is appreciated that the rearrangement need not be on a single level basis but may involve relocation of palletized loads from one level to another.

FIG. 20C shows the rearranged palletized loads of FIG. 20B with the addition of new palletized loads.

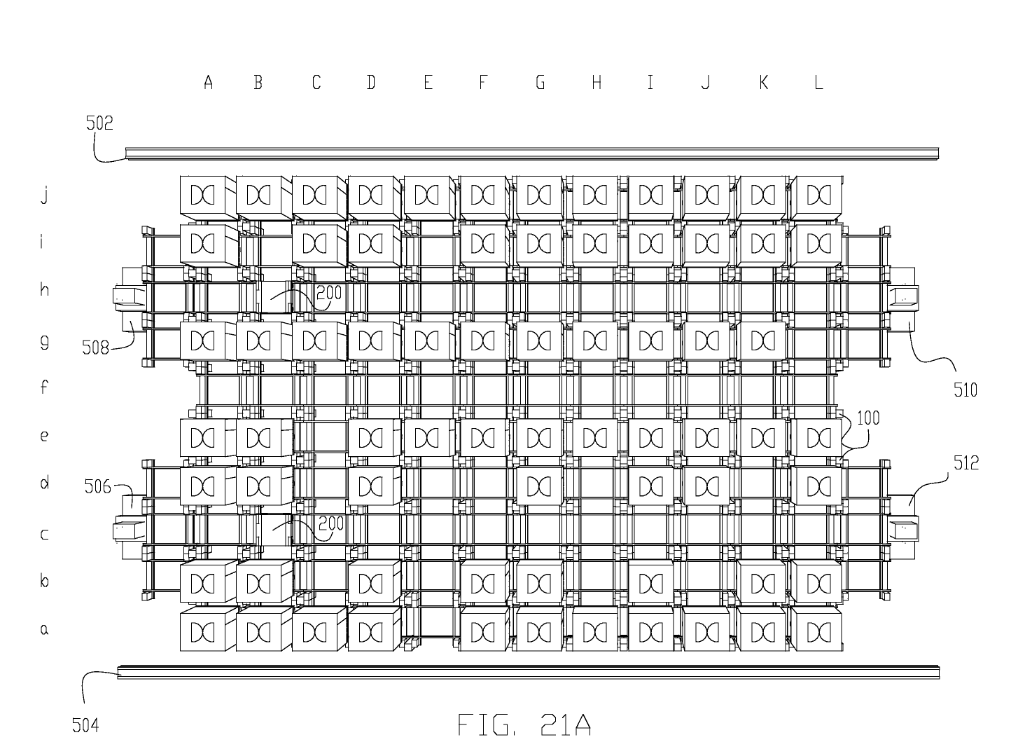

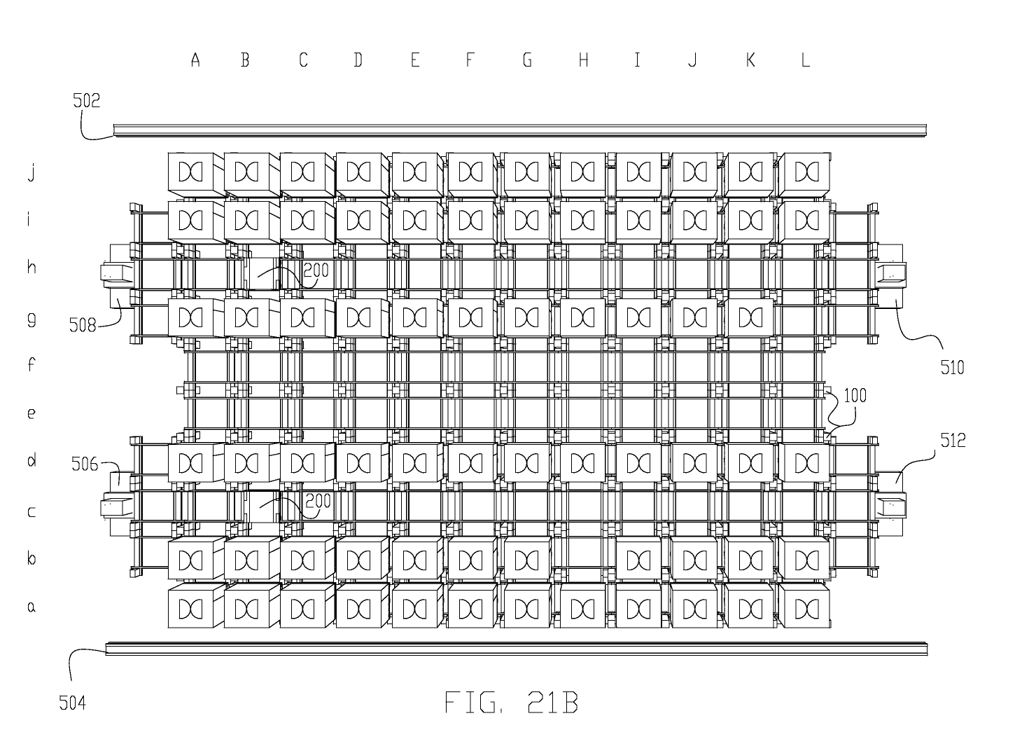

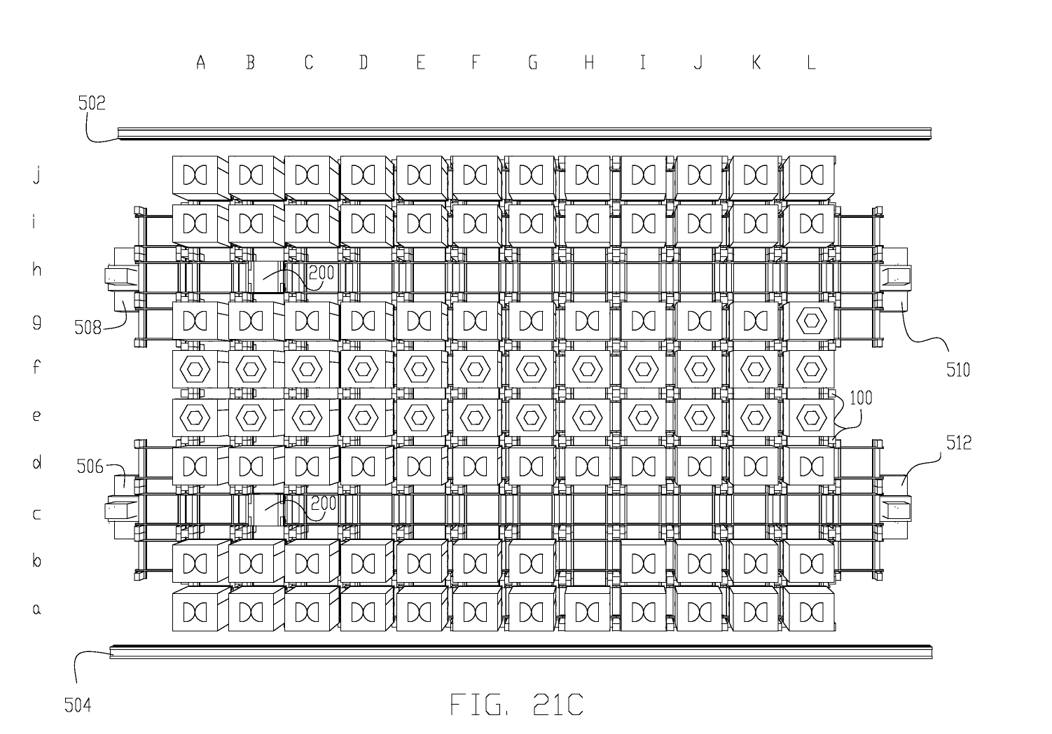

Reference is now made to FIGS. 21A, 21B and 21C, which are simplified illustrations of various stages in yet another further aspect of the operation of the dynamically configurable automated warehousing system of FIGS. 1A-12, which are combinable with one or both aspects of the operation of the dynamically configurable automated warehousing system of FIGS. 1A-12 shown in FIGS. 15A-16M.

FIG. 21A shows one level of the automated warehousing system of FIGS. 1A-12 organized in a manner shown in FIG. 14C, wherein palletized loads which may all be different from each other are arranged for 1 deep storage FIG. 21A illustrates a typical state of operation where some of the palletized loads have been removed. At this stage, prior to entry of new palletized loads, it is preferably to reposition the remaining palletized loads, taking into account quantities of the palletized loads to be received and their expected retrieval requirements.

FIG. 21B shows a typical rearrangement of the palletized loads shown in FIG. 20A in order to accommodate more palletized loads. This rearrangement, as distinct from that described hereinabove with respect to FIGS. 20A-20C, involves changing the designations of some of the mutually adjacent palletized load storage/travel locations from palletized load travel locations to palletized load storage locations. In the illustrated example of FIGS. 21A-21C, the locations in column f are redesignated from being palletized load travel locations to palletized load storage locations.

This redesignation takes place initially by relocation of the palletized loads shown in FIG. 21A to an arrangement shown in FIG. 21B. The relocations of palletized loads are each indicated hereinbelow in Table 2 by the row and column designations of the storage locations thereof:

TABLE 2

| Step # | From Location | To Location |
|---|---|---|
| 1 | Bg | Bi |
| 2 | Eg | Ei |
| 3 | Be | Bg |
| 4 | Ee | Eg |
| 5 | Ae | Cb |
| 6 | De | Cd |
| 7 | Fe | Ea |
| 8 | Ge | Eb |
| 9 | He | Hd |
| 10 | Ie | Ed |
| 11 | Je | Fd |
| 12 | Ke | Jb |
| 13 | Le | Kd |

It is appreciated that the rearrangement need not be on a single level basis but may involve relocation of palletized loads from one level to another.

FIG. 21C shows the rearranged palletized loads of FIG. 20B with the addition of new palletized loads. It is appreciated that this arrangement is a 2-deep storage arrangement and corresponds to that shown in FIG. 14D.

Reference is now made to FIG. 22, which is a simplified illustration of communication between the various components of the dynamically automated warehousing system of FIGS. 1A-12.

As seen in FIG. 22, the dynamically configurable automated warehousing system preferably includes a warehouse controller 700, typically in communication with one or more computers 702, which may be remotely located therefrom, each typically including a display 704, and one or more input devices 706 and preferably including wired and wireless communication capability. Preferably, warehouse controller 700 is operative to automatically calculate instructions for moving palletized loads, such as loads 600 and 610, and communicates the instructions, typically via a wireless communicator 710 and transporter wireless communicators 292, which communicate, in turn with transporter controller 290 of multiple three-directional palletized load transporters 200. Controller 700 also communicates instructions with cranes 502 and 504 and elevators 506, 508, 510 and 512.

It is appreciated that the configurable automated warehousing system may also include scanning devices, such as bar code readers, for scanning information tags on palletized loads. The scanning devices may be mounted on any or all of transporters 200, cranes 502 and 504 or elevators 506, 508, 510 and 512 and preferably communicate with warehouse controller 700 via one or more 2-way wireless communication links.

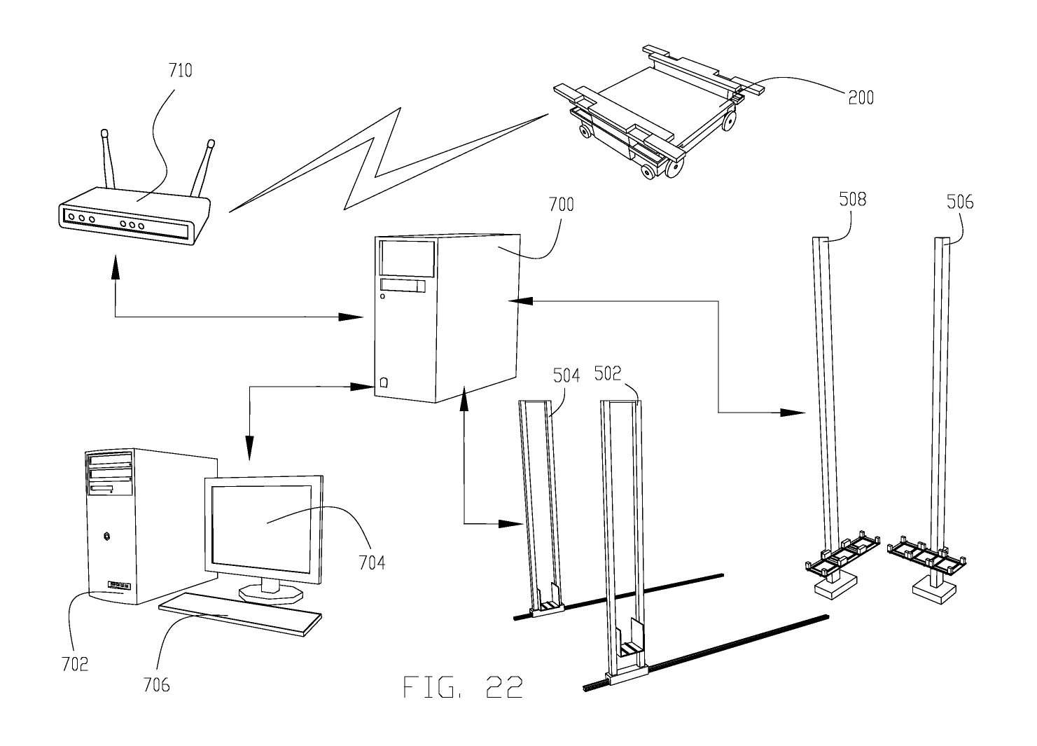

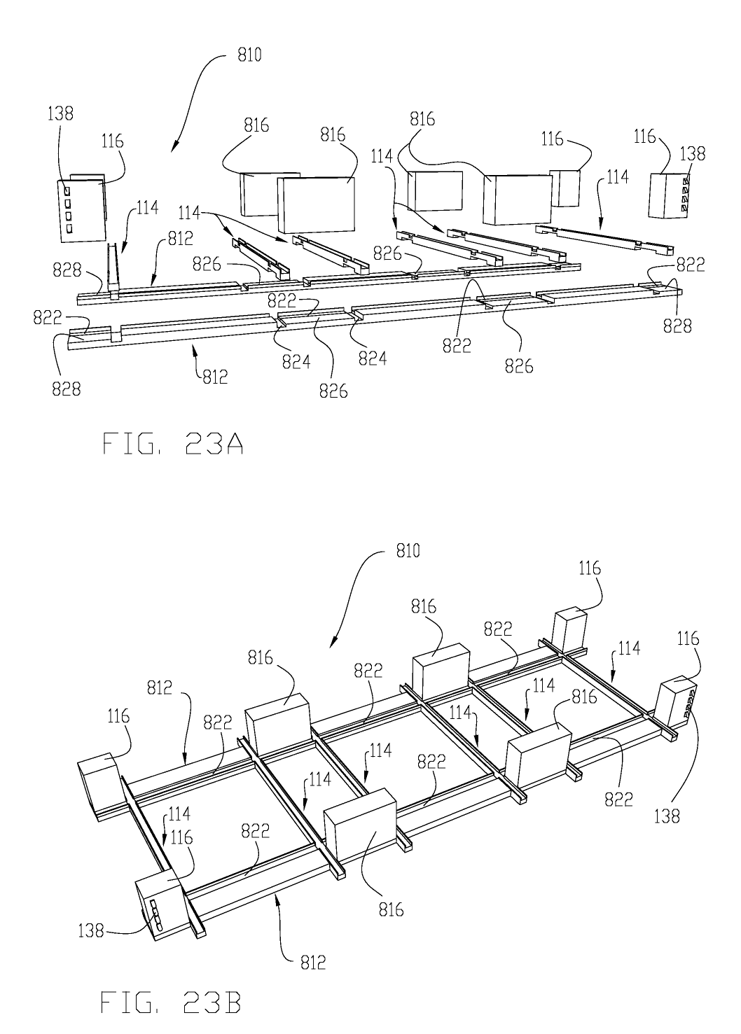

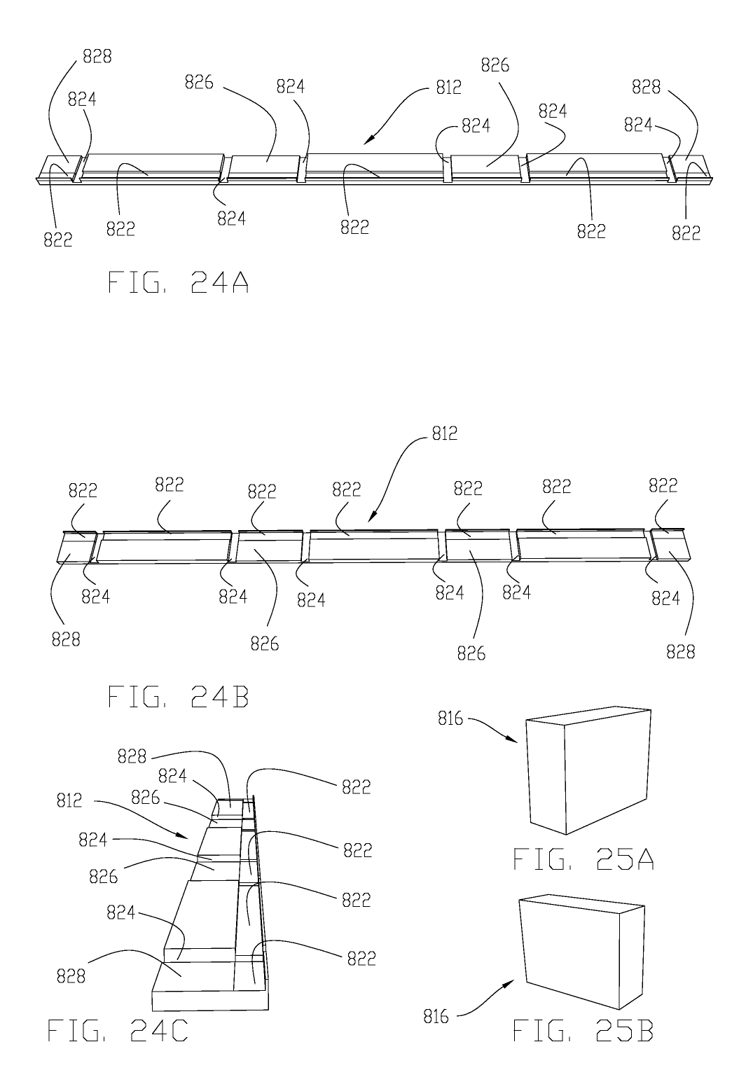

Reference is now made to FIGS. 23A & 23B, which are respective simplified exploded view and assembled view pictorial illustrations of a multiple pallet modular multi-track support element 810 employed in the construction of a dynamically configurable automated warehousing system in accordance with a second preferred embodiment of the present invention. Reference is also made to FIGS. 24A, 24B and 24C, which are respective simplified pictorial illustrations of a first type of track element forming part of the multiple pallet modular multi-track support element of FIGS. 23A & 23B, and to FIGS. 25A and 25B, which are respective simplified pictorial illustrations of a palletized load support element forming part of the multiple pallet modular multi-track support element of FIGS. 23A & 23B.

As seen in FIGS. 23A & 23B, the multiple pallet modular multi-track support element 810 is preferably a welded or bolted unit, formed of a pair of generally parallel first track elements 812, six generally parallel second track elements 114, preferably mounted on the pair of first track elements 812, four palletized load support elements 816, which are fixed to central locations along first track elements 812, and four palletized load support and pillar mounting elements 116, which are fixed to the four corners of the first track elements 812.

Turning now additionally and specifically to FIGS. 24A, 24B & 24C, it is seen that first track elements 812 preferably are each generally elongate elements having an overall generally rectangular cross section. Each track element 812 is preferably formed with a longitudinal recess 822 extending along the entire length thereof and defining a first track. Each track element 812 is also preferably formed with six mutually spaced transverse recesses 824, which intersect recess 822. As seen particularly in FIG. 24C, transverse recesses 824 are deeper than longitudinal recess 822. Each track element 812 is also formed with two central generally rectangular reduced thickness regions 826 and two corner generally rectangular reduced thickness regions 828.

Second track elements 114 included in multiple pallet modular multi-track support element 810 are described hereinabove with reference to FIGS. 4A, 4B and 4C. Palletized load support and pillar mounting elements 116 included in multiple pallet modular multi-track support element 810 are described hereinabove with reference to FIGS. 5A and 5B.

Turning now additionally and specifically to FIGS. 25A & 25B, it is seen that palletized load support elements 816 are preferably generally rectangular closed hollow elements, typically being larger than palletized load support and pillar mounting elements 116.

In the example shown in FIGS. 23A-23B, it is seen that second track elements 114 are preferably mounted perpendicularly to first track elements 812 and lie in transverse recesses 824. The various thicknesses of the elements and the recesses and cut outs formed therein are preferably such that the first and second tracks are of generally uniform dimensions all along the first and second track elements 812 and 114, including the regions at which they overlap and at which the first and second tracks intersect.

Palletized load support elements 816 are preferably welded onto central generally rectangular reduced thickness regions 826 of the multiple pallet modular multi-track support element 810 and palletized load support and pillar mounting elements 116 are preferably welded onto reduced thickness regions 828 at four corners of the multiple pallet modular multi-track support element 810. It is appreciated that, as seen above in FIGS. 5A & 5B, load support and pillar mounting elements 116 each include a vertical array of mounting protrusions 138 which are preferably configured for secure mounting of palletized load support and pillar mounting elements 116 and thus of multiple pallet modular multi-track support element 810 on multiple pillar elements 100 via engagement with a corresponding vertical array of series of mounting slots 102 formed on each of pillar elements 100.

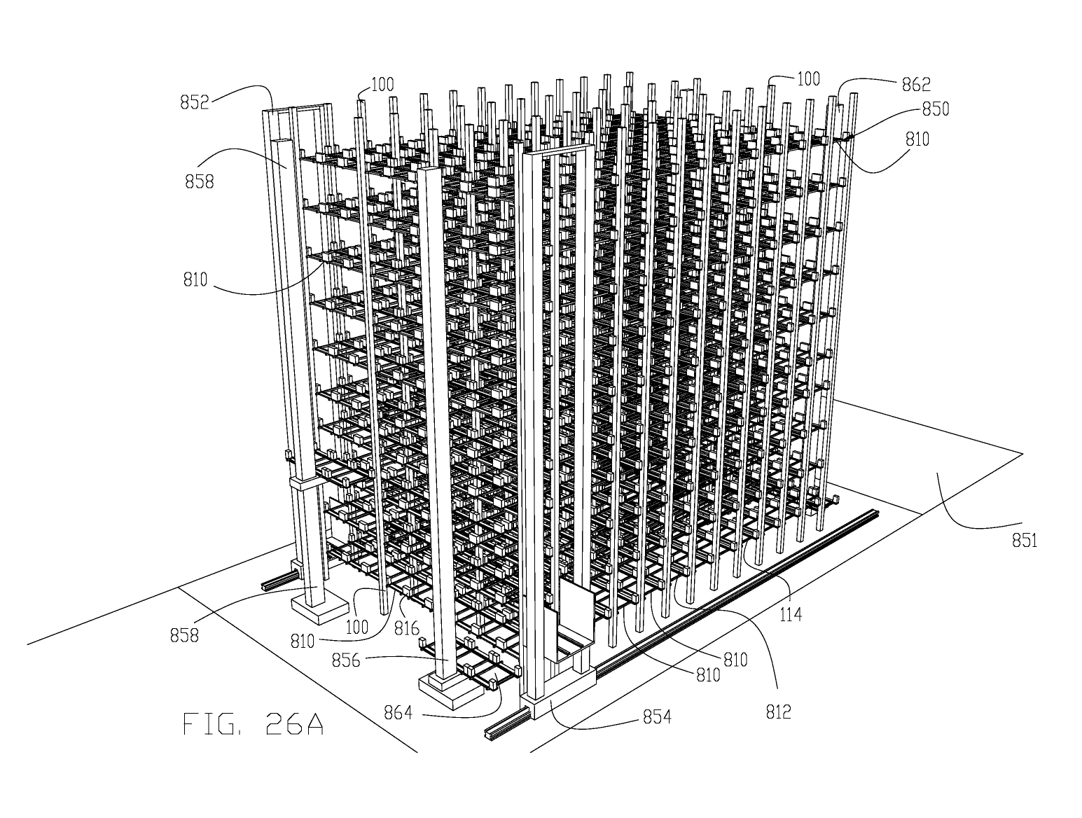

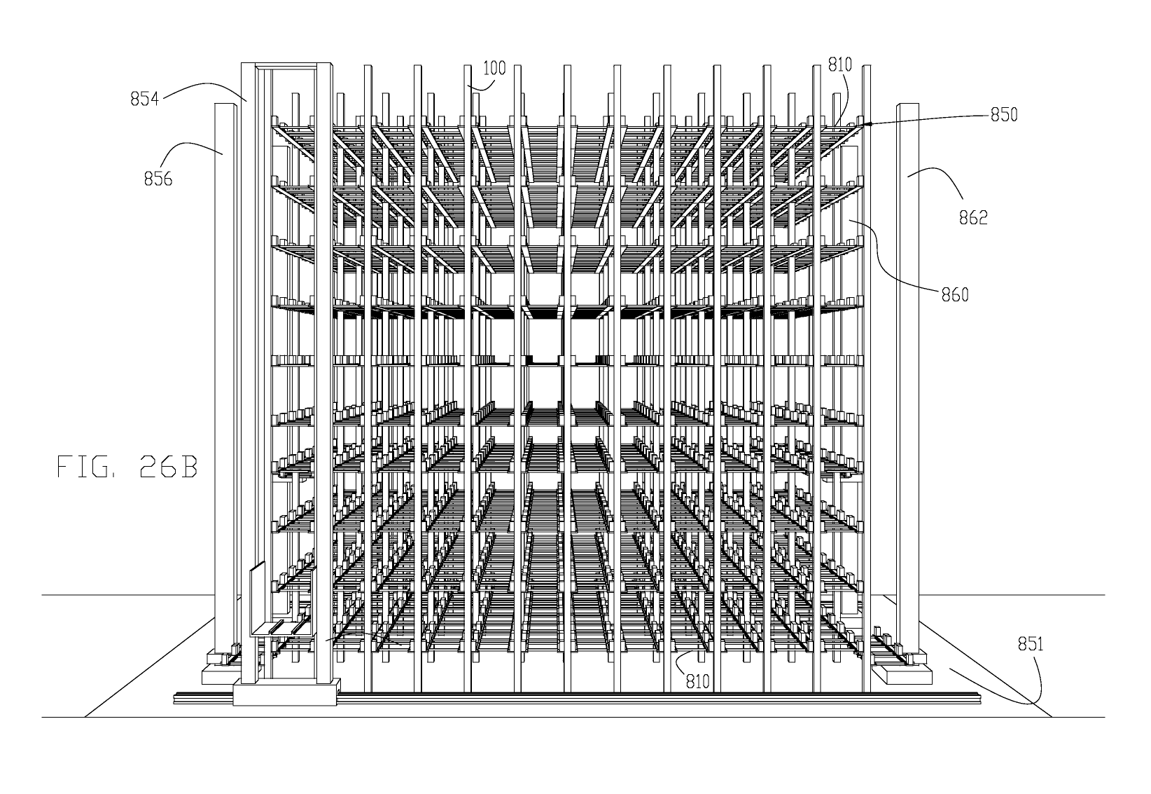

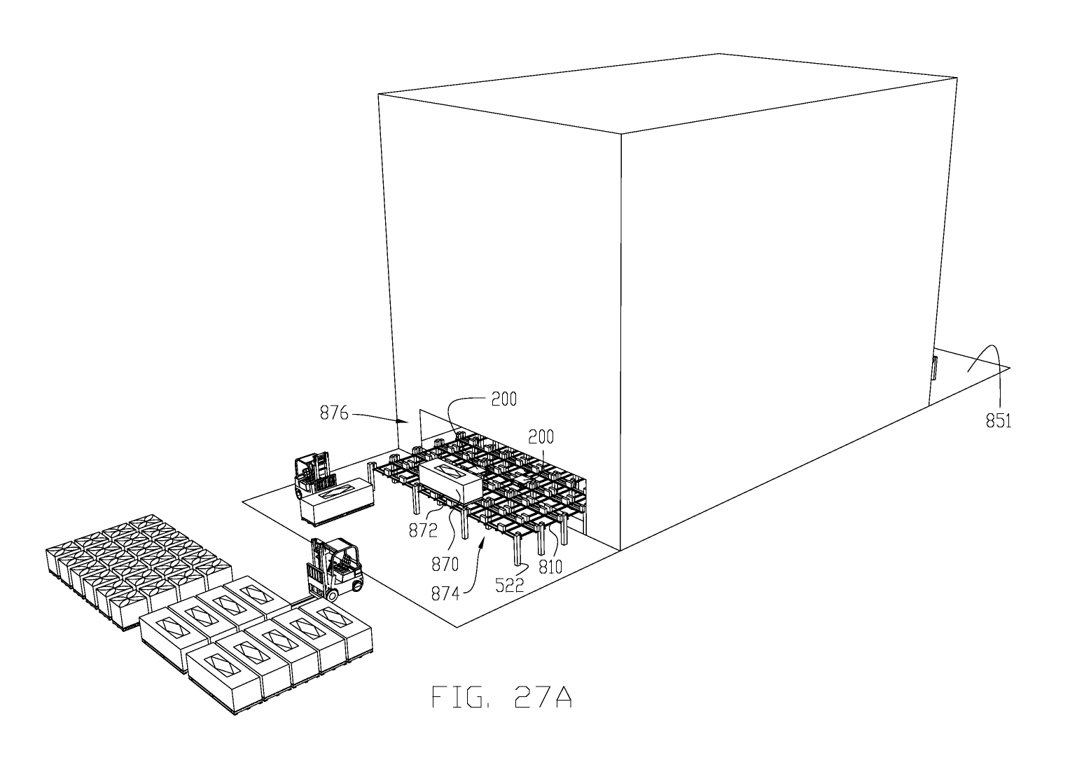

Reference is now made to FIGS. 26A & 26B, which are simplified illustrations of a dynamically configurable automated warehousing system in accordance with the second preferred embodiment of the present invention.

As seen in FIGS. 26A and 26B, an array 850 of pillar elements 100, having mounting slots 102 formed along at least two surfaces therealong, are bolted via respective mounting elements 101 onto a support surface, such as a concrete slab 851. In the illustrated embodiment, array 850 includes 13 rows of pillar elements 100, each row including 4 pillar elements.

A multiplicity of multiple pallet modular multi-track support elements 810 are mounted onto array 850, preferably by means of engagement of mounting protrusions 138 (FIG. 23A) in mounting slots 102 of pillar elements 100. In the illustrated embodiment, a total of 33 multiple pallet modular multi-track support elements 810 are provided on each level. It is appreciated that each of multiple pallet modular multi-track support elements 810 includes three different individual palletized load storage/travel locations.

As seen in FIGS. 26A and 26B, the dynamically configurable automated warehousing system also preferably includes first and second tracked palletized load handling cranes 852 and 854 on respective opposite sides of array 850. Cranes 852 and 854 may each be any suitable crane, preferably a model MTB 7, commercially available from Mecalux SA of Spain.

As seen in FIGS. 26A and 26B, dynamically configurable automated warehousing system also preferably includes a pair of palletized load handling elevators, respectively designated by reference numerals 856 & 858 and 860 & 862, on each of two respective opposite sides of array 850 on which cranes 852 and 854 are not located. Elevators 856, 858, 860 and 862 may be any suitable elevator, preferably a model Scando 650 FC-XL, commercially available from Alimak AB of Sweden. Preferably, load platforms 864 of elevators 856, 858, 860 and 862 are each configured to define recesses and tracks identical to those in multiple pallet modular multi-track support elements 810 and aligned with corresponding recesses and tracks in adjacent ones of multiple pallet modular multi-track support elements 810. Preferably, the load platforms 864 of each of elevators 856, 858, 860 and 862 accommodate three palletized loads.

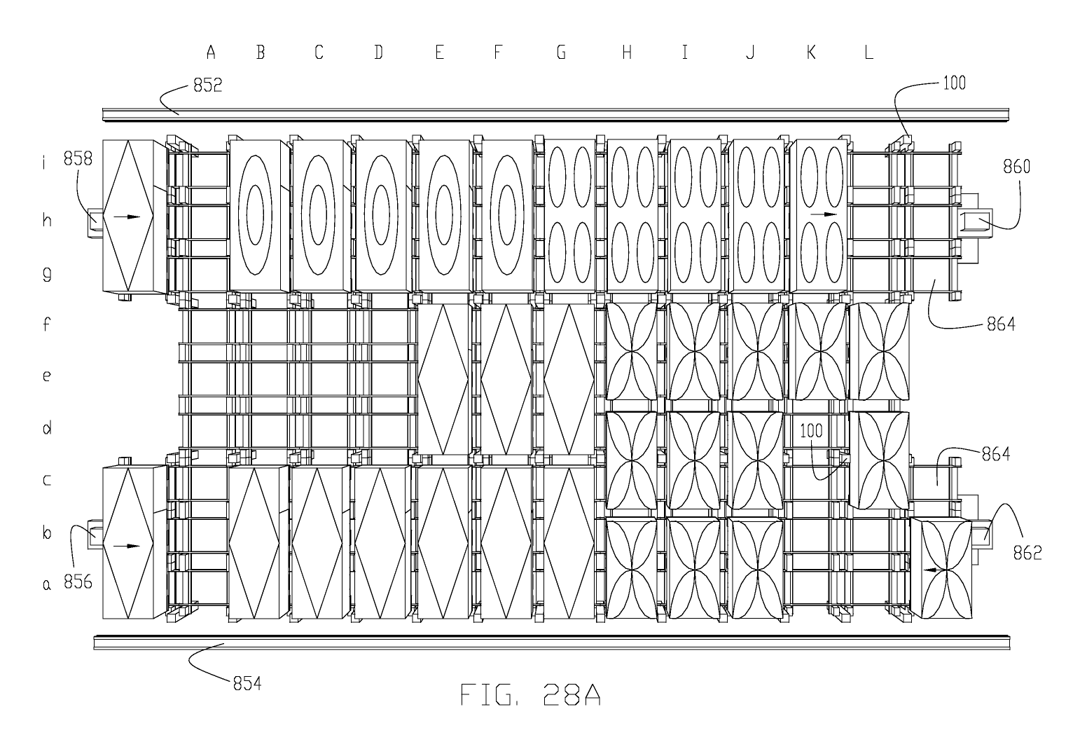

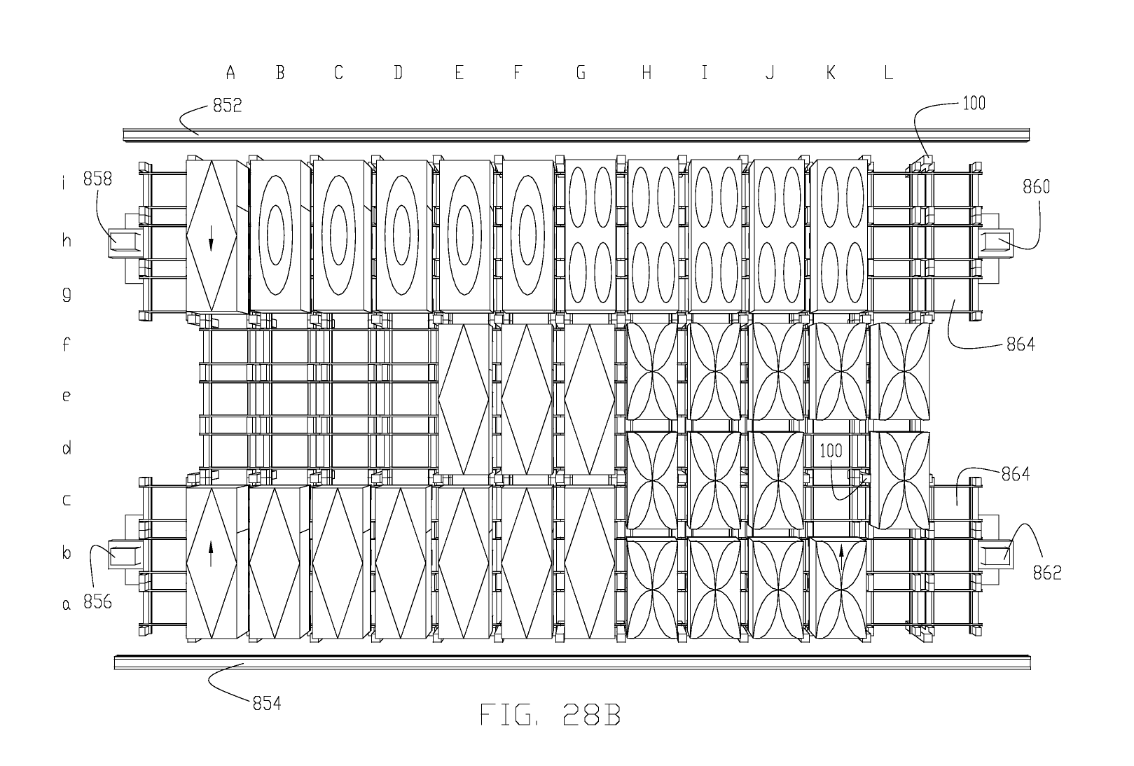

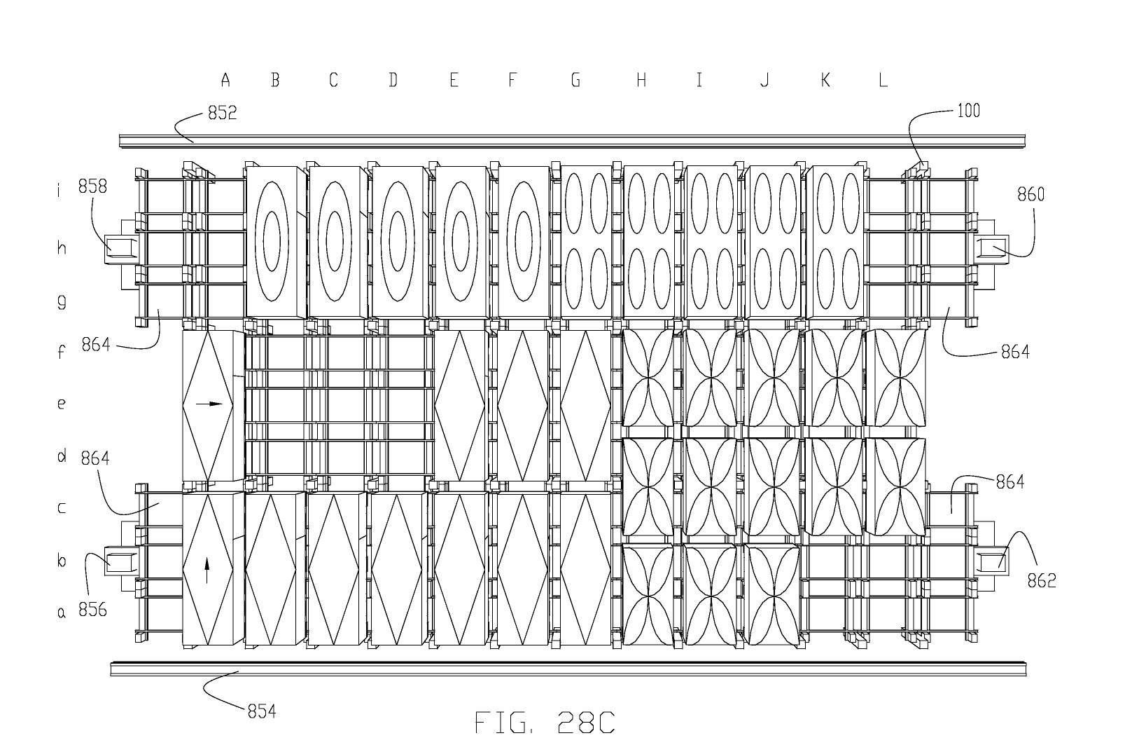

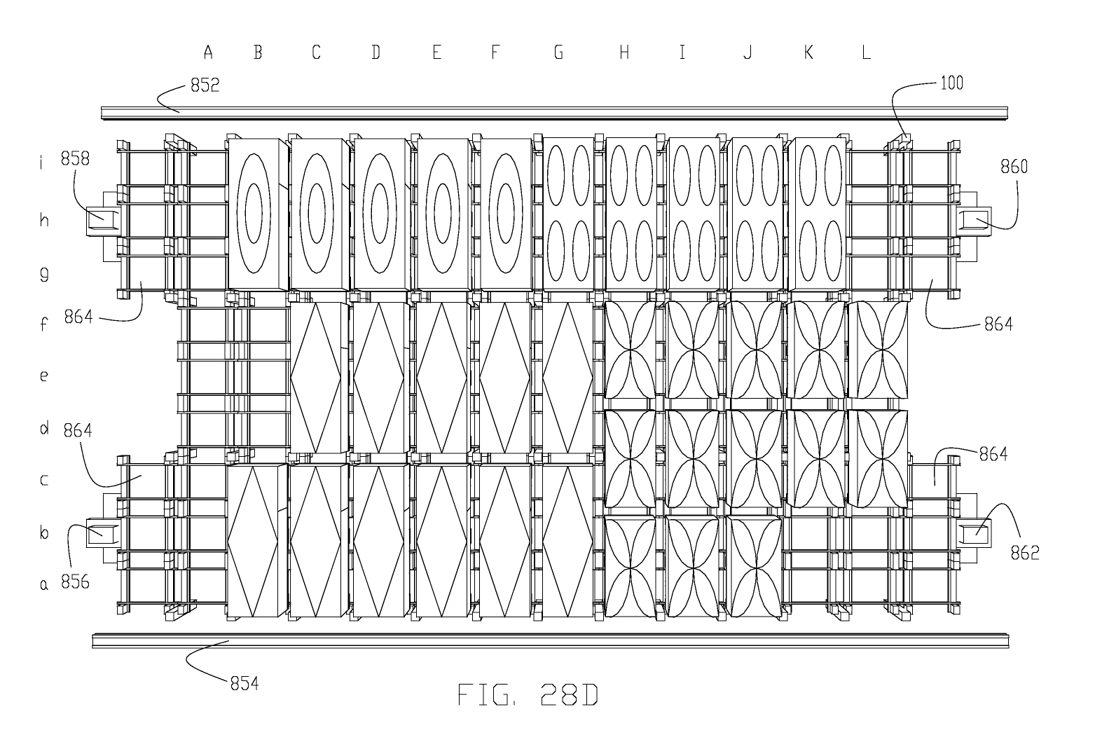

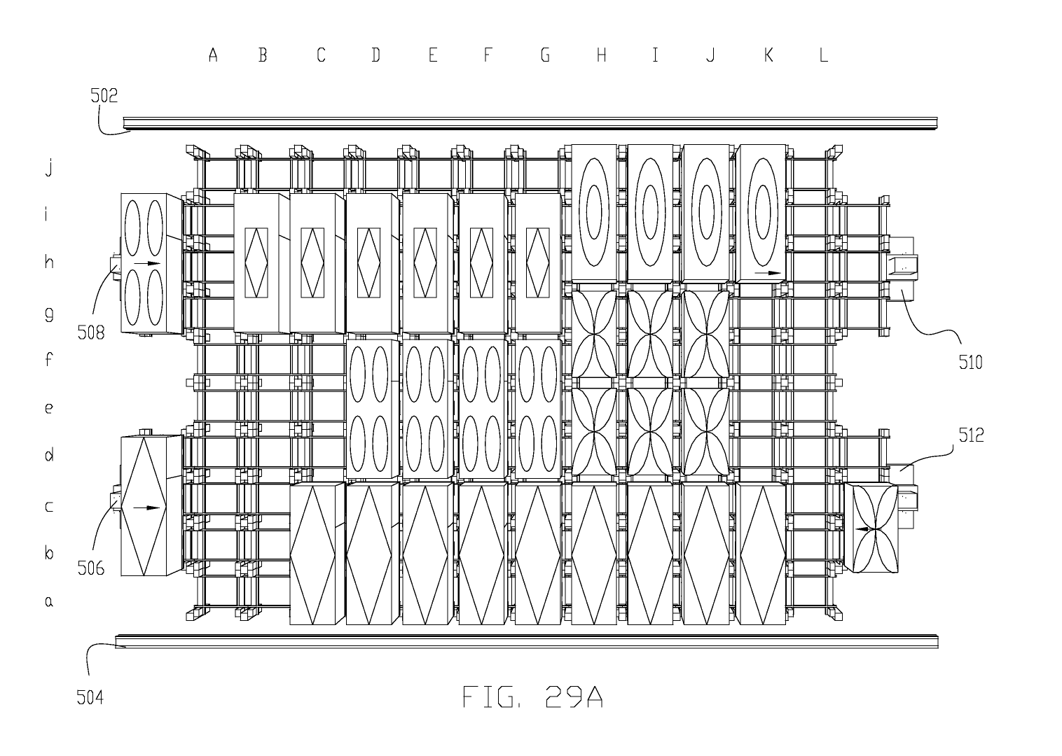

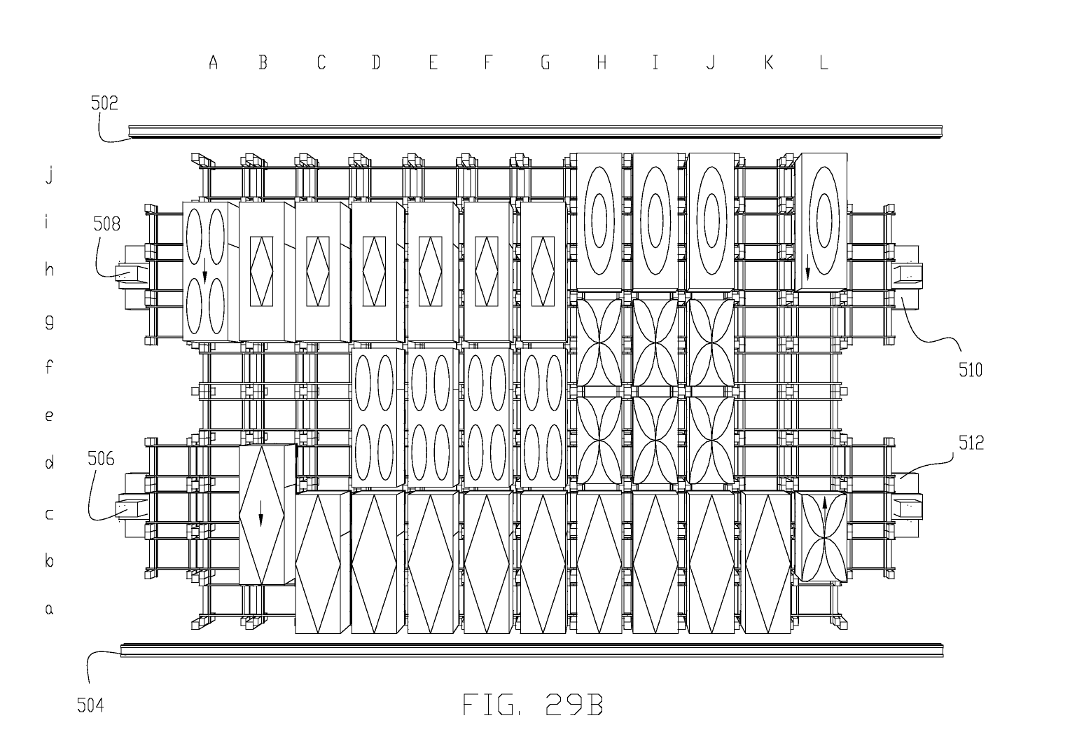

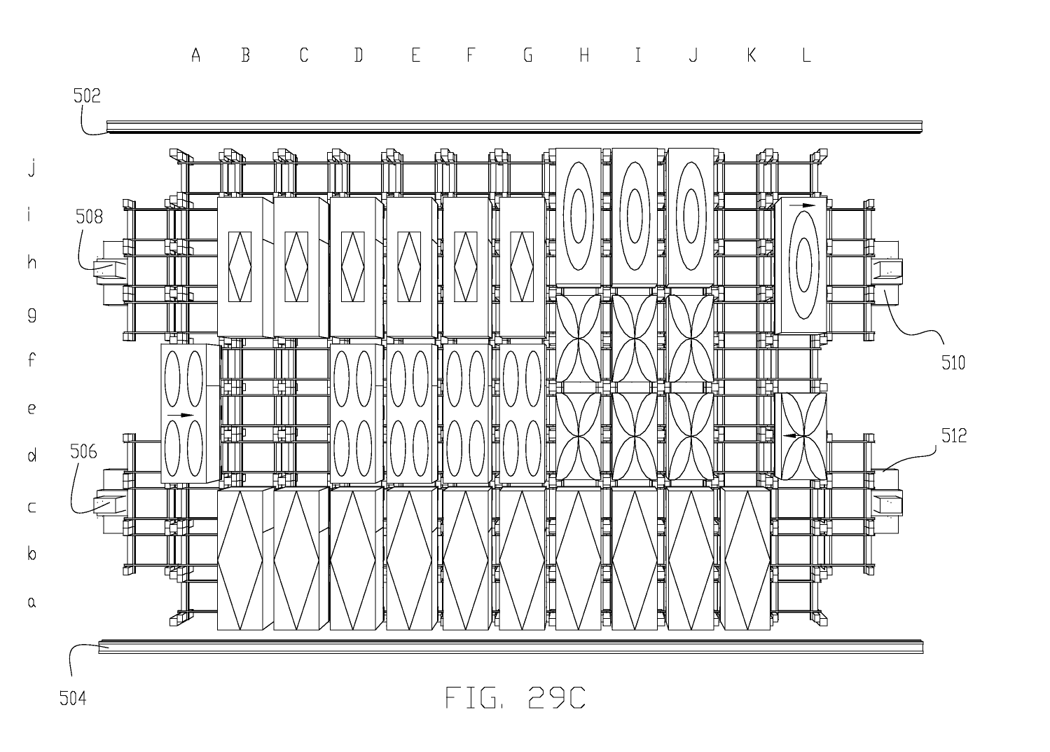

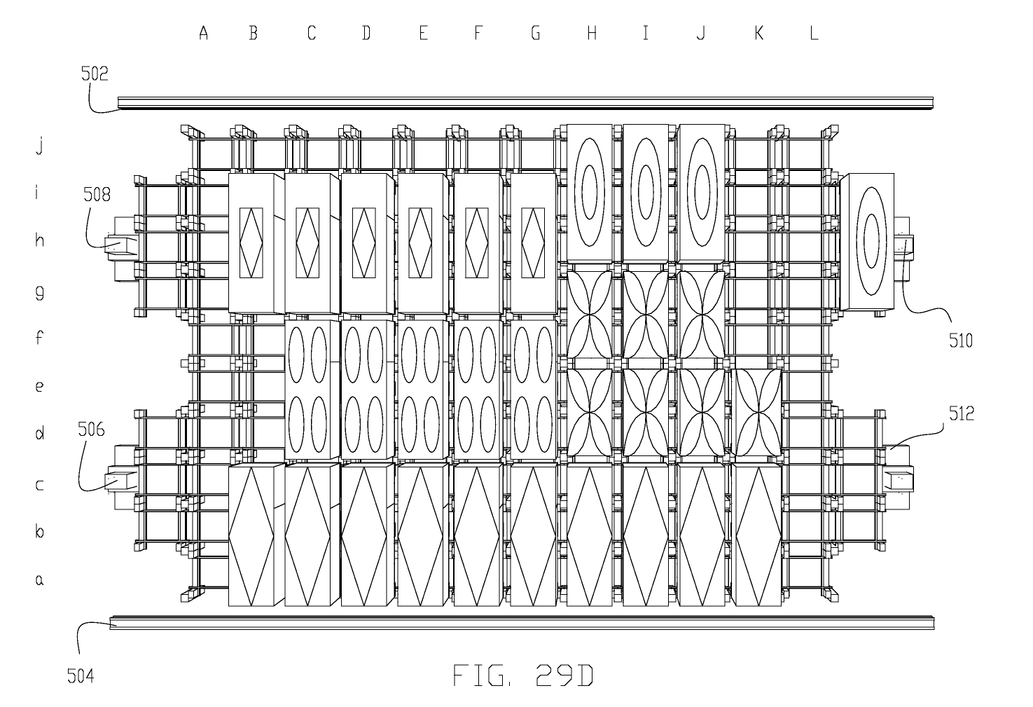

As seen in FIGS. 26A and 26B, elevators 856, 858, 860 and 862 are situated such that load platforms 864 are aligned with multiple pallet modular multi-track support elements 810 at an outer edge of array 850 to accommodate elongate sized palletized loads as described hereinbelow with referenced to FIGS. 28A-28D and 29A-29D.

It is appreciated that, while the illustrated embodiment shown in FIGS. 26A & 26B includes palletized load handling elevators on two opposite sides of array 850 and tracked palletized load handling cranes on two other opposite sides of array 850, elevators and cranes may be interchangeable and thus either only cranes or only elevators, as well as any other combination of cranes and elevators may be utilized on all four sides of array 850.

It is appreciated that the dynamically configurable automated warehousing system illustrated in FIGS. 26A and 26B also preferably includes a staging area in the vicinity of elevators 856, 858, 860 and 862 and outside array 850, similar to the staging area described hereinabove with reference to FIG. 13F, and an enclosure similar to the enclosure described hereinabove with reference to FIG. 13G.

It is appreciated that, in addition to the handling of standard sized palletized loads, such as loads 600 and 610 shown above, the dynamically configurable automated warehousing system of FIGS. 26A and 26B may also accommodate palletized loads which are supported on two or more pallets as described hereinbelow with reference to FIGS. 28A-28D and 29A-29D. While it is appreciated that the dynamically configurable automated warehousing system of FIGS. 13A-13G may also accommodate palletized loads which are supported on two or more pallets only on a top level thereof, due to the interference of array 300 of pillar elements 100 at lower levels thereof, the provision of multiple pallet modular multi-track support elements 810 enables the dynamically configurable automated warehousing system of FIGS. 26A and 26B to more easily accommodate palletized loads which are supported on two or more pallets.

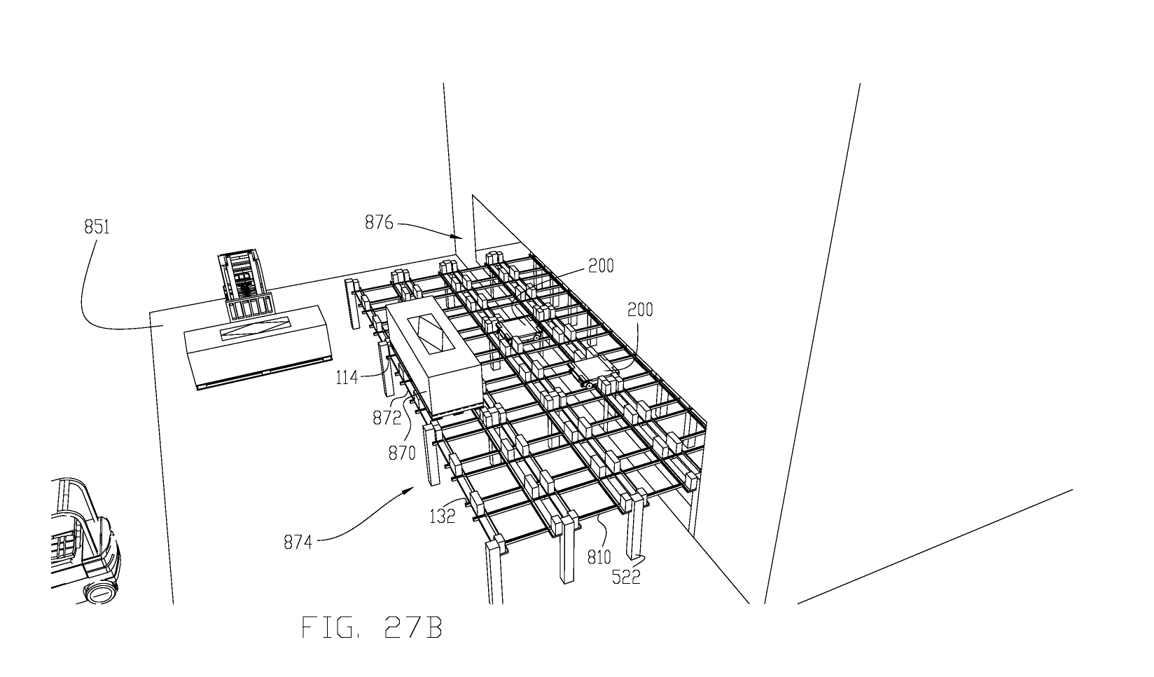

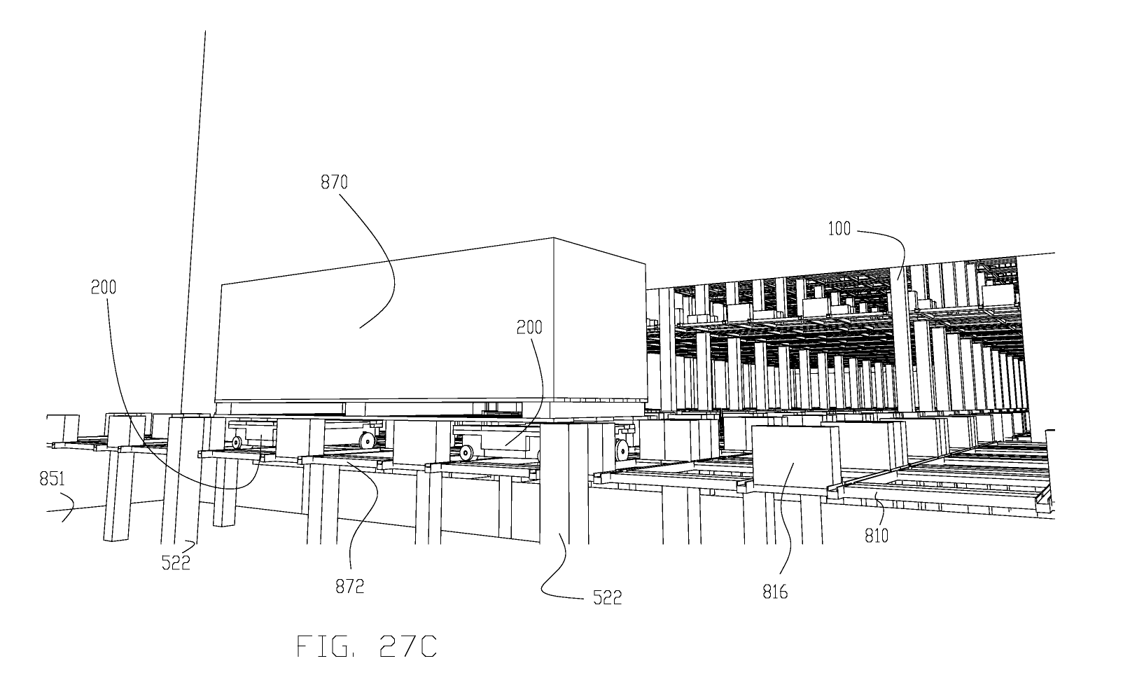

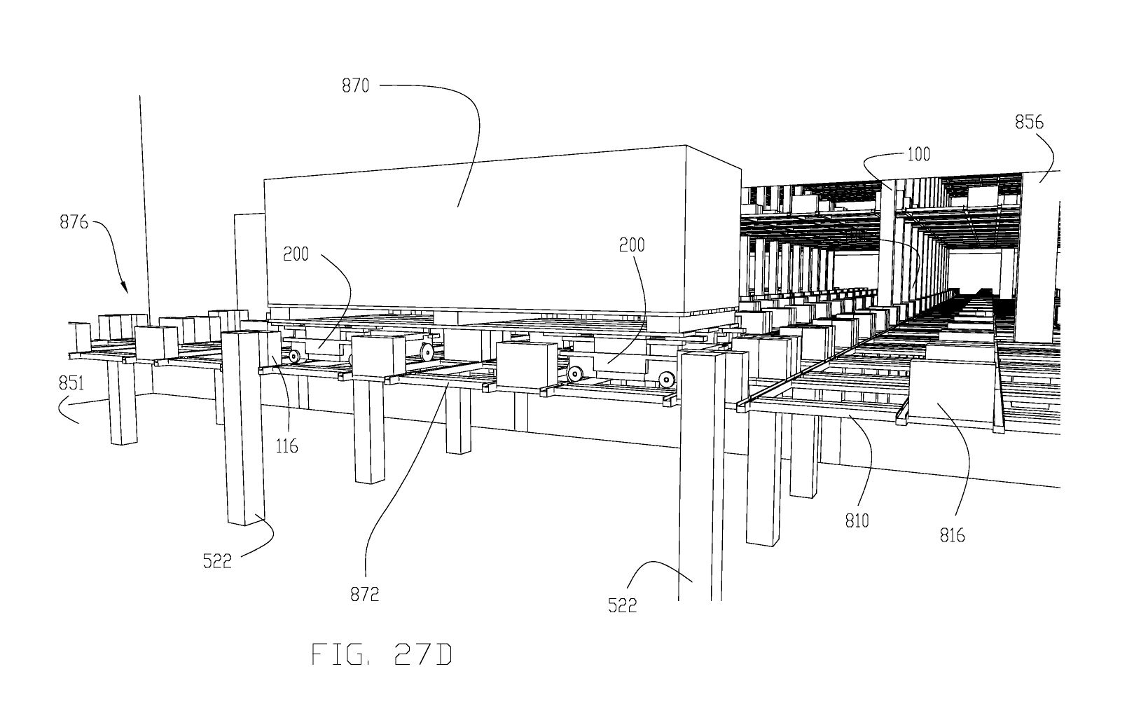

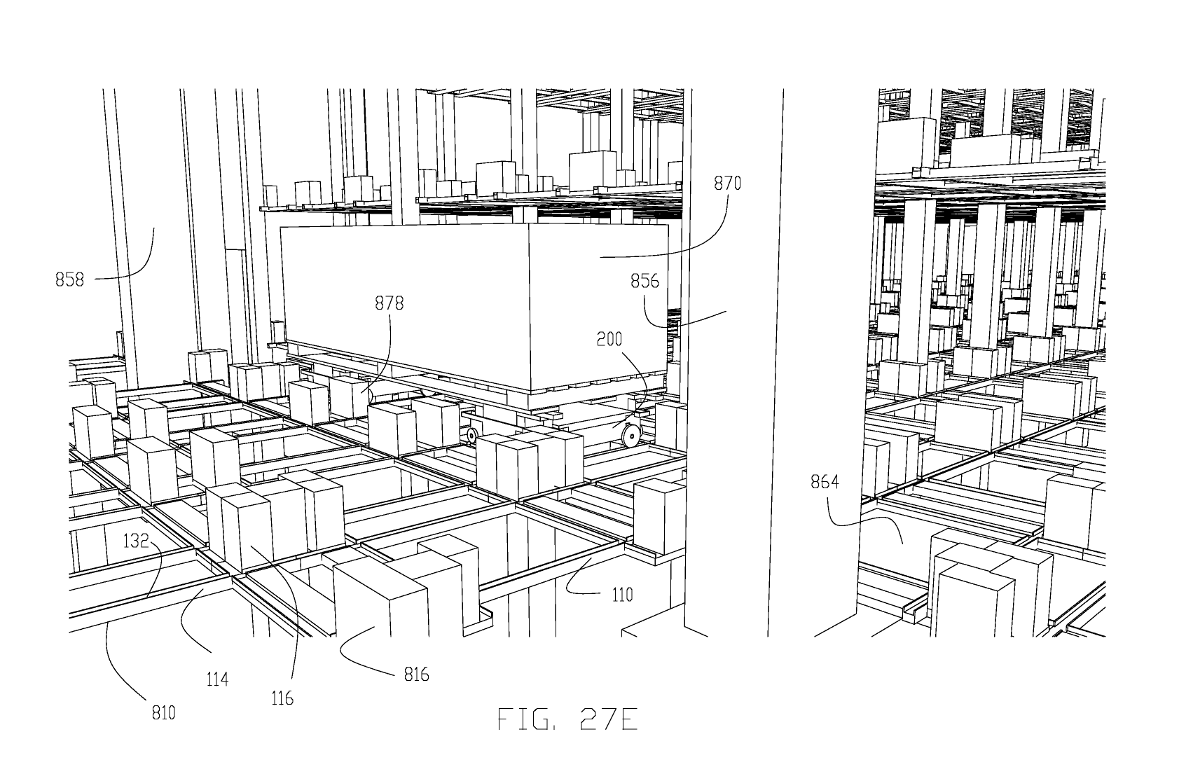

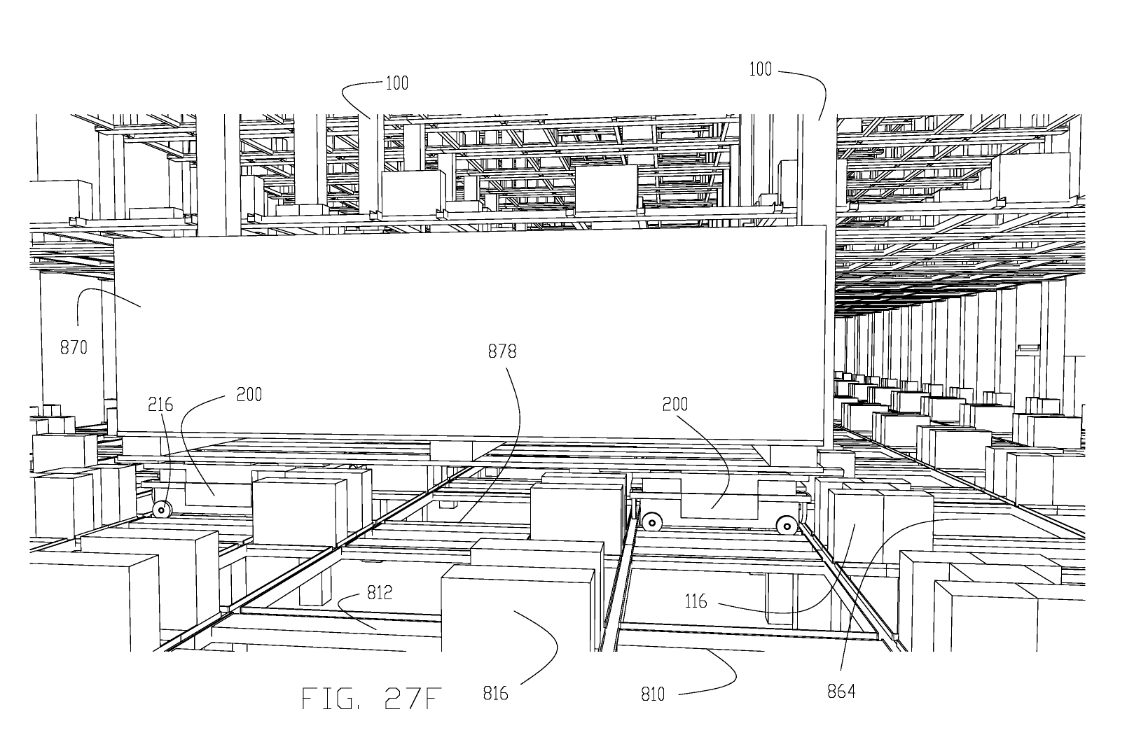

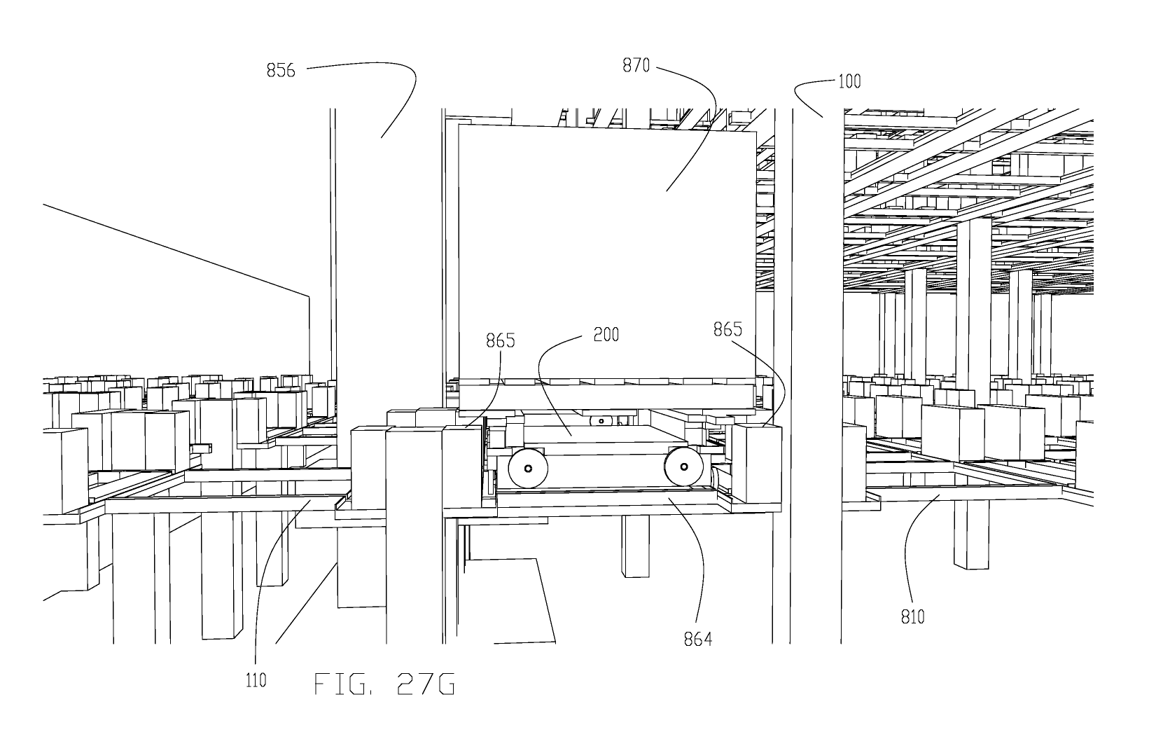

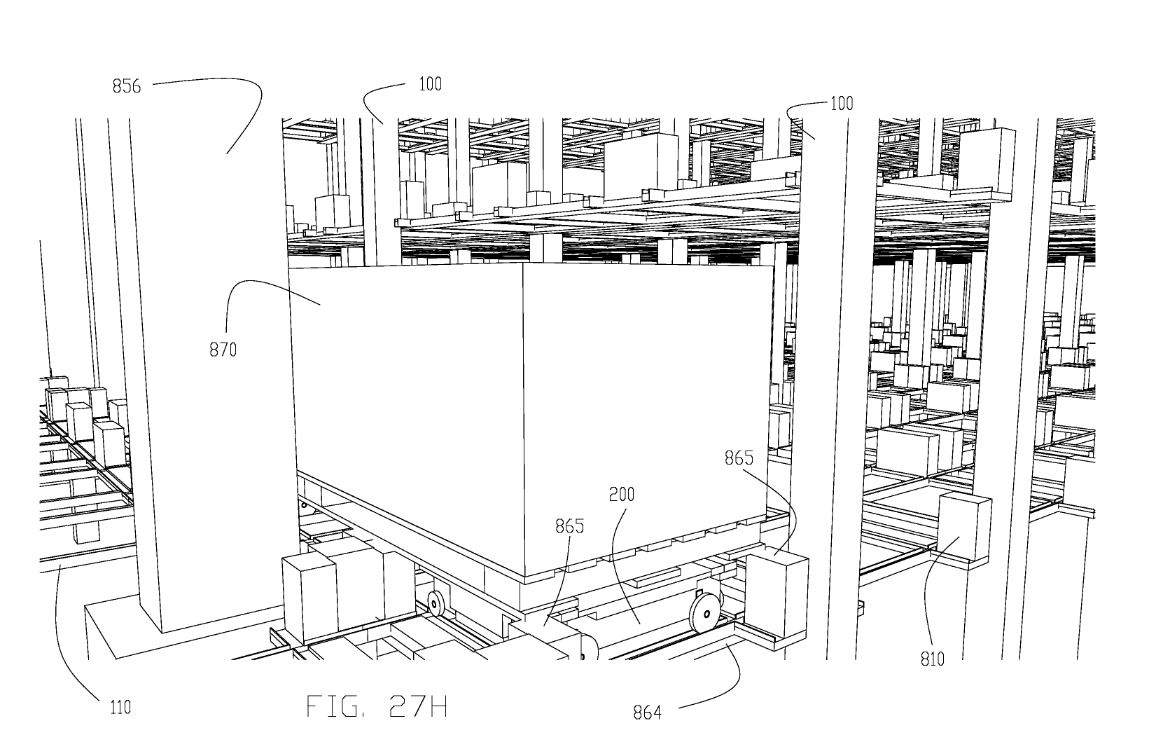

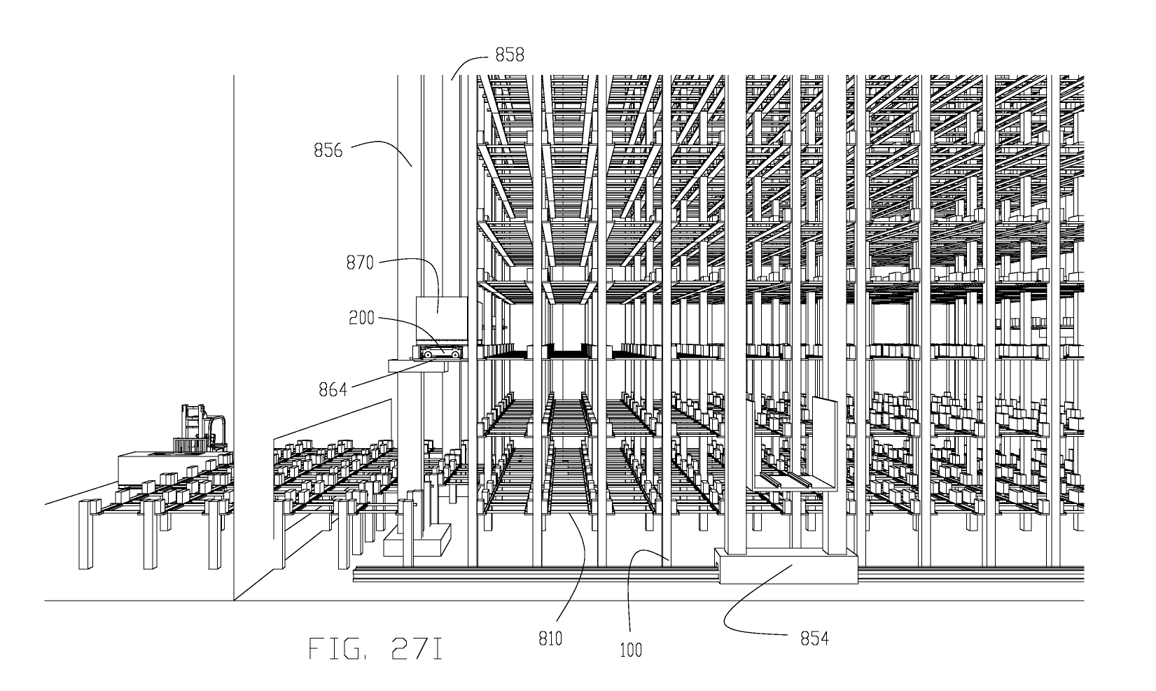

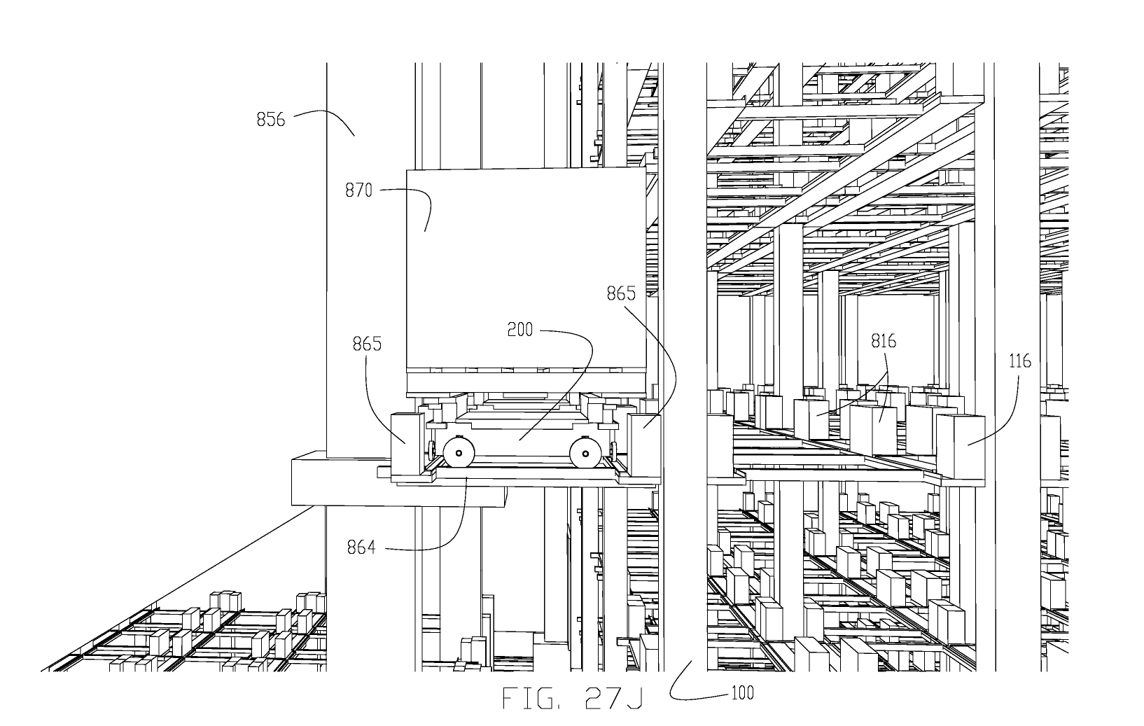

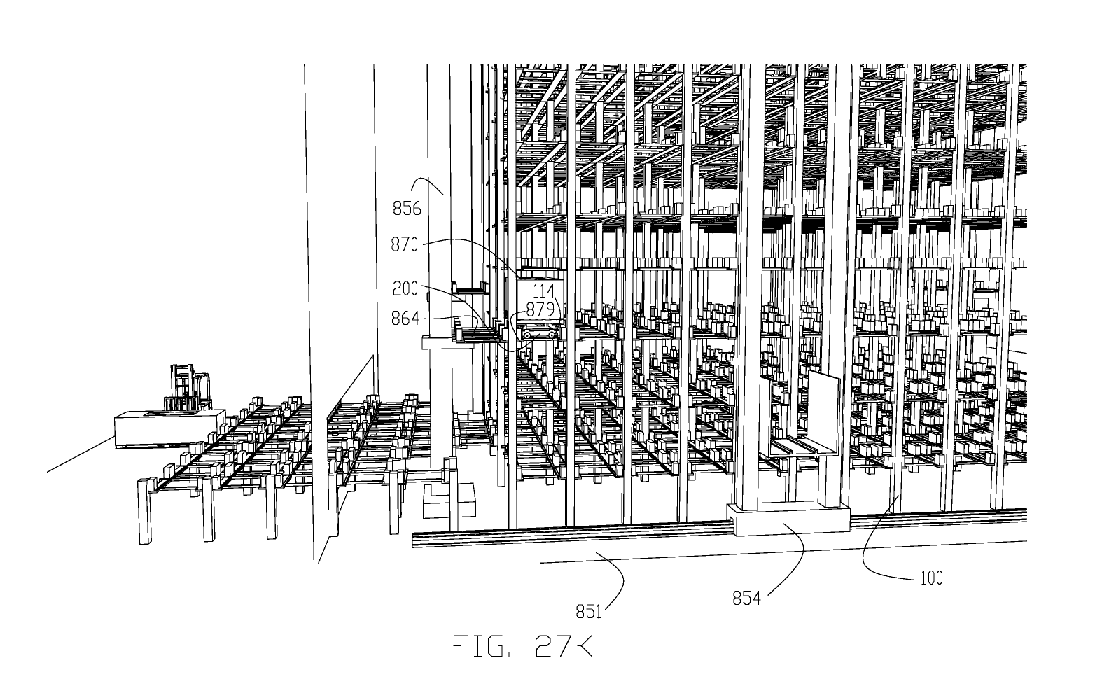

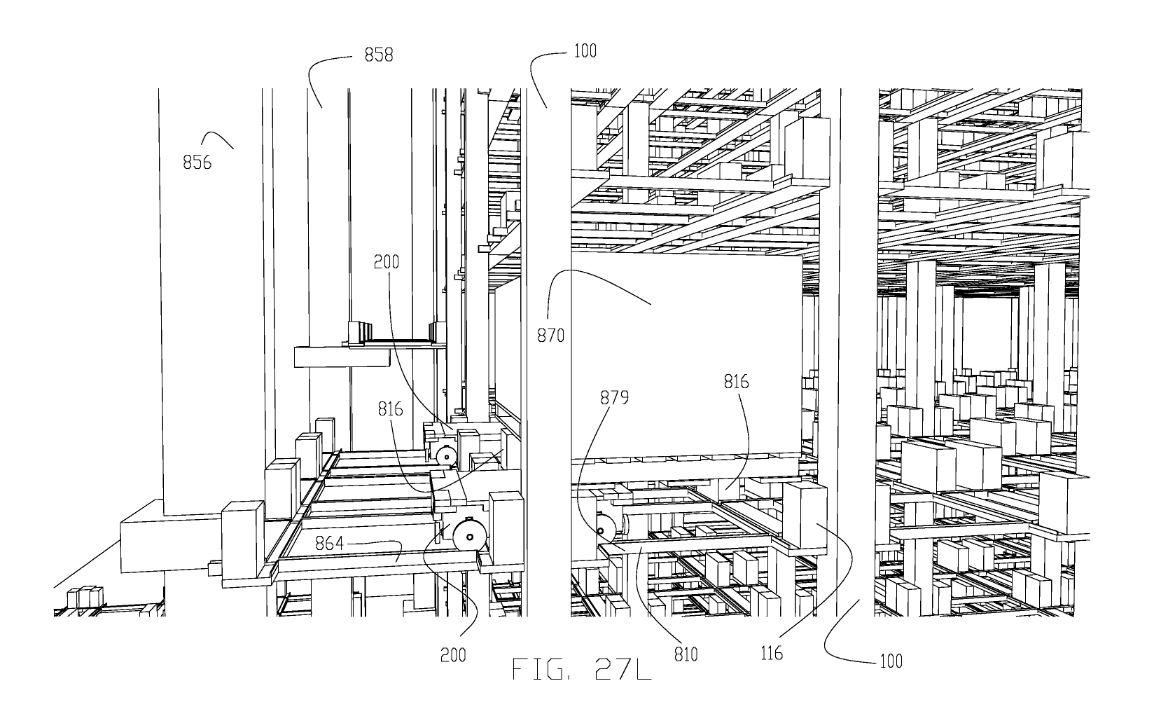

Preferably, the palletized loads which are supported on two or more pallets, described hereinbelow with reference to FIGS. 28A-28D and 29A-29D, may be moved within the warehouse system of the present invention by utilizing multiple three-directional palletized load transporters 200 operated in a mutually synchronized manner as described hereinbelow with reference to FIGS. 27A-27L.

Reference is now made to FIGS. 27A, 27B, 27C, 27D, 27E, 27F, 27G, 27H, 27I, 27J, 27K& 27L, which are simplified illustrations of various stages in the operation of the dynamically configurable automated warehousing system of FIGS. 26A and 26B.

FIG. 27A shows loading of a palletized load 870 which is supported on two or more pallets, hereinafter termed a multi-pallet load, onto a palletized load support location 872 at the exterior portion 874 of a staging area 876.

FIG. 27B shows travel of two three-directional palletized load transporters 200 along and within longitudinal recesses 132 formed in track elements 114 arranged along a Y axis into underlying engagement with multi-pallet load 870. It is appreciated that during this travel, the three-directional palletized load transporters 200 are in their second operative orientation as shown in FIG. 8.

FIG. 27C shows three-directional palletized load transporters 200 arranged underlying the two end pallets of a multi-pallet load 870 which is supported on three pallets. It is appreciated that the three-directional palletized load transporters 200 remain in their second operative orientation as shown in FIG. 8.

FIG. 27D shows synchronized operation of three-directional palletized load transporters 200 providing lifting of the multi-pallet load 870. It is appreciated that the three-directional palletized load transporters 200 are in their sixth operative orientation as shown in FIG. 12.

FIG. 27E shows the multi-pallet load 870 having been repositioned by synchronized travel of the three-directional palletized load transporters 200 along and within longitudinal recesses 132 formed in track elements 114 arranged along a Y axis to a location 878 just outside load bearing platform 864 of an elevator 856. It is noted that location 878 is aligned along an X-axis with load bearing platform 864. It is appreciated that the three-directional palletized load transporters 200 remain in their sixth operative orientation as shown in FIG. 12.

FIG. 27F shows the multi-pallet load 870 at location 878 just outside load bearing platform 864 of elevator 856. The three-directional palletized load transporters 200 have assumed their fifth operative orientation as shown in FIG. 11 such that they are ready for travel within longitudinal recesses 822 formed in track elements 812.

FIG. 27G shows the multi-pallet load 870 located on load bearing platform 864 of elevator 856. The three-directional palletized load transporters 200 remain in their fifth operative orientation as shown in FIG. 11.

FIG. 27H shows the multi-pallet load 870 resting on load support elements 865 forming part of load platform 864 of elevator 856. The three-directional palletized load transporters 200 have returned in a synchronized manner to their first operative orientation as shown in FIG. 7.

FIG. 27I shows lifting operation of elevator 856, raising the multi-pallet load 870 and the two three-directional palletized load transporters 200 to level three of the structure.

FIG. 27J shows the multi-pallet load 870 located on load bearing platform 864 of elevator 856. The three-directional palletized load transporters 200 are in their sixth operative orientation as shown in FIG. 12 and have raised the multi-pallet load 870 sufficiently to clear the height of load support elements 865 forming part of load platform 864 of elevator 856 as well as load support elements 116 and 816.

FIG. 27K shows the multi-pallet load 870 having been repositioned by synchronized travel of the three-directional palletized load transporters 200 along and within longitudinal recesses 132 formed in track elements 114 arranged along a Y axis to a travel/storage location 879 just outside load bearing platform 864 of an elevator 856. It is appreciated that the three-directional palletized load transporters 200 remain in their sixth operative orientation as shown in FIG. 12.

FIG. 27L shows the multi-pallet load 870 resting on load support elements 116 and 816. The three-directional palletized load transporters 200 have returned in a synchronized manner to their second operative orientation as shown in FIG. 8.

Reference is now made to FIGS. 28A, 28B, 28C and 28D, which are simplified illustrations of various stages of the operation of the dynamically configurable automated warehousing system of FIGS. 26A & 26B at any level thereof, which are combinable with one or both aspects of the operation of the dynamically configurable automated warehousing system of FIGS. 1A-12 shown in FIGS. 15A-16M and 27A-27L.

FIGS. 28A-28D show stages in the operation of the dynamically configurable automated warehousing system of FIGS. 26A & 26B, wherein double pallet loads and triple pallet loads are stored.

FIGS. 28A & 28B together show two triple pallet loads being moved from the load platforms 864 of respective elevators 856 and 858 to respective storage locations Aa,b,c and Ag,h,i. FIGS. 28A & 28B also show a double pallet load being moved from load platform 864 of elevator 862 to storage location Ka,b.

FIGS. 28B & 28C together show a triple pallet load being moved from the storage location Ag,h,i to storage location Ad,e,f. FIGS. 28B & 28C also show a double pallet load being moved from storage location Ka,b to storage location Kc,d.

FIGS. 28C & 28D together show two triple pallet loads being moved from respective storage locations Ad,e,f and Aa,b,c, to respective storage locations Dd,e,f and Cd,e,f.

The above relocations of palletized loads, including intermediate relocations, are each indicated hereinbelow in Table 3 by the row and column designations of the storage locations thereof:

TABLE 3

| Step # | From Location | To Location |
|---|---|---|
| 1 | 858g-i | Ag-i |
| 2 | 856a-c | Aa-c |
| 3 | 862a-b | Ka-b |
| 4 | Ag-i | Ad-f |
| 5 | Ka-b | Kc-d |
| 6 | Ad-f | Dd-f |
| 7 | Aa-c | Ad-f |
| 8 | Ad-f | Cd-f |

Reference is now made to FIGS. 29A, 29B, 29C and 29D, which are simplified illustrations of various stages in yet another further aspect of the operation of the dynamically configurable automated warehousing system of FIGS. 13A-13G, at a top level thereof, which may also be utilized in the dynamically configurable automated warehousing system of FIGS. 26A and 26B at any level thereof.

FIG. 29A shows a top level of the automated warehousing system of FIGS. 13A-13G, including elongate sized palletized loads of varying sizes. FIG. 29A illustrates a typical state of operation where palletized loads located on elevators 506, 508 and 512 are ready to be stored in palletized load storage/travel locations which were previously designated as palletized load travel locations and a palletized load located at storage locations Kh,i,j is ready to be removed from palletized load storage/travel locations which were previously designated as palletized load storage locations.

FIGS. 29B and 29C show intermediate stages in the movement of the palletized loads shown in FIG. 29A. As described above, the movement also involves changing the designations of some of the mutually adjacent palletized load storage/travel locations from palletized load travel locations to palletized load storage locations and vice versa.

The movement preferably takes place by relocation of the palletized loads shown on the load platforms 514 of elevators 506, 508 and 512 and the movement of the palletized load located at storage locations Kh,i,j in FIG. 29A to the arrangement shown in FIG. 29D. The relocations of palletized loads are each indicated hereinbelow by the row and column designations of the storage locations thereof:

TABLE 4

| Step # | From Location | To Location |
|---|---|---|
| 1 | Kh-Kj | Lh-Lj |
| 2 | Lh-Lj | Lg-Li |
| 3 | Lg-Li | 510g-h-i |
| 4 | 506b-d | Bb-Bd |
| 5 | Bb-Bd | Ba-Bc |
| 6 | 508g-h-i | Ag-Ai |
| 7 | Ag-Ai | Ad-Af |
| 8 | Ad-Af | Cd-Cf |
| 9 | 512b-c | Lb-Lc |
| 10 | Lb-Lc | Ld-Le |
| 11 | Ld-Le | Kd-Ke |

FIG. 29D shows the palletized loads of FIG. 29A at their new storage locations.

It is appreciated that, while in the illustrated embodiments shown in FIGS. 28A-29D the illustrated palletized loads include elongate sized palletized loads supported on multiple pallets, palletized loads supported on a single pallet may also be stored together with elongate sized palletized loads supported on multiple pallets on the same horizontal level of the dynamically configurable automated warehousing system of FIGS. 26A and 26B at any level thereof or on the top level of the dynamically configurable automated warehousing system of FIGS. 13A-13G.

It will be appreciated by persons skilled in the art that the present invention is not limited by what has been particularly shown and described hereinabove. Rather the scope of the present invention is defined by the claims which follow and include variations and modifications which would occur to persons skilled in the art upon reading the foregoing and which are not in the prior art.

1. A dynamically automated warehousing system comprising:
a three-dimensional storage volume having a plurality of horizontal storage levels which are vertically offset from each other, each of said plurality of horizontal storage levels defining a grid of mutually adjacent palletized load storage/travel locations, at least some of said mutually adjacent palletized load storage/travel locations being accessible from multiple directions;
a three-dimensional palletized load storage/travel controller operative to dynamically control placement of palletized loads to and removal of palletized loads from palletized load storage locations and being operative to changeably designate a first plurality of said mutually adjacent palletized load storage/travel locations as palletized load storage locations and a second plurality of said mutually adjacent palletized load storage/travel locations as palletized load travel locations at a first time, and at a second time to designate a third plurality, different from said first plurality, of said mutually adjacent palletized load storage/travel locations as palletized load storage locations and a fourth plurality, different from said second plurality, of said mutually adjacent palletized load storage/travel locations as palletized load travel locations, whereby at least some of said mutually adjacent palletized load storage/travel locations may belong to said first plurality at said first time and may belong to said fourth plurality at said second time.

2. A dynamically automated warehousing system according to claim 1 and also comprising a plurality of three-axis palletized load transporters, each arranged to displace palletized loads along three mutually perpendicular axes.

3. A dynamically automated warehousing system according to claim 2 and wherein said three-dimensional palletized load storage/travel controller is also operative to control operation of said plurality of three-axis palletized load transporters for transporting and storing palletized loads within said three-dimensional storage volume.

4. A dynamically automated warehousing system according to claim 2 and wherein said three-dimensional palletized load storage/travel controller is also operative to coordinate operation of at least two of said plurality of three-axis palletized load transporters for synchronized engagement with a single palletized load which is supported on at least two pallets, displacement thereof to a desired location and disengagement therefrom.

5. A dynamically automated warehousing system according to claim 2 and wherein:
said palletized loads include palletized loads which are supported on a single pallet and palletized loads which are supported on at least two pallets; and
said three-dimensional palletized load storage/travel controller is also operative to allow placement and removal of at least one of said palletized loads supported on a single pallet and at least one of said palletized loads supported on at least two pallets on one storage level of said plurality of horizontal storage levels.

6. An automated warehousing system comprising:
a multi-story structure for storage of palletized loads, each story comprising:
a first multiplicity of paired elongate static first palletized load travel path elements arranged in a first mutually parallel arrangement along first mutually parallel axes in a first three-dimensional arrangement within a three-dimensional volume;
a second multiplicity of paired elongate static second palletized load travel path elements arranged in a second mutually parallel arrangement along second mutually parallel axes in a second three-dimensional arrangement within said three dimensional volume, said second mutually parallel axes being generally perpendicular to said first mutually parallel axes; and
a third multiplicity of static palletized load supports arranged within said three-dimensional volume; and
a plurality of three-axis palletized load transporters, each arranged to displace palletized loads along three mutually perpendicular axes: along at least one of said first mutually parallel axes, along at least one of said second mutually parallel axes and along a vertical axis perpendicular to both said first and second mutually parallel axes.

7. An automated warehousing system according to claim 6 and wherein said plurality of three-axis palletized load transporters are operative to move along said first and second mutually parallel axes into a position underlying a palletized load which is supported on ones said third multiplicity of static palletized load supports, to raise said palletized load out of supported engagement with said ones of said multiplicity of static palletized load supports, to displace said palletized load along said first and second mutually parallel axes and thereafter to lower said palletized load onto others of said third multiplicity of static palletized load supports in supported engagement therewith and to move along said first and second mutually parallel axes to a position not underlying said palletized load.

8. An automated warehousing system according to claim 6 and also comprising at least one palletized load lifting/lowering assembly for raising or lowering said palletized loads between levels of said multi-story structure.

9. An automated warehousing system according to claim 8 and wherein said at least one palletized load lifting/lowering assembly comprises an elevator having a load platform configured to define palletized load travel paths extending along said first and second mutually parallel axes.

10. An automated warehousing system according to claim 9 and wherein said elevator has a load platform configured to accommodate palletized loads which extend over more than one pallet.

11. An automated warehousing system according to claim 6 and also comprising a palletized load storage/travel controller operative to control operation of said plurality of three-axis palletized load transporters and to coordinate operation of at least two of said plurality of three-axis palletized load transporters for synchronized engagement with a single palletized load which is supported on at least two pallets, displacement thereof to a desired location and disengagement therefrom.

12. A dynamically automated warehousing system comprising:
a three-dimensional storage volume having a plurality of horizontal storage levels which are vertically offset from each other, each of said plurality of horizontal storage levels defining a grid of mutually adjacent palletized load storage/travel locations, at least some of said mutually adjacent palletized load storage/travel locations being accessible from multiple directions; and
a three-dimensional palletized load storage/travel controller operative to dynamically control placement of palletized loads to and removal of palletized loads from said mutually adjacent palletized load storage locations and being operative to:
changeably designate a first plurality of said mutually adjacent palletized load storage/travel locations as one-deep palletized load storage locations, which do not require movement of another palletized load for access thereto; and generally independently thereof
changeably designate a second plurality of said mutually adjacent palletized load storage/travel locations as two-deep palletized load storage locations, which require movement of a single palletized load for access thereto; and generally independently thereof
changeably designate a third plurality of said mutually adjacent palletized load storage/travel locations as three-deep palletized load storage locations, which require movement of two palletized loads for access thereto,
whereby at least some of said mutually adjacent palletized load storage/travel locations may belong to said first plurality at a first time and may belong to said second plurality at a second time and may belong to said third plurality at a third time.

13. A dynamically automated warehousing system according to claim 12 and wherein said three-dimensional storage volume and said three-dimensional palletized load storage/travel controller are both capable of accommodating palletized loads which extend over more than one pallet.

14. A dynamically automated warehousing system according to claim 12 and also comprising a plurality of three-axis palletized load transporters wherein said three-dimensional palletized load storage/travel controller is operative to control operation of said plurality of three-axis palletized load transporters and to coordinate operation of at least two of said plurality of three-axis palletized load transporters for synchronized engagement with a single palletized load which is supported on at least two pallets, displacement thereof to a desired location and disengagement therefrom.

15. A dynamically automated warehousing method comprising:
providing a three-dimensional storage volume having a plurality of horizontal storage levels which are vertically offset from each other, each of said plurality of horizontal storage levels defining a grid of mutually adjacent palletized load storage/travel locations, at least some of said mutually adjacent palletized load storage/travel locations being accessible from multiple directions; and
dynamically controlling placement of palletized loads to and removal of palletized loads from palletized load storage locations including changeably designating a first plurality of said mutually adjacent palletized load storage/travel locations as palletized load storage locations and a second plurality of said mutually adjacent palletized load storage/travel locations as palletized load travel locations at a first time, and at a second time changeably designating a third plurality, different from said first plurality, of said mutually adjacent palletized load storage/travel locations as palletized load storage locations and a fourth plurality, different from said second plurality of said mutually adjacent palletized load storage/travel locations as palletized load travel locations, whereby at least some of said mutually adjacent palletized load storage/travel locations may belong to said first plurality at said first time and may belong to said fourth plurality at said second time.

16. A dynamically automated warehousing method according to claim 15 and wherein said plurality of horizontal storage levels are vertically offset from each other by differing amounts and said dynamically controlling placement of palletized loads includes selecting palletized load storage/travel locations in accordance with height of a palletized load.

17. A dynamically automated warehousing method according to claim 15 and wherein said dynamically controlling placement of palletized loads includes simultaneously moving multiple palletized loads to enable access to a given palletized load storage/travel location.

18. A dynamically automated warehousing method according to claim 15 and wherein said dynamically controlling placement of palletized loads to and removal of palletized loads from palletized load storage locations includes:
placing at least one palletized load supported on a single pallet and at least one palletized load supported on at least two pallets on a single storage level of said plurality of horizontal storage levels.

19. An automated warehousing system comprising:
a structure for storage of palletized loads including palletized loads which are supported on at least two pallets;
a plurality of palletized load transporters, each arranged to displace palletized loads in a plane and along a vertical axis perpendicular to said plane; and
a palletized load storage/travel controller operative to control operation of said plurality of palletized load transporters and to coordinate operation of at least two of said plurality of palletized load transporters for synchronized engagement with a single palletized load which is supported on at least two pallets, displacement thereof to a desired location and disengagement therefrom.

20. A dynamically automated warehousing system comprising:
a three-dimensional storage volume having a plurality of horizontal storage levels which are vertically offset from each other, each of said plurality of horizontal storage levels defining a grid of mutually adjacent palletized load storage/travel locations, at least some of said mutually adjacent palletized load storage/travel locations being accessible from multiple directions;
a three-dimensional palletized load storage/travel controller operative to dynamically control placement of palletized loads to and removal of palletized loads from palletized load storage/travel locations, said palletized loads including palletized loads which are supported on a single pallet and palletized loads which are supported on at least two pallets, said three-dimensional palletized load storage/travel controller being operative to allow placement and removal of at least one of said palletized loads supported on a single pallet and at least one of said palletized loads supported on at least two pallets on one storage level of said plurality of horizontal storage levels.
